(19) United States
(12) Patent Application Publication
(10) Pub. No.: US 2026/0023335 A1
(43) Pub. Date: Jan. 22, 2026

(54) IMAGE FORMING APPARATUS

(71) Applicant: CANON KABUSHIKI KAISHA, TOKYO (JP)

(72) Inventors: JUMPEI NITTA, KANAGAWA (JP); TOMOYA TATEISHI, KANAGAWA (JP); OSAMU SASAOKA, KANAGAWA (JP); KOHEI KOGUCHI, TOKYO (JP); SHUMA HIASA, KANAGAWA (JP); TACHIO KAWAI, TOKYO (JP); KENJI WATANABE, SHIZUOKA (JP)

(21) Appl. No.: 19/339,056

(22) Filed: Sep. 24, 2025

Related U.S. Application Data
(63) Continuation of application No. PCT/JP2024/011850, filed on Mar. 26, 2024.

(30) Foreign Application Priority Data
Mar. 28, 2023 (JP) 2023-051815
Mar. 28, 2023 (JP) 2023-051816
Mar. 28, 2023 (JP) 2023-051817

(51) Int. Cl. G03G 15/01; G03G 21/16

(52) U.S. Cl. CPC G03G 15/0173; G03G 21/1647; G03G 2221/1654

(57) ABSTRACT

An image forming apparatus includes a rotary including a first developing chamber and a second developing chamber, a first cartridge having a first cartridge indicator and configured to supply a first developer to the first developing chamber, a second cartridge having a second cartridge indicator and configured to supply a second developer to the second developing chamber, a first tray having a first tray indicator and capable of removably supporting the first cartridge, and a second tray having a second tray indicator and capable of removably supporting the second cartridge. A hue of the first cartridge indicator is closer to a hue of the first tray indicator than to a hue of the second tray indicator, and a hue of the second cartridge indicator is closer to the hue of the second tray indicator than to the hue of the first tray indicator.

### CROSS-REFERENCE TO RELATED APPLICATIONS

This application is a Continuation of International Patent Application No. PCT/JP2024/011850, filed Mar. 26, 2024, which claims the benefit of Japanese Patent Application No. 2023-051815, filed Mar. 28, 2023, Japanese Patent Application No. 2023-051816, filed Mar. 28, 2023, and Japanese Patent Application No. 2023-051817, filed Mar. 28, 2023, all of which are hereby incorporated by reference herein in their entirety.

### BACKGROUND

### Field of the Technology

The present disclosure relates to an image forming apparatus that forms an image on a recording medium.

### Description of the Related Art

In an electrophotographic image forming apparatus, a rotary developing system is known to form a color image by rotating a rotary assembly including a plurality of developing rollers. Japanese Patent Laid-Open No. 2007-183305 and Japanese Patent Laid-Open No. 2008-096852 describe image forming apparatuses that include a rotary assembly with a plurality of developing rollers and a plurality of toner cartridges (toner containers) that are detachably attachable to the rotary assembly.

### SUMMARY

The present disclosure provides a new image forming apparatus that has advanced the existing technology.

An aspect of the present disclosure is as follows.

An image forming apparatus to which a first cartridge that contains a first developer and a second cartridge that contains a second developer different in color from the first developer are detachably attached includes a rotary rotatable around a rotation axis extending in an axial direction, the rotary including a first developing chamber configured to contain the first developer supplied from the first cartridge and a second developing chamber configured to contain the second developer supplied from the second cartridge; a first tray having a first restricting portion and capable of removably supporting the first cartridge such that the first cartridge takes a first posture, the first tray being configured to be displaced relative to the rotary between a first position where the first cartridge supported in the first posture is positioned outside the rotary and a second position where the first cartridge supported in the first posture is positioned inside the rotary; and a second tray having a second restricting portion and capable of removably supporting the second cartridge such that the second cartridge takes a second posture, the second tray being configured to be displaced relative to the rotary between a third position where the second cartridge supported in the second posture is positioned outside the rotary and a fourth position where the second cartridge supported in the second posture is positioned inside the rotary, wherein, when the first tray supports the second cartridge, the first restricting portion of the first tray contacts with the second cartridge to restrict the second cartridge from taking the same posture as the first posture relative to the first tray, and, when the second tray supports the first cartridge, the second restricting portion of the second tray contacts with the first cartridge to restrict the first cartridge from taking the same posture as the second posture relative to the second tray.

An aspect of the present disclosure is as follows.

An image forming apparatus to which a first cartridge that contains a first developer and a second cartridge that contains a second developer different in color from the first developer are detachably attached includes a rotary rotatable around a rotation axis extending in an axial direction, the rotary including a first developing chamber configured to contain the first developer supplied from the first cartridge and a second developing chamber configured to contain the second developer supplied from the second cartridge; a first tray capable of removably supporting the first cartridge such that the first cartridge takes a first posture, the first tray being configured to be displaced relative to the rotary between a first position where the first cartridge is positioned outside the rotary and a second position where the first cartridge is positioned inside the rotary, and a second tray capable of removably supporting the second cartridge such that the second cartridge takes a second posture, the second tray being configured to be displaced relative to the rotary between a third position where the second cartridge is positioned outside the rotary and a fourth position where the second cartridge is positioned inside the rotary, wherein, in a state where the first tray supports the second cartridge, the first tray is restricted from moving to the second position, and, in a state where the second tray supports the first cartridge, the second tray is restricted from moving to the fourth position.

An aspect of the present disclosure is as follows. An image forming apparatus to which a first cartridge that has a first cartridge indicator and that contains a first developer and a second cartridge that has a second cartridge indicator and that contains a second developer different in color from the first developer are detachably attached includes a rotary including a first developing chamber configured to contain the first developer supplied from the first cartridge and a second developing chamber configured to contain the second developer supplied from the second cartridge; a first tray having a first tray indicator, the first tray supporting the first cartridge such that the first cartridge is detachably attached, the first tray being configured to be displaced relative to the rotary between a first position where the first cartridge is positioned outside the rotary and a second position where the first cartridge is positioned inside the rotary, and a second tray having a second tray indicator, the second tray supporting the second cartridge such that the second cartridge is detachably attached, the second tray being configured to be displaced relative to the rotary between a third position where the second cartridge is positioned outside the rotary and a fourth position where the first cartridge is positioned inside the rotary, wherein a hue of the first cartridge indicator is closer to a hue of the first tray indicator than to a hue of the second tray indicator, and a hue of the second cartridge indicator is closer to the hue of the second tray indicator than to the hue of the first tray indicator.

Features of the present disclosure will become apparent from the following description of embodiments with reference to the attached drawings.

### BRIEF DESCRIPTION OF THE DRAWINGS

The present disclosure relates to an image forming apparatus that forms an image on a recording medium.

FIG. 1 is a schematic diagram of an image forming apparatus according to a first embodiment.

FIG. 2 is a block diagram of the image forming apparatus according to the first embodiment.

FIG. 3 is a schematic diagram of a developing unit, a toner cartridge, and a tray according to the first embodiment.

FIG. 4A is a sectional view of the image forming apparatus according to the first embodiment.

FIG. 4B is a sectional view of the image forming apparatus according to the first embodiment.

FIG. 5 is a perspective view of a rotary body according to the first embodiment.

FIG. 6A is a perspective view of the image forming apparatus according to the first embodiment.

FIG. 6B is a perspective view of the image forming apparatus according to the first embodiment.

FIG. 6C is a perspective view of the image forming apparatus according to the first embodiment.

FIG. 7A is a sectional view of the image forming apparatus according to the first embodiment.

FIG. 7B is a sectional view of the image forming apparatus according to the first embodiment.

FIG. 8 is a view that illustrates the rotary body according to the first embodiment.

FIG. 9 is a view that illustrates the rotary body according to the first embodiment.

FIG. 10 is a view that illustrates the rotary body according to the first embodiment.

FIG. 11A is a view that illustrates a configuration related to the movement of a tray according to the first embodiment.

FIG. 11B is a view that illustrates the configuration related to the movement of the tray according to the first embodiment.

FIG. 12A is a view that illustrates the configuration related to the movement of the tray according to the first embodiment.

FIG. 12B is a view that illustrates the configuration related to the movement of the tray according to the first embodiment.

FIG. 13 is a perspective view of the tray according to the first embodiment.

FIG. 14 shows plan views of the trays according to the first embodiment.

FIG. 15 is a perspective view of the toner cartridge according to the first embodiment.

FIG. 16 is a perspective view of the toner cartridge according to the first embodiment.

FIG. 17 shows plan views of the toner cartridges according to the first embodiment.

FIG. 18 is a view of a state before the toner cartridge is mounted to the tray according to the first embodiment.

FIG. 19A is a perspective view of correct mounting according to the first embodiment.

FIG. 19B is a perspective view of incorrect mounting according to the first embodiment.

FIG. 20A is a plan view of an incorrectly mounted state according to the first embodiment.

FIG. 20B is a plan view of an incorrectly mounted state according to the first embodiment.

FIG. 21 shows plan views of toner cartridges according to a modification.

FIG. 22 shows plan views of trays according to the modification.

FIG. 23 shows plan views of trays according to a modification.

FIG. 24 shows plan views of toner cartridges according to the modification.

FIG. 25 is a perspective view of the image forming apparatus to which the toner cartridge is incorrectly mounted according to the first embodiment.

FIG. 26 is a perspective view of the image forming apparatus to which the toner cartridge is incorrectly mounted according to the first embodiment.

FIG. 27 shows perspective views of indicators of the toner cartridges and indicators of the trays according to the first embodiment.

FIG. 28 shows diagrams that illustrate the closeness of hue between the toner cartridge and the tray according to the first embodiment.

FIG. 29 is a diagram that illustrates the color range of each of the toner cartridge and the tray 80 according to the first embodiment.

FIG. 30A shows a perspective view of the shape of the tray according to the first embodiment.

FIG. 30B shows a plan view of the shape of the tray according to the first embodiment.

FIG. 31A is a perspective view of a toner cartridge and a tray according to a modification.

FIG. 31B is a perspective view of the toner cartridge and the tray according to the modification.

FIG. 32A is a perspective view of an image forming apparatus according to a modification.

FIG. 32B is a perspective view of the image forming apparatus according to the modification.

FIG. 33A is a perspective view of an image forming apparatus according to a modification.

FIG. 33B is a perspective view of the image forming apparatus according to the modification.

FIG. 34A is a view that illustrates a configuration related to a drive system of the tray according to the first embodiment.

FIG. 34B is a view that illustrates the configuration related to the drive system of the tray according to the first embodiment.

FIG. 35A is a view that illustrates the configuration related to the drive system of the tray according to the first embodiment.

FIG. 35B is a view that illustrates the configuration related to the drive system of the tray according to the first embodiment.

FIG. 36A is a perspective view of a stepped gear according to the first embodiment.

FIG. 36B is a perspective view of the stepped gear according to the first embodiment.

FIG. 37 is a perspective view of a lock member according to the first embodiment.

FIG. 38A is a view that illustrates a configuration related to a lock mechanism of the rotary body according to the first embodiment.

FIG. 38B is a view that illustrates the configuration related to the lock mechanism of the rotary body according to the first embodiment.

FIG. 39A is a view that illustrates the configuration related to the lock mechanism of the rotary body according to the first embodiment.

FIG. 39B is a view that illustrates the configuration related to the lock mechanism of the rotary body according to the first embodiment.

FIG. 40A is a perspective view of a drive rack according to the first embodiment.

FIG. 40B is a perspective view of the drive rack according to the first embodiment.

FIG. 40C is a perspective view of the drive rack according to the first embodiment.

FIG. 40D is a perspective view of the drive rack according to the first embodiment.

FIG. 41A is a perspective view of a configuration related to holding of the drive rack according to the first embodiment.

FIG. 41B is a perspective view of the configuration related to holding of the drive rack according to the first embodiment.

FIG. 42A is a perspective view of the rotary body according to the first embodiment.

FIG. 42B is a perspective view of the rotary body according to first embodiment.

FIG. 43A is a view that illustrates a configuration related to regulation of a gear clearance according to the first embodiment.

FIG. 43B is a view that illustrates the configuration related to regulation of the gear clearance according to the first embodiment.

FIG. 43C is a view that illustrates the configuration related to regulation of the gear clearance according to the first embodiment.

FIG. 43D is a view that illustrates the configuration related to regulation of the gear clearance according to the first embodiment.

FIG. 44 is a view that illustrates the configuration related to regulation of the gear clearance according to the first embodiment.

FIG. 45A is a view that illustrates a configuration of an idle gear according to the first embodiment.

FIG. 45B is a view that illustrates the configuration of the idle gear according to the first embodiment.

FIG. 46A is a view that illustrates a configuration related to detection of tray pushing action according to the first embodiment.

FIG. 46B is a view that illustrates the configuration related to detection of tray pushing action according to the first embodiment.

FIG. 46C is a view that illustrates the configuration related to detection of tray pushing action according to the first embodiment.

FIG. 46D is a view that illustrates the configuration related to detection of tray pushing action according to the first embodiment.

FIG. 46E is a view that illustrates the configuration related to detection of tray pushing action according to the first embodiment.

FIG. 47 is a flowchart of a tray insertion operation according to the first embodiment.

FIG. 48 is a flowchart of a tray ejection operation according to the first embodiment.

FIG. 49 shows perspective views of toner cartridges and trays according to a modification.

FIG. 50 is a perspective view of the toner cartridge and the tray according to the modification.

FIG. 51 is a plan view of the toner cartridge and the tray according to the modification.

### DESCRIPTION OF THE EMBODIMENTS

Hereinafter, embodiments of the present disclosure will be described with reference to the attached drawings.

### First Embodiment

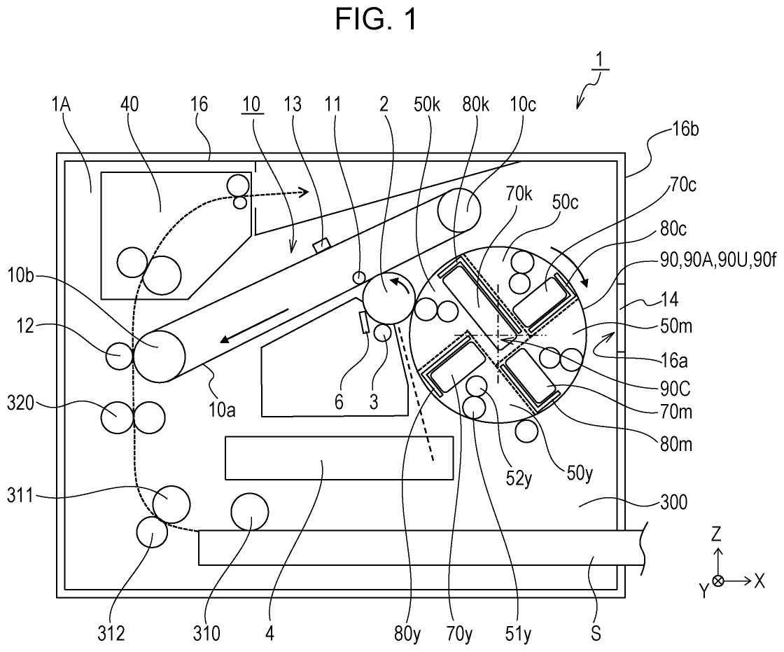

An image forming apparatus 1 according to the first embodiment will be described with reference to FIGS. 1 to 12A, and 12B. In the following description and drawings, a vertical direction in a case where the image forming apparatus 1 is installed on a horizontal plane is defined as Z direction. A direction that crosses the Z direction and that is a direction of a rotation axis 90C of a rotary body 90 (described later) (a rotation axis direction of a rotary) is defined as Y direction. A direction that crosses both the Z direction and the Y direction is defined as X direction. The X direction and the Y direction are preferably a horizontal direction. The X direction, the Y direction, and the Z direction are preferably orthogonal to each other. As needed, the directions of the arrows X, Y, and Z shown in the drawings are referred to as +X side, +Y side, and +Z side, and their opposite sides are referred to as −X side, −Y side, and −Z side.

### Overall Configuration of Image Forming Apparatus

Initially, the overall configuration of the image forming apparatus 1 will be described. The image forming apparatus 1 is a laser beam printer that forms an image on a sheet S by using an electrophotographic method. More specifically, the image forming apparatus 1 is a color laser beam printer including four developing units 50y, 50m, 50c, 50k. Various sheet materials of different sizes and materials, including paper, such as plain paper and thick paper, plastic film, cloth, sheet materials with surface treatment like coated paper, and special-shaped sheet materials, such as envelopes and index paper, can be used as the sheet S that is a recording material (recording medium).

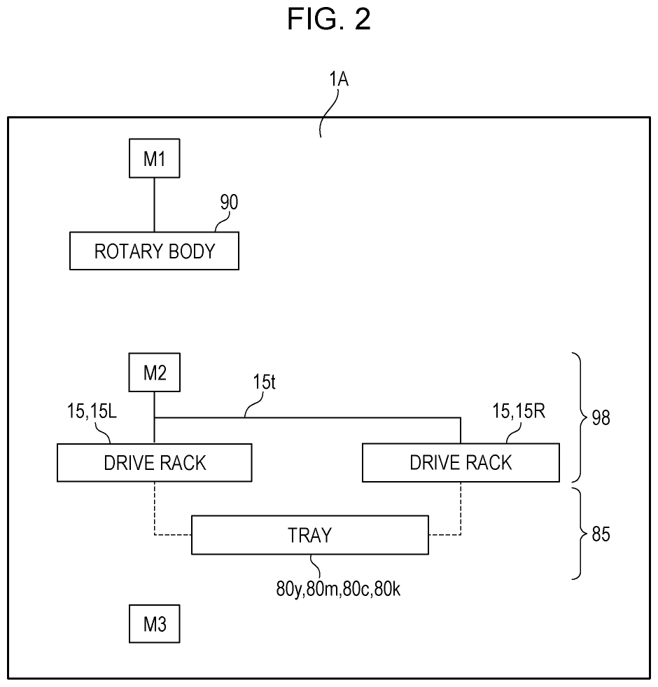

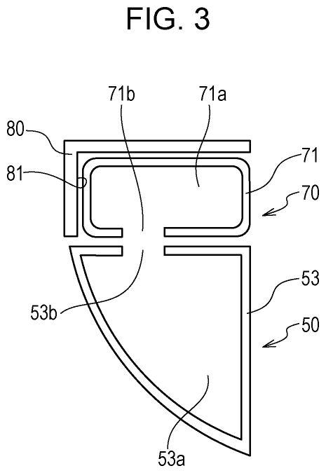

The schematic configuration and image forming operation of the image forming apparatus 1 will be described with reference to FIGS. 1, 2, and 3. FIG. 1 is a schematic diagram that shows the sectional configuration of the image forming apparatus 1. FIG. 2 is a block diagram that illustrates a drive source of the image forming apparatus 1. FIG. 3 is a conceptual diagram that shows a configuration for supplying toner from a toner cartridge 70 to the developing unit 50.

As shown in FIG. 1, the image forming apparatus 1 includes an image forming apparatus body (hereinafter, referred to as apparatus body) 1A, and toner cartridges 70y, 70m, 70c, 70k detachably attached to the apparatus body 1A. The apparatus body 1A of the present embodiment is a portion excluding the toner cartridges 70y, 70m, 70c, 70k from the image forming apparatus 1.

The apparatus body 1A of the image forming apparatus 1 includes an electrophotographic photoconductor (hereinafter, photoconductor drum) 2 having a drum shape (cylindrical shape) as an image carrier that carries an electrostatic latent image. A charge roller 3, a scanner 4 serving as an exposure device, and a cleaning unit 6 are disposed around the photoconductor drum 2.

The charge roller 3 is an example of a charging unit for uniformly electrostatically charging the photoconductor drum 2. The scanner 4 is an example of an exposure unit that performs exposure by irradiating the photoconductor drum 2 with laser beam according to image information. By irradiating the electrostatically charged photoconductor drum 2 with a laser beam, an electrostatic latent image is formed on the surface of the photoconductor drum 2. The cleaning unit 6 is an example of a cleaning unit for removing toner remaining on the surface of the photoconductor drum 2.

The apparatus body 1A includes a sheet storage chamber 300, a pick-up roller 310, a feed roller 311, a separation roller 312, a conveyance roller pair 320, a secondary transfer roller 12, a fuser unit 40, and an intermediate transfer unit 10. The pick-up roller 310 is an example of a sheet feeding unit that feeds sheets S. The feed roller 311 and the separation roller 312 are an example of a separation conveying unit that conveys a sheet S while separating the sheet S one by one using frictional force. The secondary transfer roller 12 is an example of a transfer unit that transfers an image from an intermediate transfer belt 10a to the sheet S.

The intermediate transfer unit 10 includes the intermediate transfer belt 10a, a belt drive roller 10b, a tension roller 10c, a cleaning device 13, and a primary transfer roller 11. The intermediate transfer belt 10a is an example of an intermediate transfer member that carries an image transferred (primary transfer) from the photoconductor drum 2 and conveys the image for transferring (secondary transfer) the image to the sheet S. The intermediate transfer belt 10a is stretched between the belt drive roller 10b and the tension roller 10c. The belt drive roller 10b is a drive member that conveys the intermediate transfer belt 10a by being rotationally driven by a drive source.

The apparatus body 1A includes the rotary body (a rotary, a rotating member) 90 with the developing units 50y, 50m, 50c, 50k. As will be described later, in the present embodiment, trays (support members) 80y, 80m, 80c, 80k are attached to the rotary body 90. The toner cartridges 70y, 70m, 70c, 70k are removably mounted to the trays 80y, 80m, 80c, 80k.

In the following description, a plurality of members and the like having similar functions can be distinguished from each other by assigning numerals. For example, one of the toner cartridges 70y, 70m, 70c, 70k can be referred to as a first toner cartridge (first cartridge), one of the remaining three can be referred to as a second toner cartridge (second cartridge), one of the remaining two can be referred to as a third toner cartridge (third cartridge), and the last one can be referred to as a fourth toner cartridge (fourth cartridge). Similarly, one of the trays 80y, 80m, 80c, 80k can be referred to as a first tray, one of the remaining three can be referred to as a second tray, one of the remaining two can be referred to as a third tray, and the last one can be referred to as a fourth tray. In other words, one of the trays 80y to 80k is an example of a first support member, another one of the trays 80y to 80k is an example of a second support member, yet another one of the trays 80y to 80k is an example of a third support member, and the last one of the trays 80y to 80k is an example of a fourth support member. Numbering is used for the sake of convenience of description and can generally be interchanged as needed.

The developing units (the first to fourth developing units) 50y, 50m, 50c, 50k are examples of a developing unit that develops an electrostatic latent image formed on the photoconductor drum 2 into a toner image using toner of the corresponding color. Each of the developing units 50y, 50m, 50c, 50k develops the electrostatic latent image formed on the photoconductor drum 2 using yellow toner, magenta toner, cyan toner, or black toner. In other words, each of the developing units 50y, 50m, 50c, 50k performs development by using a developer, and the image forming apparatus 1 has a first developer, a second developer, a third developer, and a fourth developer with different colors.

The developing unit 50y includes a developing roller 51y, a supply roller 52y, and a developing blade. The developing roller 51y is a developer carrier that rotates while carrying toner as a developer and supplies the toner to the photoconductor drum 2. The supply roller 52y is a supply member that is disposed so as to contact with the developing roller 51y and that supplies toner to the developing roller 51. The developing blade is a regulating member that regulates the thickness of a toner layer carried on the developing roller 51y. The other developing units 50m, 50c, 50k also include similar developing rollers 51m, 51c, 51k, supply rollers 52m, 52c, 52k, and developing blades, respectively.

The toner cartridges 70y, 70m, 70c, 70k corresponding to the developing units 50y, 50m, 50c, 50k are mounted to the rotary body 90. Yellow toner, magenta toner, cyan toner, and black toner are respectively contained in the toner cartridges 70y, 70m, 70c, 70k as toners to be supplied to the developing units 50y, 50m, 50c, 50k. One of the four-color toners may be regarded as first toner, one of the remaining three-color toners may be regarded as second toner, one of the remaining two-color toners may be regarded as third toner, and the last toner may be regarded as fourth toner. For example, black toner may be regarded as an example of the first toner, and magenta toner may be regarded as an example of the second toner. Numbering is used for the sake of convenience of description and can generally be interchanged as needed.

Here, the rotary body 90 includes a rotary frame 90f that supports the developing units 50y, 50m, 50c, 50k. The developing units 50y, 50m, 50c, 50k are supported by the rotary frame 90f that is a rotatable rotation support member.

The trays 80y, 80m, 80c, 80k are attached to the rotary body 90. A combination of the rotary body 90 and the trays 80y, 80m, 80c, 80k can be referred to as a rotary unit 90U. In other words, the rotary unit 90U includes the rotary body 90 and the trays 80y, 80m, 80c, 80k.

The toner cartridges 70y to 70k are detachably held by the trays 80y to 80k, respectively. As will be described later, the trays 80y to 80k are supported so as to be slidable to the outside of the rotary body 90. A combination of the rotary unit 90U and the toner cartridges 70y, 70m, 70c, 70k can be referred to as a rotary assembly 90A. In other words, the rotary assembly 90A includes the rotary unit 90U and the toner cartridges 70y, 70m, 70c, 70k.

As will be described later, the rotary body 90 is rotatable around the rotation axis (rotation center) 90C. The rotation axis 90C coincides with the rotation axes of the rotary frame 90F, the rotary unit 90U, and the rotary assembly 90A. The rotation axis 90C is substantially parallel to the rotation axis (rotation center) of the photoconductor drum 2.

When the rotary body 90 rotates around the rotation axis 90C, any one of the developing rollers 51y, 51m, 51c, 51k can take a development posture to face the photoconductor drum 2. The posture in which the developing roller 51y faces the photoconductor drum 2 is referred to as a yellow development posture. The posture in which the developing roller 51m faces the photoconductor drum 2 is referred to as a magenta development posture. The posture in which the developing roller 51c faces the photoconductor drum 2 is referred to as a cyan development posture. The posture in which the developing roller 51k faces the photoconductor drum 2 is referred to as a black development posture. In other words, the rotary body 90 can rotate around the rotation axis 90C so that the positions of the developing rollers 51y, 51m, 51c, 51k relative to the photoconductor drum 2 change. The black development posture is an example of a first development posture in which a first developing roller (developing roller 51k) faces the photoconductor drum 2. The other development postures are examples of a second development posture in which a second developing roller (any one of the developing rollers 51y to 51c) faces the photoconductor drum 2. The yellow, magenta, cyan, and black development postures can also be referred to as first to fourth development postures. Numbering is used for the sake of convenience of description and can generally be interchanged as needed.

As shown in FIG. 2, the apparatus body 1A includes motors M1, M2, M3 as drive sources. As will be described later, the motor M1 supplies driving force for rotating the rotary body 90 around the rotation axis 90C. In other words, the motor M1 rotates the rotary assembly 90A and the rotary unit 90U around the rotation axis 90C.

The apparatus body 1A includes a drive device 98 including the motor M2 and a transmission device. The transmission device includes drive racks 15R, 15L serving as drive gears (described later), and a transmitting unit 15t. The driving force of the motor M2 is transmitted to the drive racks 15R, 15L by the transmitting unit 15t. In other words, the motor M2 is configured to drive the drive racks 15R, 15L and moves the trays 80y, 80m, 80c, 80k relative to the rotary body 90 through the drive racks 15R, 15L.

The motor M3 drives members other than the members driven by the motor M1 or the motor M2. For example, the motor M3 drives the photoconductor drum 2, the developing units 50y, 50m, 50c, 50k, the pick-up roller 310, the feed roller 311, the conveyance roller pair 320, the secondary transfer roller 12, the belt drive roller 10b, and the fuser unit 40.

The members driven by the motors M1, M2, M3 can be changed as needed. The roles of any two or three of the motors M1, M2, M3 may be consolidated into a single motor. On the other hand, another drive source other than the motors M1, M2, M3 may be added.

The suffixes y, m, c, and k of the developing units 50y, 50m, 50c, 50k, the toner cartridges 70y, 70m, 70c, 70k, and the trays 80y, 80m, 80c, 80k each indicate the color of toner. The basic configurations and functions of the developing units 50y, 50m, 50c, 50k are common. The basic configurations and functions of the toner cartridges 70y, 70m, 70c, 70k are common. The basic configurations and functions of the trays 80y, 80m, 80c, 80k are common. Therefore, when the units, cartridges, or trays do not need to be distinguished from one another, the suffixes y, m, c, and k are omitted, and the units, cartridges, or trays will be described on the assumption that there is any one of the four units, cartridges, or trays. When the four units, cartridges, or trays are distinguished from one another, they will be described on the assumption that each of them is one of the four units, cartridges, or trays corresponding to the suffix y, m, c, or k.

As shown in FIG. 3, the toner cartridge 70 includes a toner frame 71. The toner frame 71 has a toner storage chamber 71a that contains toner, and a discharge opening 71b that communicates with the toner storage chamber 71a.

The developing unit 50 has a developing frame (storage frame) 53. The developing frame 53 includes a developing-side storage chamber 53a and a receiving opening 53b that communicates with the developing-side storage chamber (toner supply chamber) 53a. In other words, the rotary body 90 includes a developing frame 53y, a developing frame 53m, a developing frame 53c, and a developing frame 53k. In other words, the rotary body 90 includes a first developing chamber, a second developing chamber, a third developing chamber, and a fourth developing chamber. As described earlier, the developing unit 50 includes the developing roller 51, the supply roller 52, and the like; however, these components are omitted in FIG. 3.

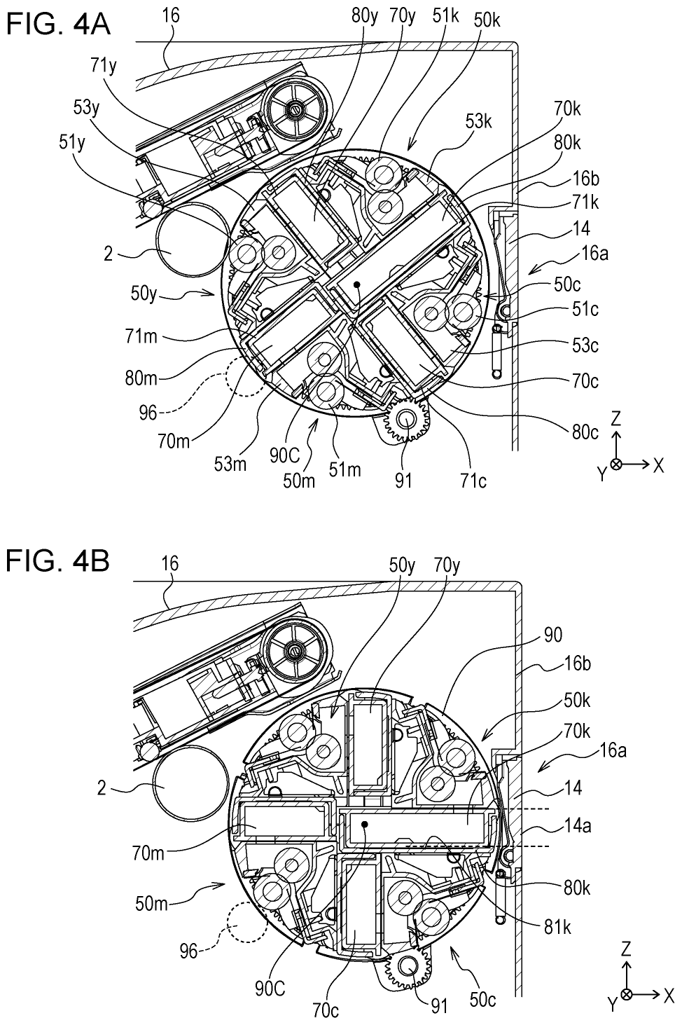

The developing roller 51k of the developing unit 50k is an example of the first developing roller. The developing roller 51m of the developing unit 50m is an example of the second developing roller. The developing frame 53k of the developing unit 50k (FIG. 4A) with the developing-side storage chamber 53a is an example of a first storage frame having a first storage chamber. The developing frame 53m of the developing unit 50m (FIG. 4A) with the developing-side storage chamber 53a is an example of a second storage frame having a second storage chamber. The rotary body 90 is an example of a rotatable rotary including the first developing roller, the second developing roller, the first storage frame having the first storage chamber, and the second storage frame having the second storage chamber. In the present embodiment, the rotary body 90 includes first to fourth developing rollers and first to fourth storage frames.

As will be described later, the toner cartridge 70 is movable relative to the developing frame 53 between a mounting position and a retreat position moved from the mounting position. The discharge opening 71b faces the receiving opening 53b in a state where the toner cartridge 70 is at the mounting position relative to the developing frame 53. In other words, the toner storage chamber 71a of the toner cartridge 70 and the developing-side storage chamber 53a of the developing unit 50 communicate with each other via the discharge opening 71b and the receiving opening 53b. When toner is supplied from the toner cartridge 70 to the developing unit 50, at least part of the receiving opening 53b is positioned below at least part of the discharge opening 71b.

Then, toner contained in the toner storage chamber 71a is discharged from the discharge opening 71b, and the toner discharged from the discharge opening 71b is put into the developing-side storage chamber 53a through the receiving opening 53b. In other words, the rotary body 90 includes a first developing chamber configured to store the first developer supplied from the first cartridge. The rotary body 90 includes a second developing chamber configured to store the second developer supplied from the second cartridge. The rotary body 90 includes a third developing chamber configured to store the third developer supplied from the third cartridge. The rotary body 90 includes a fourth developing chamber configured to store the fourth developer supplied from the fourth cartridge. In other words, the first developer is supplied to the first developing chamber of the rotary body 90, the second developer is supplied to the second developing chamber, the third developer is supplied to the third developing chamber, and the fourth developer is supplied to the fourth developing chamber.

The toner contained in the developing-side storage chamber 53a is supplied to the developing roller 51 by the supply roller 52. The toner contained in the toner storage chamber 71a is supplied to the developing roller 51 through this route.

The toner cartridge 70 desirably includes a sealing member (first sealing member) (not shown) that covers the discharge opening 71b. The developing unit 50 desirably includes a sealing member (second sealing member) (not shown) that covers the receiving opening 53b.

In a state where the toner cartridge 70 is not mounted to the developing unit 50, the discharge opening 71b and the receiving opening 53b are desirably covered by the sealing members to suppress the outflow of toner from the discharge opening 71b and the receiving opening 53b.

### Image Forming Operation

The image forming operation in the present embodiment will be described. First, the photoconductor drum 2 is rotated in the direction of the arrow in FIG. 1 (counterclockwise) in synchronization with the rotation of the intermediate transfer belt 10a. Then, the surface of the photoconductor drum 2 is uniformly charged with the charge roller 3.

When forming a color image on a sheet S, the rotary body 90 rotates in the direction of the arrow in FIG. 1 (clockwise) while supporting the developing units 50y, 50m, 50c, 50k as described below. After that, while the developing rollers 51y, 51m, 51c, 51k are moved to a developing position one by one, an electrophotographic process is repeatedly performed.

First, the scanner 4 applies laser beam based on image data corresponding to a yellow image to form a static latent image corresponding to the yellow image on the surface of the photoconductor drum 2. In parallel with the formation of the electrostatic latent image, the motor M1 rotates the rotary body 90 to cause the rotary body 90 to take the yellow development posture. When the rotary body 90 is in the yellow development posture, the developing roller 51y is at the developing position and develops the electrostatic latent image formed on the photoconductor drum 2 by using yellow toner.

In the present embodiment, each of the developing rollers 51y, 51m, 51c, 51k is an elastic roller in which a metal shaft is coated with rubber. At the developing position, each of the developing rollers 51y, 51m, 51c, 51k develops an electrostatic latent image in a state of being in contact with the photoconductor drum 2. In other words, the image forming apparatus 1 in the present embodiment adopts a contact developing method. However, at the developing position, each of the developing rollers 51y, 51m, 51c, 51k may develop an electrostatic latent image in a state where there is a gap from the photoconductor drum 2. In other words, the image forming apparatus 1 may adopt a noncontact developing method.

When the yellow toner image is developed, the yellow toner image on the photoconductor drum 2 is primarily transferred to the intermediate transfer belt 10a by the primary transfer roller 11 disposed inside the intermediate transfer belt 10a.

After this, the rotary body 90 is rotated to move the developing rollers 51m, 51c, 51k in sequence to the developing position, and a toner image of the corresponding color is formed. In other words, after the yellow toner image is formed on the intermediate transfer belt 10a, the rotary body 90 takes the magenta development posture, and a magenta toner image is formed on the intermediate transfer belt 10a. After the magenta toner image is formed on the intermediate transfer belt 10a, the rotary body 90 takes the cyan development posture, and a cyan toner image is formed on the intermediate transfer belt 10a. After the cyan toner image is formed on the intermediate transfer belt 10a, the rotary body 90 takes the black development posture, and a black toner image is formed on the intermediate transfer belt 10a.

Then, primary transfer is repeated such that four toner images are overlaid on the intermediate transfer belt 10a, with the result that a color image is formed on the intermediate transfer belt 10a. The secondary transfer roller 12 and the cleaning device 13 do not contact with the intermediate transfer belt 10a until a color image is formed on the intermediate transfer belt 10a.

On the other hand, a sheet S is fed by the pick-up roller 310 from the sheet storage chamber 300 provided at the bottom of the apparatus body 1A. The sheets S are separated into individual sheets by the feed roller 311 and the separation roller 312 and sent to the conveyance roller pair 320. The conveyance roller pair 320 sends the fed sheet S to a transfer portion (secondary transfer portion) that is a nip portion between the intermediate transfer belt 10a and the secondary transfer roller 12. The color image on the intermediate transfer belt 10a is transferred to the surface of the conveyed sheet S (secondary transfer).

The sheet S with a color image transferred is sent to the fuser unit 40. In the fuser unit 40, the sheet S is heated and pressed to fix the image onto the sheet S. The sheet S having passed through the fuser unit 40 is discharged to the outside of the image forming apparatus 1 as a product.

On the other hand, when forming a monochrome image on a sheet S, the rotary body 90 takes the black development posture. In this state, after an electrostatic latent image is formed on the surface of the photoconductor drum 2 as a result of charging and exposure of the photoconductor drum 2, the electrostatic latent image is developed using black toner by the developing roller 51k positioned at the developing position. The black toner image is primarily transferred to the intermediate transfer belt 10a and then secondarily transferred to a sheet S. The subsequent processes are similar to those in the case of color images.

### Rotary Configuration

The configuration of the rotary body 90 will be described with reference to FIGS. 1, 4A, 4B, and 5.

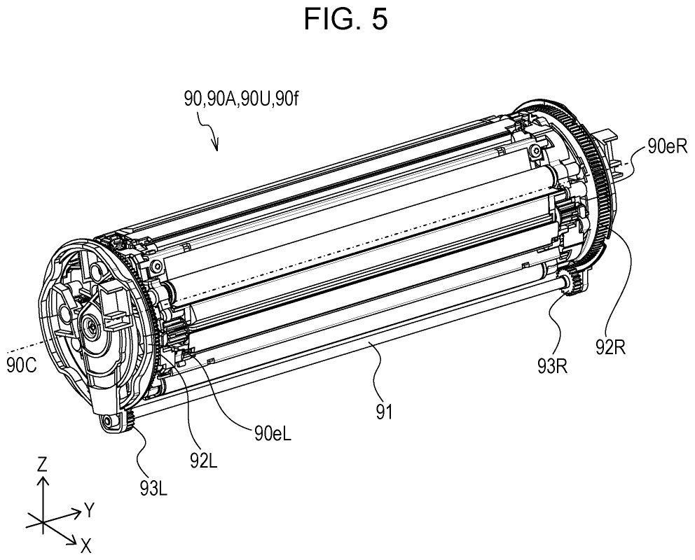

FIGS. 4A and 4B are sectional views that show the rotary body 90 of the image forming apparatus 1 and its surroundings. FIGS. 4A and 4B are sectional views of the apparatus, taken along an imaginary plane perpendicular to the rotation axis 90C of the rotary body 90. FIG. 5 is a perspective view of the rotary body 90.

As described earlier, the toner cartridges 70y to 70k are detachably attached to the rotary body 90. A user is able to supply toner to the image forming apparatus 1 by replacing the toner cartridges 70y to 70k when toner inside the toner cartridges 70y to 70k runs out.

As shown in FIG. 1, the apparatus body 1A includes a frame 16 that accommodates the rotary body 90.

The frame 16 is a main body frame of the image forming apparatus 1 of the present embodiment. The frame 16 is the housing (framework) of the apparatus body 1A made up of a frame and an exterior member. The frame 16 has a substantially rectangular parallelepiped shape in the present embodiment.

The frame 16 has an opening 16a. More specifically, the frame 16 includes a side surface 16b that expands in a direction that crosses the horizontal direction. The side surface 16b makes up at least part of a plus X-side outer appearance surface of the apparatus body 1A. The opening 16a is disposed at the side surface 16b. The side surface 16b is a side surface disposed downstream of an outlet of the apparatus body 1A in a discharge direction in which a sheet S with a formed image is discharged. A user is able to access the sheet storage chamber 300 from the side surface 16b side of the image forming apparatus 1 to replenish the sheet storage chamber 300 with sheets S or collect a sheet S discharged from the outlet. Therefore, the side surface 16b may be regarded as the front (front face) of the apparatus body 1A.

The toner cartridges 70y, 70m, 70c, 70k can be attached to and detached from the rotary body 90 through the opening 16a. In other words, the toner cartridge 70k may be regarded as an example of a first toner cartridge that contains toner supplied to the first developing roller (developing roller 51k) and that can be attached to and detached from the rotary (rotary body 90) through the opening 16a of the frame 16 of the apparatus body 1A. The toner cartridge 70m may be regarded as an example of a second toner cartridge that contains toner supplied to the second developing roller (developing roller 51m) and that can be attached to and detached from the rotary (rotary body 90) through the opening 16a of the frame 16 of the apparatus body 1A.

In the present embodiment, the toner cartridges 70y, 70m, 70c, 70k are attached to and detached from the rotary body 90 through the opening 16a in a state of being supported by the trays 80y to 80k. In other words, a user is able to attach and detach the toner cartridges 70y to 70k to and from the rotary body 90 via the trays 80y to 80k.

The opening 16a is disposed at the side surface 16b of the frame 16. In the present embodiment, the side surface 16b is a surface that is substantially parallel to the rotation axis 90C of the rotary body 90. Therefore, when the toner cartridge 70 is replaced, the toner cartridge 70 passes through the opening 16a in a direction that crosses (preferably, a direction orthogonal to) the rotation axis 90C.

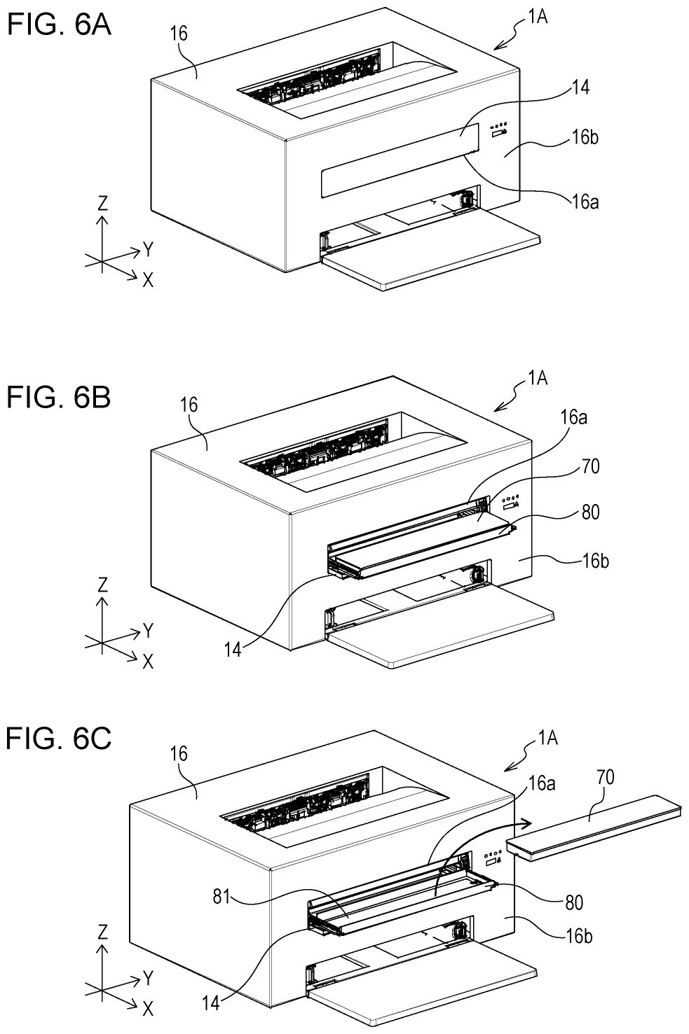

The image forming apparatus 1 includes a door 14 that covers the opening 16a of the frame 16. The door 14 is an opening and closing member movable between a closed position at which the opening 16a is covered (see FIG. 6A) and an open position at which the opening 16a is exposed (see FIGS. 6B and 6C).

As described above, in the present embodiment, the toner cartridge 70 is configured to be detachably attachable to the rotary body 90 via the tray 80. Therefore, the toner cartridge 70 can be stably attached to and detached from the rotary body 90.

More specifically, a user is able to replace the toner cartridge 70 by performing operation to attach and detach the toner cartridge 70 to and from the tray 80 configured to be movable relative to the rotary body 90 (that is, relative to the apparatus body 1A). When the user directly replaces the toner cartridge by directly removing the toner cartridge from the apparatus body and inserting a toner cartridge to the apparatus body, the user is asked to insert the toner cartridge into the predetermined mounting position inside the apparatus body. In the present embodiment, the tray 80 is movable in the state of supporting the toner cartridge 70 so that the toner cartridge 70 moves to the mounting position. Therefore, a user is able to replace the toner cartridge 70 through easy operation, that is, by putting the toner cartridge 70 on the tray 80, so the operability improves.

The toner cartridge 70 has an elongated shape extending in a longitudinal direction set to the Y direction parallel to the rotation axis 90C of the rotary body 90. In other words, the dimension of the toner cartridge 70 in the longitudinal direction is larger than the height and width in a cross section orthogonal to the longitudinal direction. When the toner cartridge 70 with such an elongated shape is handled, the toner cartridge 70 can be passed through the opening 16a with a short moving distance by disposing the opening 16a at the side surface 16b of the frame 16 that is substantially parallel to the longitudinal direction (Y direction) of the toner cartridge 70. For example, replacing the toner cartridges 70 is easier compared to removing and inserting the toner cartridge 70 through an opening provided at one-side (+Y-side or −Y-side) side surface of the frame 16 in the longitudinal direction of the toner cartridge 70.

The rotary body 90 can rotate around the rotation axis 90C to take a replacement posture in which removal of any one of the toner cartridges 70y to 70k from the rotary body 90 is allowed. The posture in which removal of the toner cartridge 70y is allowed is referred to as yellow replacement posture. The posture in which removal of the toner cartridge 70m is allowed is referred to as magenta replacement posture. The posture in which removal of the toner cartridge 70c is allowed is referred to as cyan replacement posture.

The posture in which removal of the toner cartridge 70k is allowed is referred to as black replacement posture. The black replacement posture is an example of a first replacement posture in which removal of the first toner cartridge from the rotary is allowed. The yellow, magenta, and cyan replacement postures are examples of a second replacement posture in which removal of the second toner cartridge from the rotary is allowed. The yellow, magenta, cyan, and black replacement postures may also be referred to as first to fourth replacement postures. Numbering is used for the sake of convenience of description and can generally be interchanged as needed.

FIG. 4A shows the cross section of the rotary body 90 in a development posture (specifically, in the yellow development posture). FIG. 4B shows the cross section of the rotary body 90 in a replacement posture (specifically, the black replacement posture).

As shown in FIGS. 4A and 4B, four trays 80y to 80k are attached to the rotary body 90. The trays 80y to 80k respectively hold the toner cartridges 70y to 70k. In FIGS. 4A and 4B, the trays 80y to 80k are accommodated inside the rotary body 90, and this state may be regarded as a state where the toner cartridges 70y to 70k are mounted to the developing units 50y, 50m, 50c, 50k.

As described above, the toner cartridge 70 is movable relative to the developing frame 53 of the developing unit 50 between the mounting position and the retreat position moved from the mounting position. In other words, the first toner cartridge (toner cartridge 70k) is movable relative to the first storage frame (developing frame 53k) between a first mounting position and a first retreat position. The second toner cartridge (toner cartridge 70m) is movable relative to the second storage frame (developing frame 53m) between a second mounting position and a second retreat position.

The discharge opening 71b and the receiving opening 53b face each other as shown in FIG. 3 in a state where the toner cartridge 70 is at the mounting position relative to the developing frame 53. In this state, the toner cartridge 70 is configured to supply toner to the developing-side storage chamber 53a through the receiving opening 53b (the opening of the storage frame).

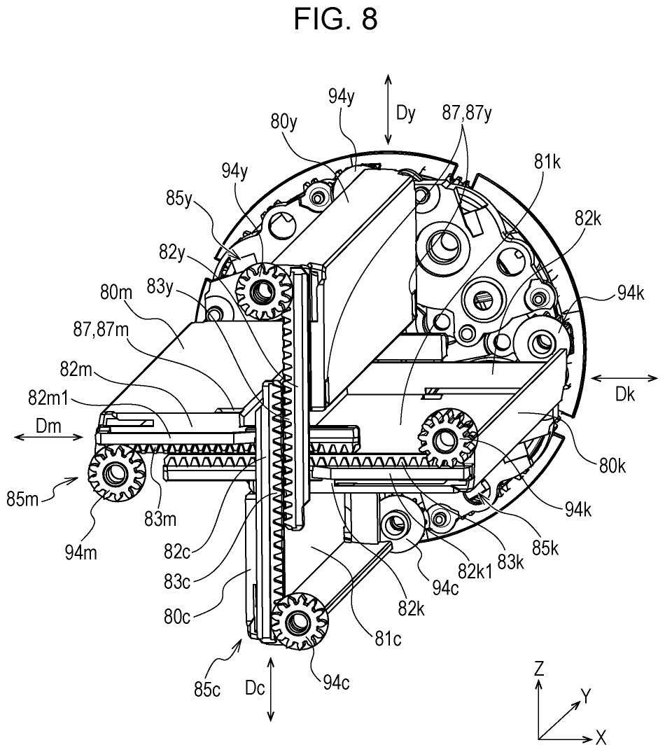

The apparatus body 1A includes a moving device 85 configured to move the toner cartridge 70 from the mounting position to the retreat position relative to the rotary body 90 (more specifically, relative to the developing frame 53 of the developing unit 50). The moving device 85 will be described later with reference to FIG. 8 and the like. In the present embodiment, a plurality of moving devices 85y to 85k corresponding to the plurality of toner cartridges 70y to 70k is disposed in the rotary body 90. The trays 80y to 80k may be regarded as parts of the moving devices 85y to 85k.

In the present embodiment, the toner cartridge 70k containing black toner has a larger size and can contain a larger amount of toner than the toner cartridges 70y to 70c respectively containing yellow toner, magenta toner, and cyan toner. In other words, the first toner cartridge can contain a first amount of toner, and the second toner cartridge can contain a second amount of toner, so the first amount is regarded as being greater than the second amount.

Specifically, the length of the black toner cartridge 70k in a first radial direction relative to the rotation axis 90C of the rotary body 90 is greater than the length of the magenta toner cartridge 70m in a second radial direction. Here, the first radial direction refers to the radial direction of the rotary body 90 (the radial direction of an imaginary circle centered on the rotation axis 90C) and is a direction in which the toner cartridge 70k extends relative to the rotation axis 90C when viewed in the direction of the rotation axis 90C. The second radial direction is the radial direction of the rotary body 90 and is a direction in which the toner cartridge 70m extends relative to the rotation axis 90C when viewed in the direction of the rotation axis 90C. Similarly, the length of the black toner cartridge 70k in the first radial direction is greater than the length of the toner cartridges 70y, 70c in the radial directions corresponding to the other toner cartridges 70y, 70c.

Therefore, the tray 80k that holds the black toner cartridge 70k is larger in size than the trays 80y to 80c that hold the other toner cartridges 70y, 70m, 70c. In other words, the four toner cartridges 70y to 70k and trays 80y to 80k with different sizes are disposed inside the rotary body 90. In other words, the toner cartridge 70k that is an example of the first toner cartridge, and the toner cartridge 70y that is an example of the second toner cartridge smaller in size than the first toner cartridge are attachable to and detachable from the rotary body 90. In accordance with this, the rotary body 90 includes the tray 80k that is an example of the first support member supporting the first toner cartridge and the tray 80y that is an example of the second support member smaller in size than the first support member. The toner cartridges 70m, 70c that are examples of the third toner cartridge and the fourth toner cartridge smaller in size than the first toner cartridge are attachable to and detachable from the rotary body 90. In accordance with this, the rotary body 90 includes the trays 80m, 80c that are examples of the third support member and the fourth support member smaller in size than the first support member.

Here, the rotational drive of the rotary body 90 will be described with reference to FIG. 5. As shown in FIG. 5, disk gears 92R, 92L are respectively provided at both ends of the rotary body 90. Rotary drive gears 93R, 93L are respectively drivably connected to both ends of a pivot shaft 91. Here, the driving force of the motor M1 is transmitted to the rotary drive gear 93R by a drive transmission mechanism. Subsequently, the rotary body 90 is rotationally driven by the driving force transmitted to the disk gears 92R, 92L by the rotary drive gears 93R, 93L.

The rotary body 90 is supported so as to be pivotable about the pivot shaft 91. The rotary body 90 is urged by an urging member (not shown) in a counterclockwise direction in FIGS. 4A and 4B about the pivot shaft 91. This direction may be regarded as the direction in which each of the developing rollers 51y to 51k approaches the photoconductor drum 2. As a result, in a state where the rotary body 90 is in the development posture, each of the developing rollers 51y to 51k contacts with the photoconductor drum 2.

On the other hand, as shown in FIG. 5, rotary cams 90eR, 90eL are provided at both ends of the rotary body 90. When the rotary body 90 rotates clockwise in FIGS. 4A and 4B about the rotation axis 90C, the rotary cams 90eR, 90eL contact with a roller 96 (FIGS. 4A and 4B) supported by the frame 16. Then, the rotary body 90 moves in a clockwise direction in FIGS. 4A and 4B about the pivot shaft 91. This direction may be regarded as a direction in which each of the developing rollers 51y to 51k moves away from the photoconductor drum 2. This direction may be regarded as a direction in which the rotary body 90 approaches the opening 16a of the frame 16 and the door 14.

Thus, when the rotary body 90 rotates to switch from the development posture to the replacement posture, the rotary body 90 pivots about the pivot shaft 91. In a state where the rotary body 90 is in the replacement posture, the developing roller 51 separates from the photoconductor drum 2.

As shown in FIG. 4B, in the black replacement posture, the toner cartridge 70k stops at a position at which the toner cartridge 70k faces the opening 16a and the door 14 both provided at the side surface 16b of the apparatus body 1A. From this state, when the tray 80k is slid from the mounting position for the developing unit 50k to the outside of the rotary body 90, a user is able to replace the toner cartridge 70k.

### Replacement Operation of Toner Cartridge

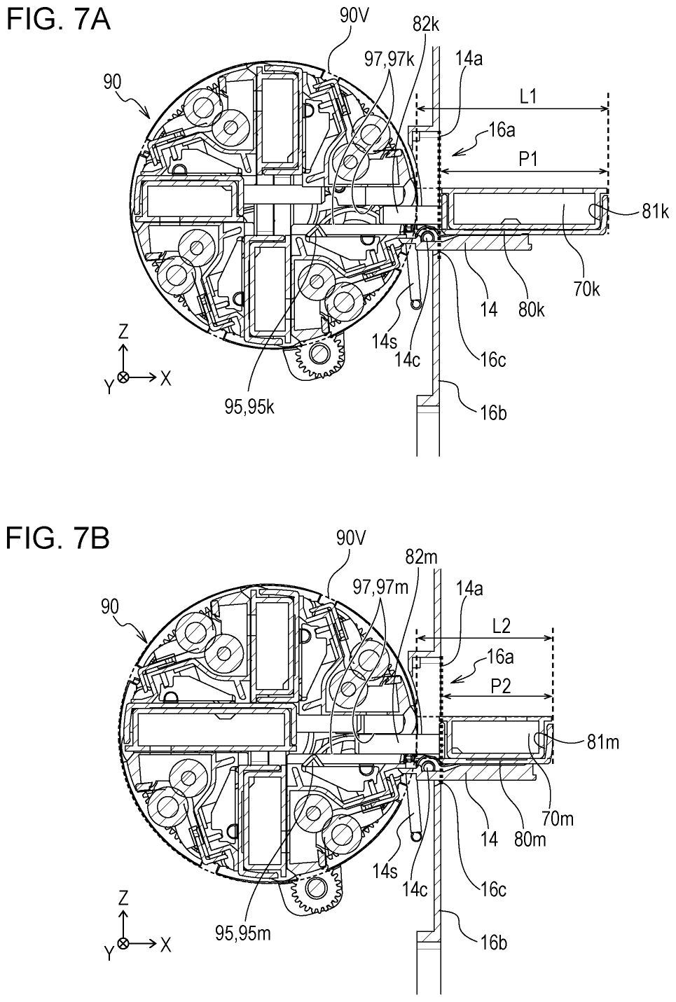

The toner cartridge replacement operation will be described with reference to FIGS. 4A, 6A to 6C, 7A, and 7B. FIGS. 6A to 6C are outer appearance views of the apparatus body 1A. FIGS. 7A and 7B are sectional views around the rotary body 90 when the toner cartridge is replaced. FIGS. 7A and 7B are sectional views of the apparatus, taken along an imaginary plane perpendicular to the rotation axis 90C of the rotary body 90.

FIG. 6A is the outer appearance of the apparatus body 1A during image forming operation and in a standby state. During the image forming operation, the image forming apparatus 1 is performing a series of operations in which the image forming apparatus 1 feeds a sheet S, forms an image on the sheet S, and then discharges the sheet S as a product. The standby state is a state in which the image forming apparatus 1 can start the image forming operation when receiving an image forming instruction (print instruction) and is a state of waiting for an image forming instruction from a user. As shown in FIG. 6A, the door 14 is in a closed state during the image forming operation and in the standby state.

FIG. 6B is the outer appearance of the apparatus body 1A when the toner cartridge is replaced. When the toner cartridge is replaced, the door 14 is placed in the open state, and the tray 80 and the toner cartridge 70 are moved to the outside of the apparatus body 1A.

The toner cartridge 70 is movable relative to the developing frame 53 of the developing unit 50 between the mounting position and the retreat position moved from the mounting position. The discharge opening 71b and the receiving opening 53b face each other as shown in FIG. 3 in a state where the toner cartridge 70 is at the mounting position relative to the developing frame 53. As shown in FIGS. 4A and 4B, the rotary body 90 is configured to rotate around the rotation axis 90C to take the development posture or the replacement posture when the toner cartridge 70 is at the mounting position.

The toner cartridge replacement operation will be described. Initially, the user instructs the control unit of the apparatus body 1A to perform the toner cartridge replacement operation. The instruction for the toner cartridge replacement operation is provided by input through an operating panel (operating unit) provided, for example, on the apparatus body 1A.

When the control unit receives the instruction for toner cartridge replacement operation, the rotary body 90 rotates to the replacement posture of the toner cartridge 70 to be replaced (toner-empty toner cartridge 70) and stops. In other words, the control unit rotates the rotary body 90 to the replacement posture of the toner cartridge designated in the instruction for toner cartridge replacement operation (the black replacement posture for replacing the black toner cartridge 70k in FIG. 4B). In the replacement posture, the tray 80 supporting the designated toner cartridge 70 for replacement faces the opening 16a of the frame 16 of the apparatus body 1A.

For example, the rotary body 90 in FIG. 4B is in the yellow development posture in which the yellow developing roller 51y faces the photoconductor drum 2. At this time, the black toner cartridge 70k and the corresponding tray 80k do not need to face the opening 16a and the door 14. In other words, the toner cartridge 70 and the tray 80 do not need to face the opening 16a and the door 14 when the rotary body 90 is in a replacement posture other than the replacement posture of the toner cartridge, or a development posture. Therefore, the opening 16a just needs to have a size enough for each toner cartridge 70 to pass through individually. When the rotary body 90 rotates from the yellow development posture by a predetermined angle clockwise in the drawing, the black toner cartridge 70k and the tray 80k face the opening 16a and the door 14 as shown in FIG. 4B.

Here, “the tray 80 faces the opening 16a” means that the tray 80 is positioned so that the tray 80 is movable to the outside of the apparatus body 1A through the opening 16a. In other words, when the tray 80 faces the opening 16a, the tray 80 is moved to the radially outer side of the rotary body 90 by a moving mechanism (described later), with the result that the tray 80 and the toner cartridge 70 supported by the tray 80 can protrude to the outside of the apparatus body 1A. In FIG. 4A, none of the trays 80y to 80k are facing the opening 16a. In FIG. 4B, only the black tray 80k faces the opening 16a, while the other trays 80y to 80c do not face the opening 16a.

When the rotary body 90 is positioned in the replacement posture, the tray 80 supporting the toner cartridge 70 to be replaced is moved toward the outside of the apparatus body 1A by the motor M2.

As a result, the toner cartridge 70 to be replaced moves from the mounting position to the retreat position relative to the rotary body 90. As shown in FIGS. 6B, 6C, 7A, and 7B, the tray 80 and the toner cartridge 70 to be replaced, supported by the tray 80, protrude to the outside of the apparatus body 1A through the opening 16a.

More specifically, the tray 80 is movable relative to the rotary body 90 between a storage position and an eject position. In other words, the first tray is movable relative to the rotary body 90 between the storage position (second position) and the eject position (first position). The second tray is movable relative to the rotary body 90 between the storage position (fourth position) and the eject position (third position). The storage position is a position at which the tray 80 is stored in the rotary body 90. The eject position is a position at which the tray 80 protrudes to the outside of the rotary body 90 and the toner cartridge 70 is allowed to be removed from the tray 80 (removal position, replaceable position). Examples of the storage position include the positions of the trays 80y to 80k in FIGS. 4A and 4B. Examples of the eject position include the positions of the tray 80 in FIGS. 6B and 6C, the tray 80k in FIG. 7A, and the tray 80m in FIG. 7B.

When the tray 80 is at the storage position, the toner cartridge 70 attached to the tray 80 is positioned inside the rotary body 90 and positioned at the mounting position. When the tray 80 is at the eject position, the toner cartridge 70, to which the tray 80 is attached, is positioned outside of the rotary body 90 and positioned at the retreat position.

Here, as shown in FIGS. 7A and 7B, the rotary body 90 has protrusions 95 to hold the tray 80 at the storage position and to hold the toner cartridge 70 at the mounting position. As shown in FIG. 8, the tray 80 has recesses 87 that fit the protrusions 95. FIGS. 7A and 7B show protrusions 95k, 95m corresponding to the trays 80k, 80m, and FIG. 8 shows recesses 87y, 87m of the trays 80y, 80m; however, the protrusions 95 and the recesses 87 are provided for each of the trays 80y to 80k. The protrusions 95 are preferably urged in a direction to engage with the recesses 87.

When the protrusions 95 fit the recesses 87 of the tray 80, the tray 80 is locked to the rotary frame 90f. This makes the tray 80 stay at the storage position even when the rotary body 90 rotates and prevents the movement of the toner cartridge 70 from the mounting position. When the tray 80 is moved between the storage position and the eject position by the moving device (described later), the protrusions 95 can be configured to be moved by the tray 80 to come off from the recesses 87.

In the present embodiment, the door 14 is pivotally supported relative to the apparatus body 1A. As shown in FIG. 7A, the door 14 is urged from the open position toward the closed position by a spring 14s. The spring 14s is, for example, a tension spring that urges the door 14 to generate moment in the counterclockwise direction in FIGS. 7A and 7B about a support shaft 14c of the door 14.

The tray 80 pushes the door 14 to place the door 14 in the open state (the state shown in FIG. 6B). This state can also be referred to as a state where the tray 80 is supported by the door 14. The door 14 supports at least part of the tray 80 protruding to the outside of the apparatus body 1A, with the result that the toner cartridge 70 can be further stably supported. In other words, when the first toner cartridge (toner cartridge 70k) is at the first retreat position, the opening and closing member (door 14) at the open position supports the first support member (tray 80k). When the second toner cartridge (any one of the toner cartridges 70y to 70c) is at the second retreat position, the opening and closing member (door 14) at the open position supports the second support member (a corresponding one of the trays 80y to 80c).

The door 14 is configured to contact with a part (for example, a lower edge 16c of the opening 16a) of the frame 16 of the apparatus body 1A at the open position and not to pivot downward beyond the open position. When the tray 80 is pulled back from the outside to the inside of the apparatus body 1A, the door 14 returns to the closed position due to the urging force of the spring 14s.

The toner cartridge 70 is detachably held by the tray 80. Therefore, as shown in FIG. 6C, a user is able to perform the work for removing the toner cartridge 70 from the tray 80 and attaching a new toner cartridge 70 (replacement work). When the plurality of toner cartridges 70 is replaced, replacement work can be performed by repeating the above-described actions.

FIGS. 7A and 7B show a cross-section around the rotary body 90 when the toner cartridge is replaced. FIG. 7A shows a state when the black toner cartridge 70k is replaced. FIG. 7B shows a state when the magenta toner cartridge 70m is replaced.

The image forming apparatus 1 includes moving devices 85 (FIG. 8) that respectively move the toner cartridges 70 from the mounting position to the retreat position. In the present embodiment, it may be understood that each of the moving devices 85 includes the tray 80. The moving device 85k including the tray 80k may be regarded as an example of a first moving device including the first support member. The moving device 85m including the tray 80m may be regarded as an example of a second moving device including the second support member.

Even when the toner cartridge 70 is at the retreat position, the tray 80 is still connected to the rotary body 90 (supported by the rotary body 90). To easily perform operation to remove the toner cartridge 70 from the rotary body 90, the length by which the toner cartridge 70 protrudes from the rotary body 90 at the retreat position is preferably long. Since the toner cartridge 70 is configured to be detachably attachable to the rotary body 90 via the tray 80, the toner cartridge 70 can be stably supported by the tray 80 even when the length by which the toner cartridge 70 protrudes from the rotary body 90 is long.

The moving direction of the toner cartridge 70 when the toner cartridge 70 moves from the mounting position to the retreat position is referred to as a retreat direction. In the present embodiment, the retreat direction of the toner cartridge 70 is a direction that crosses the direction of the rotation axis 90C (Y direction). Therefore, as shown in FIGS. 7A and 7B, when viewed in the direction of the rotation axis 90C (Y direction), the retreat direction of the toner cartridge 70 is a direction orthogonal to the direction of the rotation axis 90C (Y direction). The retreat direction of the toner cartridge 70 may be regarded as a direction outward in the radial direction of the rotary body 90 (a direction away from the rotation axis 90C).

As shown in FIGS. 7A and 7B, because the user performs operation to remove the toner cartridge 70 from the rotary body 90, at least part of the toner cartridge 70 preferably protrudes from the rotary body 90 when the toner cartridge 70 is removed. In the present embodiment, when the toner cartridge 70 is at the retreat position, the entire toner cartridge 70 protrudes from the rotary body 90.

When the rotary body 90 rotates around the rotation axis 90C, the rotation trajectory of the rotary body 90 can be considered to coincide with the circumscribed circle (the imaginary circle 90V indicated by the dashed line in FIGS. 7A and 7B) of the rotary body 90 about the rotation axis 90C. When the toner cartridge 70 is at the retreat position, a half or more of the length of the toner cartridge 70 in the retreat direction is preferably placed outside of the rotation trajectory of the rotary body 90. In other words, when viewed in the rotation axis direction of the rotary, a half or more of the total length of the toner cartridge is preferably positioned outside of the rotation trajectory of the rotary in the moving direction of the toner cartridge from the mounting position toward the retreat position in a state where the toner cartridge is at the retreat position. This applies to each of the toner cartridges 70 including the toner cartridge 70k as an example of the first cartridge and the toner cartridge 70m as an example of the second cartridge. In the present embodiment, as shown in FIGS. 7A and 7B, when the toner cartridge 70 is at the retreat position, the entire toner cartridge 70 is positioned outside of the rotation trajectory (imaginary circle 90V) of the rotary body 90.

Furthermore, to make it easier for the user to grasp the toner cartridge 70, when the toner cartridge 70 is at the retreat position, at least part of the toner cartridge 70 is preferably positioned outside of the machine of the image forming apparatus 1 (outside of the machine of the apparatus body 1A). Here, the “outside of the machine” means a space outside of the image forming apparatus 1 (outside of the apparatus body 1A) when the image forming apparatus 1 is used in, for example, image forming operation on a sheet S or the like.

In the present embodiment, the outer appearance surface of the apparatus body 1A is formed by the outer appearance surface of the frame 16. In other words, the “outside of the machine” may be regarded as the outside of the frame 16. Therefore, a state where at least part of the toner cartridge 70 is positioned outside of the machine may be regarded as a state where at least part of the toner cartridge 70 protrudes from the opening 16a of the frame 16 of the apparatus body 1A toward the outside of the frame 16.

In the present embodiment, when the door 14 is at the closed position, the opening 16a of the frame 16 of the apparatus body 1A is covered by the door 14. Part of the outer appearance surface of the apparatus body 1A is formed by the outer appearance surface 14a of the door 14 at the closed position. In this case, “outside of the machine” refers to outside of the outer appearance surface 14a of the door 14 at the closed position. In other words, where the position of the outer appearance surface 14a of the door 14 at the closed position is an outer appearance position, when the toner cartridge 70 is at the retreat position, at least part of the toner cartridge 70 is positioned outside of the apparatus body 1A beyond the outer appearance position.

In other words, if the door 14 is at the closed position, at least part of the toner cartridge 70 is positioned in a space outside of the apparatus body 1A. In the retreat direction of the toner cartridge 70, at least part of the toner cartridge 70 is positioned downstream of the outer appearance position.

Where the side surface 16b having the opening 16a is the front of the apparatus body 1A, when the toner cartridge 70 is at the retreat position, at least part of the toner cartridge 70 may be regarded as protruding further to the front beyond the front-side outer appearance surface of the apparatus body 1A. In this case, a user is able to access the toner cartridge 70 from the front side of the image forming apparatus to easily replace the toner cartridge 70.

When the toner cartridge 70 is at the retreat position, a half or more of the length of the toner cartridge 70 in the retreat direction is preferably placed outside of the machine. In other words, when viewed in the rotation axis direction of the rotary, a half or more of the total length of the toner cartridge is preferably positioned outside of the main body frame in the moving direction of the toner cartridge from the mounting position toward the retreat position in a state where the toner cartridge is at the retreat position. This applies to each of the toner cartridges 70 including the toner cartridge 70k as an example of the first cartridge and the toner cartridge 70m as an example of the second cartridge. When the toner cartridge 70 is at the retreat position, the entire toner cartridge 70 is preferably placed outside of the machine. In the present embodiment, the front-side outer appearance surface of the apparatus body 1A is formed by the outer appearance surface 14a of the door 14 and the side surface 16b; however, the configuration of the door 14 is not limited thereto. For example, the size of the door 14 may be a size covering the entire side surface 16b. In this case, the front-side outer appearance surface of the apparatus body 1A is formed by the outer appearance surface 14a of the door 14.

The tray 80 includes a cartridge holding portion 81 that holds the toner cartridge 70 (see FIGS. 3 and 6C). The cartridge holding portion 81 has a bottom surface. For example, one of the bottom surfaces of the cartridge holding portions 81y to 81k can be referred to as a first tray bottom surface, one of the remaining three can be referred to as a second tray bottom surface, one of the remaining two can be referred to as a third tray bottom surface, and the last one can be referred to as a fourth tray bottom surface.

The cartridge holding portion 81 is a mounted portion to which the toner cartridge 70 is mounted. When the tray 80 is at the eject position, the entire cartridge holding portion 81 is preferably positioned outside of the rotation trajectory of the rotary body 90 in the retreat direction. When the tray 80 is at the eject position, a half or more of the length of the cartridge holding portion 81 is preferably positioned outside of the machine in the retreat direction.

As described earlier, the toner cartridge 70k and the tray 80k are larger in size than the other toner cartridges 70y to 70c and the other trays 80y to 80c. Therefore, in the present embodiment, as shown in FIGS. 7A and 7B, the amount of movement of the tray 80 during toner cartridge replacement is changed according to the size of the toner cartridge 70.

Specifically, as shown in FIG. 7A, when the tray 80k (first support member) moves from the storage position (first storage position) to the eject position (first eject position), the moving distance is L1. When the tray 80m (second support member) moves from the storage position to the eject position (third eject position), the moving distance is L2. FIG. 7B shows a state where the toner cartridge 70m and the tray 80m have moved, and, when the trays 80y, 80c move from the storage position to the retreat position, the moving distance is also L2. At this time, L1 is greater than L2. In other words, the moving distance of the first support member when the first toner cartridge moves from the first mounting position to the first retreat position may be regarded as being longer than the moving distance of the second support member when the second toner cartridge moves from the second mounting position to the second retreat position.

As shown in FIG. 7A, in a state where the tray 80k is at the eject position and the toner cartridge 70k is at the retreat position, the toner cartridge 70k protrudes from the outer appearance surface of the apparatus body 1A to the outside of the machine by a distance P1. In the present embodiment, the tray 80k also protrudes from the outer appearance surface of the apparatus body 1A to the outside of the machine by a distance P1.

As shown in FIG. 7B, in a state where the tray 80m is at the eject position and the toner cartridge 70m is at the retreat position, the toner cartridge 70m protrudes from the outer appearance surface of the apparatus body 1A to the outside of the machine by a distance P2. In the present embodiment, the tray 80m also protrudes from the outer appearance surface of the apparatus body 1A to the outside of the machine by a distance P2. The toner cartridges 70y, 70c also protrude from the outer appearance surface of the apparatus body 1A to the outside of the machine by a distance P2.

The distance P1 is longer than the distance P2. In other words, the length by which the first toner cartridge at the first retreat position protrudes from the opening 16a of the apparatus body 1A is defined as a first length (P1), and the length by which the second toner cartridge at the second retreat position protrudes from the opening 16a is defined as a second length (P2). In this case, the first length may be regarded as being longer than the second length.

The smaller toner cartridges 70y to 70c as compared to the toner cartridge 70k can be beneficial in terms of strength when the distance P2 by which the toner cartridge protrudes to the outside of the machine at the retreat position is shorter than the distance P1 by which the toner cartridge 70k protrudes to the outside of the machine at the retreat position. This is due to the following reasons. When the toner cartridge 70 is at the retreat position, at least part of the toner cartridge 70 protrudes to the outside of the rotation trajectory of the rotary body 90 or to the outside of the machine from the outer appearance surface of the apparatus body 1A. At this time, the tray 80 supports the weight of the toner cartridge 70 in a state of being supported by the rotary body 90 in a cantilever manner. Therefore, as the distance P2 by which the toner cartridges 70y to 70c protrude to the outside of the machine at the retreat position is reduced, the load on the trays 80y to 80c and guide portions 97 of the rotary body 90, which support the trays 80y to 80k, can be reduced. Since the toner cartridges 70y to 70c are smaller in size than the toner cartridge 70k, even when the distance P2 is made shorter than the distance P1, it is possible to maintain the operability of cartridge replacement for the trays 80y to 80c.

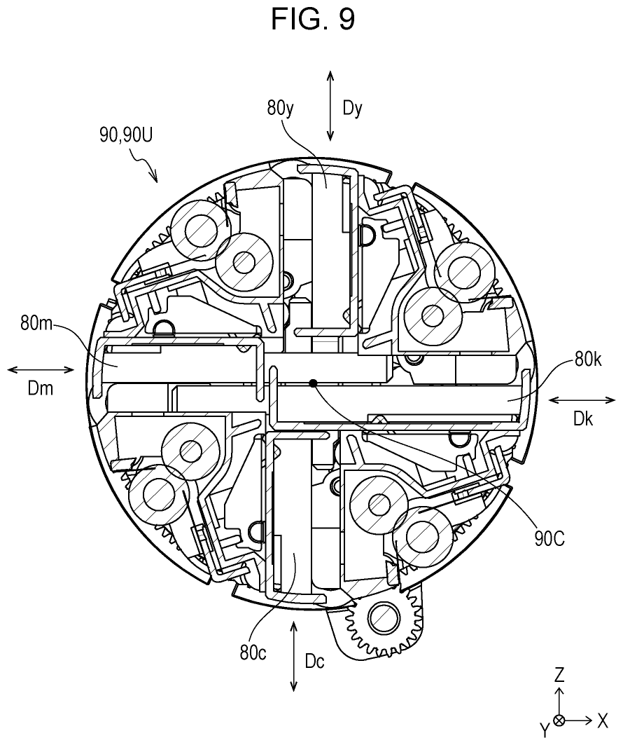

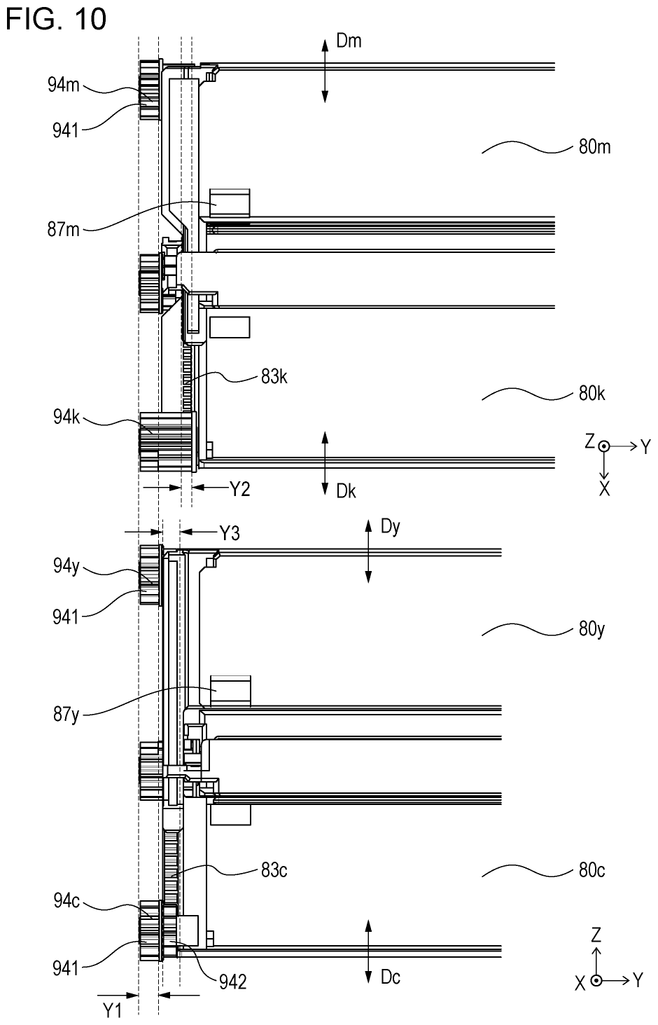

(Tray Arrangement in Rotary) The arrangement of the trays 80y to 80k in the rotary body 90 will be described with reference to FIGS. 8, 9, and 10. FIG. 8 is a perspective view of the arrangement of the trays 80y to 80k in the rotary body 90. FIG. 9 is a sectional view of the arrangement of the trays 80y to 80k in the rotary body 90. FIG. 10 is a view of the arrangement of members on one end side of the trays 80y to 80k in the Y direction. FIG. 10 is a sectional view of the rotary body 90, taken along an imaginary plane perpendicular to the rotation axis 90C of the rotary body 90. The upper half of FIG. 10 is a view of the rotary body 90 and the trays 80m, 80k from the upper side (+Z side) of FIG. 8, and the lower half of FIG. 10 is a view of the rotary body 90 and the trays 80c, 80y from the right side (+X side) of FIG. 8.

As shown in FIG. 8, each of the trays 80y to 80k includes a corresponding one of the cartridge holding portions 81y to 81k and a corresponding one of pairs of guided portions 82y to 82k.

The toner cartridges 70y to 70k are respectively mounted on the cartridge holding portions 81y to 81k. Each of the cartridge holding portions 81y to 81k stores at least part of a corresponding one of the toner cartridges 70y to 70k, mounted thereon.

Each of the pairs of guided portions 82y to 82k is provided at both ends of a corresponding one of the trays 80y to 80k so as to sandwich a corresponding one of the cartridge holding portions 81y to 81k in the Y direction. Each of the guided portions 82y to 82k is an elongated member extending in a direction orthogonal to the rotation axis of the rotary body 90.

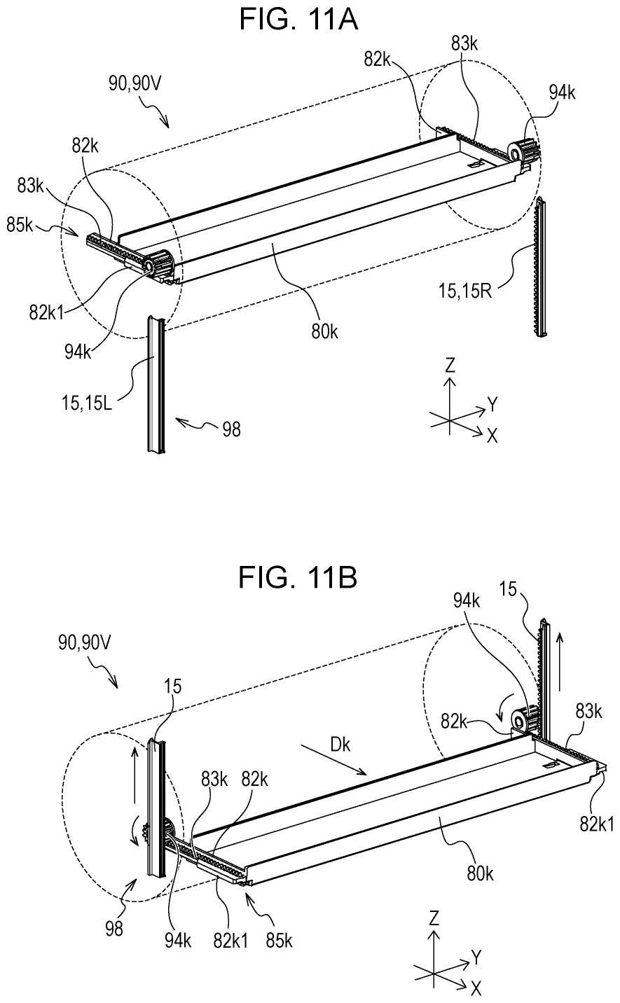

In the present embodiment, a reinforcement rib 82k1 is formed on part of the guided portion 82k in a moving direction Dk of the tray 80k, and a reinforcement rib 82m1 is formed on part of the guided portion 82m in a moving direction Dm of the tray 80m (see also FIGS. 11A and 11B). Each of the reinforcement ribs 82k1, 82m1 has an elongated rib shape (projection) extending outward from a corresponding one of the guided portions 82k, 82m provided at each end of a corresponding one of the trays 80k, 80m in the Y direction and extends in a corresponding one of the moving directions Dk, Dm of the trays 80k, 80m. With the reinforcement ribs 82k1, 82m1, the rigidity of the guided portions 82k, 82m improves.

In the present embodiment, the length of the reinforcement ribs 82m1, 82k1 is limited to avoid interference with the guided portions 82y, 82c. However, if there is no interference with the guided portions 82y, 82c, the reinforcement ribs 82m1, 82k1 may be provided along the entire length of the guided portions 82m, 82k. Reinforcement ribs may be added to the guided portions 82y, 82c. When the rigidity of the guided portions 82m, 82k is sufficient, the reinforcement ribs 82m1, 82k1 do not need to be provided.

Rack portions 83y to 83k (racks) are respectively formed at the guided portions 82y to 82k. Pinions 94y to 94k are rotatably held in the rotary body 90. The pinions 94y to 94k are respectively drivably in mesh with the rack portions 83y to 83k.

The rack portions 83y to 83k and the pinions 94y to 94k are respectively parts of the moving devices 85y to 85k configured to move the toner cartridges 70y to 70k from the mounting position to the retreat position. The rack portions 83y to 83k and the pinions 94y to 94k may be regarded as part of a driven device driven by the drive device 98 of the apparatus body 1A.

The pinions 94y to 94k may be regarded as rotating members (rotary members) that rotate to move the trays 80y to 80k relative to the rotary body 90.

The pinions 94y to 94k and the rack portions 83y to 83k function as driven units for the moving devices 85y to 85k of the rotary body 90 to receive driving force from the drive device 98 of the apparatus body 1A. The pinion 94k and the rack portion 83k are examples of a first pinion and a first rack that make up at least part of a first driven unit of the first moving device. The pinion 94m and the rack portion 83m are examples of a second pinion and a second rack that make up at least part of a second driven unit of the second moving device.

The rotary body 90 has the guide portions 97 that respectively engage with the guided portions 82y to 82k (see FIGS. 7A and 7B). FIG. 7A shows the guide portion 97 (97k) that engages with the guided portion 82k of the tray 80k, and FIG. 7B shows the guide portion 97 (97m) that engages with the guided portion 82m of the tray 80m. The rotary body 90 includes similar guide portions that respectively engage with the guided portions 82y, 82c of the trays 80y, 80c. FIGS. 7A and 7B show the guide portion 97 provided on one side (−Y side) of the rotary body 90 in the Y direction; however, a similar guide portion 97 is also provided on the other side (+Y side) of the rotary body 90 in the Y direction.

When the tray 80 moves between the storage position and the eject position, the guide portion 97 maintains engagement with the guided portion 82 at least in part of the moving range and guides the moving direction of the tray 80. In the present embodiment, the guide portion 97 maintains engagement with the guided portion 82k over the entire moving range between the storage position and the eject position of the tray 80k. In the present embodiment, the guide portion 97 maintains engagement with the guided portion 82m over the entire moving range between the storage position and the eject position of the tray 80m.

As shown in FIGS. 8 and 9, four trays 80y to 80k are disposed so as to overlap each other in the rotary body 90, as will be specifically described below.

When the pinions 94y to 94k rotate, the rack portions 83y to 83k and the trays 80y to 80k move relative to the rotary body 90. As shown in FIG. 9, four trays 80y to 80k are disposed in the rotary body 90 such that the moving directions of the four trays 80y to 80k are rotated by 90 degrees. Therefore, the pair of tray 80y and tray 80c and the pair of tray 80m and tray 80k each are held so as to be slidable substantially in the same direction (parallel direction). The moving direction of each of the trays 80y to 80k during sliding is regulated by the engagement of a corresponding one of the guided portions 82y to 82k with a corresponding one of the guide portions 97.

Each of the trays 80y to 80k moves to the outside of the machine through the opening 16a. When each of the trays 80y to 80k moves to the outside of the machine through the opening 16a, the moving direction of each tray is substantially the same direction (parallel).

As shown in FIG. 9, in the moving direction Dk of the tray 80k, the range in which the tray 80k is placed is disposed so as to overlap the range in which the tray 80y is placed and the range in which the tray 80c is placed. In the moving direction Dk of the tray 80k, the range in which the tray 80k is placed overlaps the rotation axis 90C of the rotary body 90. In other words, the toner cartridge 70k held by the cartridge holding portion 81k of the tray 80k may be regarded as overlapping the rotation axis 90C of the rotary body 90 (FIG. 4B).

On the other hand, in the moving direction Dm of the tray 80m, the range in which the tray 80m is placed is disposed with an offset so as not to overlap the range in which the tray 80y is placed or the range in which the tray 80c is placed. Furthermore, in the moving direction Dy of the tray 80y, the range in which the tray 80y is placed is disposed with an offset so as not to overlap the range in which the tray 80m is placed or the range in which the tray 80k is placed. Similarly, in the moving direction Dc of the tray 80c, the range in which the tray 80c is placed is disposed with an offset so as not to overlap the range in which the tray 80m is placed or the range in which the tray 80k is placed.

The positional relationship among the trays 80 can also be described as follows. When viewed in the moving direction Dy of the tray 80y, the tray 80y overlaps the tray 80k; however, the tray 80y does not overlap the tray 80m. When viewed in the moving direction Dm of the tray 80m, the tray 80m overlaps the tray 80k; however, the tray 80m does not overlap the tray 80y or the tray 80c. When viewed in the moving direction Dc of the tray 80c, the tray 80c overlaps the tray 80k; however, the tray 80c does not overlap the tray 80m.

Here, the phrase “two elements (members, components, units, or the like) overlap each other when viewed in a specific direction” means that, when each element is perpendicularly projected onto an imaginary plane perpendicular to the specific direction, the projection area of one element and the projection area of the other element at least partially overlap each other.

As shown in FIGS. 8 and 10, in the direction of the rotation axis 90C (Y direction), the range in which the rack portion 83m and the guided portion 82m are placed at least partially overlaps the range in which the rack portion 83k and the guided portion 82k are placed. In other words, in the present embodiment, in the rotation axis direction of the rotary (Y direction), the range in which the first rack (rack portion 83k) is placed at least partially overlaps the range in which the second rack (rack portion 83m) is placed. Therefore, compared to the arrangement in which the rack portion 83m and the guided portion 82m do not overlap the rack portion 83k and the guided portion 82k, the rack portions 83m, 83k and the guided portions 82m, 82k can be disposed in a space-saving manner in the Y direction.

In the direction of the rotation axis 90C (Y direction), the range in which the rack portion 83y and the guided portion 82y are placed at least partially overlaps the range in which the rack portion 83c and the guided portion 82c are placed. In other words, in the present embodiment, in the rotation axis direction of the rotary (Y direction), the range in which a third rack (rack portion 83y) is placed at least partially overlaps the range in which a fourth rack (rack portion 83c) is placed. Therefore, compared to the arrangement in which the rack portion 83y and the guided portion 82y do not overlap the rack portion 83c and the guided portion 82c, the rack portions 83y, 83c and the guided portions 82y, 82c can be disposed in a space-saving manner in the Y direction.

Here, the meshing position between the rack portion 83 and the pinion 94 will be described with reference to FIG. 10. The upper half of FIG. 10 shows the meshing position between the rack portion 83k and the pinion 94k. The lower half of FIG. 10 shows the meshing position between the rack portion 83c and the pinion 94c.

In the direction of the rotation axis 90C (Y direction) of the rotary body 90, in the range Y1 in the drawing, driving force transmitted by the transmission device (described later) from the motor M2 (FIG. 2) serving as the drive source is transmitted to the pinions 94y to 94k. In the range Y2 in the drawing in the Y direction, the pinion 94k is drivably in mesh with the rack portion 83k. In the range Y3 in the drawing in the Y direction, the pinion 94c is drivably in mesh with the rack portion 83c. The rack portion 83m, as in the case of the rack portion 83k, is drivably in mesh with the pinion 94m (FIG. 8) in the range Y2. The rack portion 83y, as in the case of the rack portion 83c, is drivably in mesh with the pinion 94y (FIG. 8) in the range Y3.

Here, the range Y2 and the range Y3 lie at different positions in the Y direction (lie with an offset in the Y direction). The range Y1 is located at a different position in the Y direction from any one of the range Y2 and the range Y3. In other words, the range Y1 lies with an offset in the Y direction from the range Y2 and the range Y3.

Furthermore, in a state where the toner cartridges 70y, 70c are at the mounting position, the range in which the rack portion 83y is placed at least partially overlaps the range in which the rack portion 83c is placed in the moving direction of the rack portion 83y (the moving direction Dy of the tray 80y). In the present embodiment, since the moving directions Dy, Dc of the trays 80y, 80c are substantially the same direction (parallel), the range in which the rack portion 83y is placed at least partially overlaps the range in which the rack portion 83c is placed also in the moving direction Dc of the tray 80c. Therefore, in a state where the toner cartridges 70y, 70c are at the mounting position, the tooth surface of the rack portion 83y faces the tooth surface of the rack portion 83c in a direction orthogonal to the moving directions Dy, Dc of the rack portions 83y, 83c (the right and left direction in FIG. 8).

Furthermore, in a state where the toner cartridges 70m, 70k are at the mounting position, the range in which the rack portion 83m is placed at least partially overlaps the range in which the rack portion 83k is placed in the moving direction of the rack portion 83m (the moving direction Dm of the tray 80m). In the present embodiment, since the moving directions Dm, Dk of the trays 80m, 80k are substantially the same direction (parallel), the range in which the rack portion 83m is placed at least partially overlaps the range in which the rack portion 83k is placed also in the moving direction Dk of the tray 80k. Therefore, in a state where the toner cartridges 70m, 70k are at the mounting position, the tooth surface of the rack portion 83m faces the tooth surface of the rack portion 83k in a direction orthogonal to the moving directions Dm, Dk of the rack portions 83m, 83k (the up and down direction in FIG. 8).

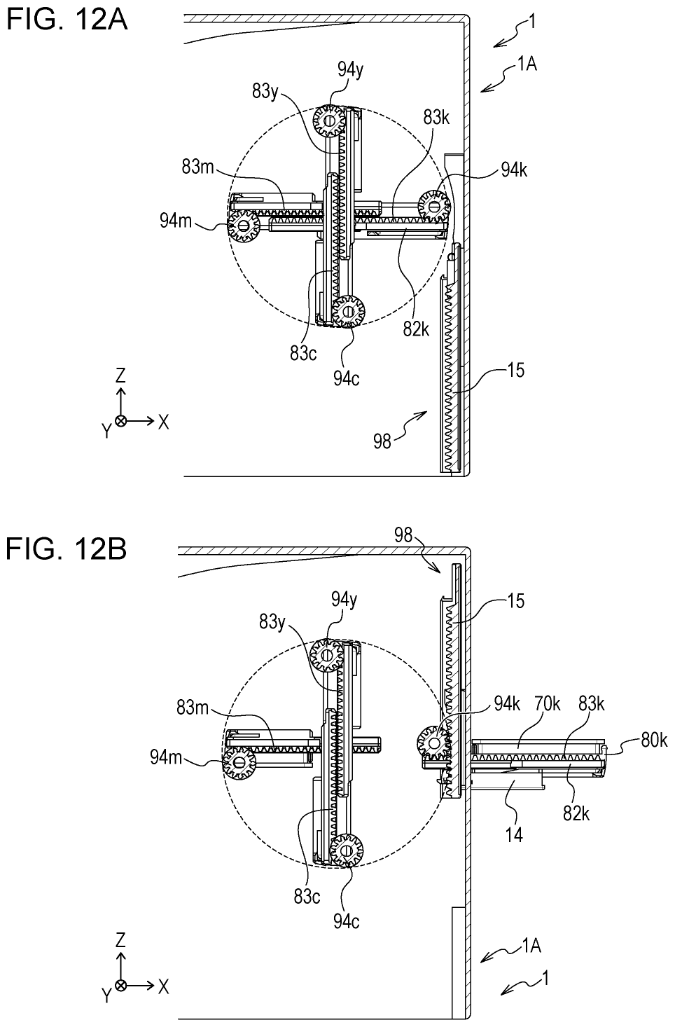

As shown in FIG. 12A (described later), when viewed in the direction of the rotation axis 90C (Y direction), the rack portion 83y overlaps the rack portion 83m and the rack portion 83k. When viewed in the direction of the rotation axis 90C (Y direction), the rack portion 83m overlaps the rack portion 83y and the rack portion 83c. When viewed in the direction of the rotation axis 90C (Y direction), the rack portion 83c overlaps the rack portion 83m and the rack portion 83k. When viewed in the direction of the rotation axis 90C (Y direction), the rack portion 83k overlaps the rack portion 83y and the rack portion 83c. In other words, in the rotation axis direction of the rotary (Y direction), the range in which the first rack (rack portion 83k) is placed does not overlap the range in which the third rack (rack portion 83y) is placed. When viewed in the rotation axis direction of the rotary (Y direction), the first rack (rack portion 83k) overlaps the third rack (rack portion 83y) in a state where the first toner cartridge 70k is at the first mounting position and the second toner cartridge 70y is at the second mounting position.

In this way, since the positions at which the rack portions 83k, 83m are placed in the Y direction differ from the positions at which the rack portions 83y, 83c are placed in the Y direction, the rack portions 83y, 83c and the rack portions 83m, 83k can be disposed so as to overlap each other when viewed in the Y direction.

Thus, space-saving four tray arrangement within the rotary body 90 is provided, so it is possible to reduce the size of the rotary body 90 in the radial direction of the rotary body 90. In other words, when the rack portions 83 are disposed so as not to overlap each other when viewed in the Y direction while the moving distance of each of the trays 80y to 80k is equivalent to that of the present embodiment, the area needed to dispose four rack portions increases when viewed in the Y direction. Compared to this configuration, the area of arrangement of the rack portions 83 reduces when viewed in the Y direction since the plurality of rack portions 83 is disposed so as to be shifted in position in the Y direction and the rack portions 83 are caused to overlap each other when viewed in the Y direction.

In the present embodiment, the four rack portions 83y to 83k are paired two by two, and the two pairs are disposed so as to be shifted in the Y direction. In other words, in the rotation axis direction (Y direction) of the rotary, the range in which the first rack is placed and the range in which the second rack is placed overlap, and the range in which the third rack is placed and the range in which the fourth rack is placed overlap. In the Y direction, the range in which the first rack and the second rack are placed and the range in which the third rack and the fourth rack are placed are disposed so as not to overlap each other. As a result, it is possible to reduce the size of the rotary body 90 in the Y direction compared to when each of the four rack portions 83y to 83k is shifted in the Y direction.

### Tray Movement Configuration

The configuration related to the movement of the trays 80y to 80k disposed in the rotary body 90 will be described with reference to FIGS. 11A, 11B, 12A, and 12B. FIGS. 11A and 11B are perspective views of the configuration related to the movement of the tray 80k. FIGS. 12A and 12B are sectional views of the configuration related to the movement of the tray 80k.

In the present embodiment, the trays 80y to 80k are driven by the driving force of the motor M2, transmitted to the pinions 94y to 94k by drive racks 15R, 15L serving as the transmission device. Here, the configuration for moving the tray 80k relative to the rotary body 90 will be described, and the configuration for moving the trays 80y to 80c relative to the rotary body 90 is substantially the same as the configuration for moving the tray 80k, so the description thereof is omitted.

FIG. 11A shows a state where the tray 80k is placed inside the rotary body 90 (that is, a state where the toner cartridge 70k is mounted to the developing unit 50k). In other words, FIG. 11A shows a state where the tray 80k is at the storage position and corresponds to a state where the toner cartridge 70k is at the mounting position relative to the developing frame 53k (FIG. 4A). FIG. 11B shows a state where the tray 80k has been slid to the outside of the rotary body 90. In other words, FIG. 11B shows a state where the tray 80k is at the eject position and corresponds to a state where the toner cartridge 70k is at the retreat position relative to the developing frame 53k (FIG. 4B).

The apparatus body 1A of the present embodiment includes the drive racks 15R, 15L as drive gears that drive the pinions 94. Each of the drive racks 15 is driven by the motor M2 via a drive transmission mechanism (not shown).

As described earlier, two rack portions 83k are respectively provided at both ends of the tray 80k in the Y direction. The two pinions 94k and the two drive racks 15R, 15L are respectively disposed at the positions corresponding to the rack portions 83k at both ends. In other words, the apparatus body 1A of the present embodiment includes the drive racks 15L, 15R as a first drive gear and a second drive gear. The drive rack 15L is an example of the first drive gear, and the drive rack 15R is an example of the second drive gear.

However, numbering is used for the sake of convenience of description and can generally be interchanged as needed. When there is no need to distinguish between the drive racks 15R, 15L, the drive racks 15R, 15L are referred to as “drive racks 15”.

The rack portions 83 of the present embodiment are configured as a rack pair, and the pinions 94 of the present embodiment are configured as a pinion pair. In the present embodiment, the rack pair and the pinion pair are disposed at one end and the other end of the support member (tray 80) in the Y direction; however, the rack pair and the pinion pair may be disposed at other positions. The rack portions 83k and pinions 94k of the moving device 85k corresponding to the tray 80k may be regarded as examples of a first rack pair and a first pinion pair.

Any one set of the rack portions 83y to 83c and the pinions 94y to 94c of the moving devices 85y to 85c corresponding to the other trays 80y to 80c may be regarded as examples of a second rack pair and a second pinion pair.

One of the rack pair is in mesh with one of the pinion pair, and the other one of the rack pair is in mesh with the other one of the pinion pair. At least one of the pinion pair is driven by the drive rack 15L serving as a first drive rack. In the present embodiment, both of the pinion pair are driven at the same time by the drive racks 15R, 15L serving as the first drive rack and a second drive rack. Thus, the tray 80 is less likely to rotate, with the result that it is possible to stably move the toner cartridge 70.

The tray 80 may have a single rack portion 83 and may be configured to be moved by a single drive rack 15 through a single pinion 94.

The tray 80k is held so as to be slidable in a direction parallel to the guided portion 82k (that is, the moving direction Dk) relative to the rotary body 90. The drive rack 15 is held so as to be slidable in a direction that crosses the moving direction Dk of the tray 80k relative to the apparatus body 1A. The drive rack 15 is configured to slide (reciprocate) in a first direction (vertically upward in the present embodiment) and in a second direction (vertically downward in the present embodiment) opposite to the first direction relative to the apparatus body 1A. In other words, the moving direction of the drive rack 15 of the present embodiment is a direction that crosses (preferably, a direction orthogonal to) both the moving direction Dk of the tray 80k and the direction of the rotation axis 90C (Y direction) of the rotary body 90.

The tray moving operation for sliding the tray 80k between the storage position and the eject position will be described with reference to FIGS. 11A and 11B. The tray moving operation of the tray 80k is performed by the motor M2 (FIG. 2), the drive transmission mechanism (not shown), the drive racks 15, the pinions 94k, and the rack portions 83k.

Initially, the tray moving operation (tray ejection operation) when the toner cartridge 70k is removed from the rotary body 90 will be described. In a state before the tray ejection operation is started, the drive rack 15 is positioned below the position at which the drive rack 15 meshes with the pinion 94k (FIG. 11A). As described earlier, in the replacement operation of the toner cartridge 70k, the rotary body 90 takes the replacement posture of the toner cartridge 70k (FIG. 4B).

When the tray ejection operation is started, the drive rack 15 is slid upward of the apparatus body 1A by the driving force of the motor M2. During the process in which the drive rack 15 moves, the drive rack 15 engages with the pinion 94k, and the pinion 94k is rotationally driven.

As shown in FIG. 11B, when the pinion 94k is rotationally driven in the direction of the arrow in the drawing, the driving force is input to the rack portion 83k that is in mesh with the pinion 94k. As a result, the tray 80k is pushed out to the outside of the machine and moves from the storage position to the eject position relative to the rotary body 90. The moving direction of the tray 80k at this time is guided in the predetermined moving direction Dk by the engagement of the guided portion 82k with the guide portion 97k of the rotary body 90 (FIG. 7A). As a result of the tray 80k moving from the storage position to the eject position, the toner cartridge 70k is moved from the mounting position to the retreat position relative to the developing unit 50k.

In a state where the tray 80k is at the eject position and the toner cartridge 70k is at the retreat position, a user is able to attach the toner cartridge 70k to or detach the toner cartridge 70k from the tray 80k.

The tray moving operation (tray insertion operation, tray insertion operation) when the toner cartridge 70 is attached to the rotary body 90 is performed in the process reverse to the tray ejection operation. In a state before the tray insertion operation is started, the drive rack 15 is positioned above the position at which the drive rack 15 meshes with the pinion 94k. When the operation is started, the drive rack 15 is slid downward of the apparatus body 1A by the driving force of the motor M2. Here, the rotation direction of the motor M2 in the tray insertion operation is opposite to that in the tray ejection operation. During the process in which the drive rack 15 moves, the drive rack 15 engages with the pinion 94k, and the pinion 94k is rotationally driven.

When the pinion 94k is rotationally driven in a direction opposite to the arrow in FIG. 11B, the driving force is input to the rack portion 83k that is in mesh with the pinion 94k. As a result, the tray 80k is pulled into the machine and moves from the eject position to the storage position relative to the rotary body 90.

The moving direction of the tray 80k is guided in the moving direction Dk (the direction opposite to the arrow in FIG. 11B) by the engagement of the guided portion 82k with the guide portion 97k (FIG. 7A) of the rotary body 90. As a result of the tray 80k moving from the eject position to the storage position, the toner cartridge 70k is moved from the retreat position to the mounting position relative to the developing unit 50k.

The movement of the black tray 80k and the black toner cartridge 70k has been described, and the movement of the other trays 80y to 80c and the other toner cartridges 70y to 70c is also performed by similar mechanisms. In other words, the drive rack 15 transmits driving force to the pinions 94y to 94c in the replacement posture of each toner cartridge.

The drive device 98 for driving the moving devices 85 provided in the rotary body 90 is made up of the motor M2 provided in the apparatus body 1A and the transmission device including the drive racks 15 (15R, 15L) and the drive transmission mechanism.

As described earlier, in the present embodiment, the plurality of moving devices 85y to 85k corresponding to the plurality of toner cartridges 70y to 70k is disposed in the rotary body 90. The drive device 98 of the apparatus body 1A is a common drive device that drives the plurality of moving devices 85k to 85y (a plurality of driven devices) of the rotary body 90.

In the present embodiment, the target to be driven by the drive device 98 switches with the rotation of the rotary body 90. In other words, the drive device of the present embodiment includes the drive rack 15 as a transmission member for transmitting the driving force of the drive source. The drive device is capable of taking a state where the transmission member drivably engages with the first driven unit (pinion 94k) and a state where the transmission member drivably engages with the second driven unit (pinion 94m). The drive device is capable of taking a state where the transmission member is disconnected from the first driven unit and the second driven unit.

As described above, the pinions 94y to 94k are held in the rotary body 90. Therefore, when the rotary body 90 rotates, the meshing of the pinions 94y to 94k with the drive rack 15 can be released.

FIG. 12A shows a state where the tray 80k is placed inside the rotary body 90 (the state at the storage position). FIG. 12B shows a state where the tray 80k has moved to the outside of the rotary body 90 (a state of having moved to the eject position).

As shown in FIG. 12A, when the tray 80k is placed inside the rotary body 90, the drive rack 15 is positioned at the bottom in the apparatus body 1A. At this time, the drive rack 15 is retracted from the pinion 94k. Therefore, the rotary body 90 is allowed to be rotated without any interference with the drive rack 15. More specifically, the drive rack 15 can retract to the outside of the rotation trajectory of the rotary body 90, indicated by the dashed line in FIGS. 12A and 12B.

As described above, when the motor M2 is rotationally driven in the forward and reverse directions, the tray 80 attached to the rotary body 90 can be moved from the storage position to the eject position and from the eject position to the storage position relative to the rotary body 90. In other words, the drive device of the present embodiment is capable of not only driving each moving device of the rotary such that the toner cartridge moves from the mounting position to the retreat position but also driving each moving device such that the toner cartridge moves from the retreat position to the mounting position.

Here, as described earlier, in the present embodiment, the amount of movement of the tray 80 during toner cartridge replacement is changed according to the size of the toner cartridge 70. Specifically, as shown in FIGS. 7A and 7B, the moving distance L1 when the black tray 80k moves from the storage position to the eject position is longer than the moving distance L2 when the other trays 80y to 80c move from the storage position to the eject position.

Therefore, in the present embodiment, when the toner cartridges 70y to 70k are moved from the mounting position to the retreat position, the value obtained by dividing the speed of the rack portion 83k by the speed of the drive rack 15 is greater than the value obtained by dividing the speed of each of the rack portions 83y to 83c by the speed of the drive rack 15.

For example, as shown in FIG. 10, the pinion 94y is a stepped gear, the pitch radius of a small-diameter gear 942 that meshes with the rack portion 83y is smaller than the pitch radius of a large-diameter gear 941 that meshes with the drive rack 15. The pinions 94m, 94c are also similar stepped gears. On the other hand, the pinion 94k is made such that a portion that meshes with the drive rack 15 and a portion that meshes with the rack portion 83k have the same pitch radius. At this time, the pitch radius of the pinion 94k can be set to the same radius as the pitch radius of the large-diameter gears 941 of the pinions 94y to 94c. With this configuration, even when the moving distance of the drive rack 15 is the same, the moving distance of the rack portion 83k can be made larger than the moving distances of the other rack portions 83y to 83c. In other words, the moving distance L1 when the black tray 80k moves from the storage position to the eject position can be made longer than the moving distance L2 when the other trays 80y to 80c move from the storage position to the eject position.

When the pinions 94y to 94c are stepped gears, the moving distance L1 of the tray 80k can be made larger than the moving distance L2 of the other trays 80y to 80c with the configuration that the pinions 94y to 94k receive driving force from the same drive rack 15.

Instead of (or in combination with) the configuration in which the pinions 94y to 94c are used as stepped gears, the pinion 94k may also be used as a stepped gear. In this case, a portion of the pinion 94k, which meshes with the drive rack 15, just needs to be formed as a small-diameter gear, and a portion of the pinion 94k, which meshes with the rack portion 83k, just needs to be formed as a large-diameter gear greater in pitch radius than the small-diameter gear. The stepped gear is an example of a speed reduction mechanism and may be replaced with a known speed reduction mechanism that reduces the amount of movement of an output-side (tray 80-side) member more than the amount of movement of the input-side (drive source-side) member.

The amount of movement of the drive rack 15 when the toner cartridge 70k is moved from the mounting position to the retreat position may be greater than the amount of movement of the drive rack 15 when the toner cartridges 70y to 70c are moved from the mounting position to the retreat position.

Incidentally, as the distance that the toner cartridge 70 moves from the mounting position to the retreat position shortens, the moving time period of the toner cartridge 70 can be shortened, so a period of time for which the user waits for movement of the toner cartridge 70 can be shortened. With the configuration in which the amount of movement of the drive rack 15 for the toner cartridge 70k is greater than the amount of movement of the drive rack 15 for the toner cartridges 70y to 70c as described above, a period of time for which the user waits for movement of the toner cartridges 70y to 70c can be shortened.

With the configuration described above, the moving distance L1 can be made longer than the moving distance L2. These configurations can also be used in combination.

The configuration in which the driven unit includes the pinion 94 that meshes with both the drive rack 15 and the rack portion 83 has been described. Alternatively, the driven unit may include a gear that meshes with the drive rack 15 and a gear that meshes with the rack portion 83.

The configuration of the moving device 85 for moving the tray 80 is not limited to a so-called rack and pinion mechanism. For example, the member corresponding to the pinion 94 may be replaced with a roller that rotates under the drive of the motor M2, and the tray 80 is moved by the friction between the roller and the tray 80.

When a roller that rotates under the drive of the motor M2 is used, the roller may be brought into contact with the toner cartridge 70. In this case, the toner cartridges 70y to 70k may be configured to be directly attached to and detached from the rotary body 90 without intervening the trays 80y to 80k. In this case, the moving device 85 is made up of rollers.

### Incorrect Mounting Suppression Configuration of Toner Cartridge

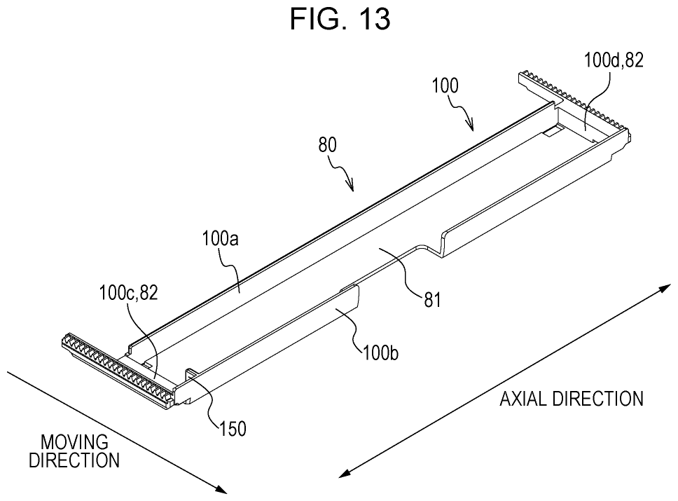

As described above, the toner cartridges 70y to 70k are removably mounted to the developing units 50y to 50k provided in the rotary body 90, and toner is supplied from the toner cartridges 70y to 70k to the developing units 50y to 50k. If the color of the toner contained in the developing-side storage chamber 53a of the developing unit 50 is different from the color of the toner in the toner cartridge 70 mounted to the developing unit 50, the toners of different colors mix within the developing-side storage chamber 53a. Therefore, the image forming apparatus 1 has an incorrect mounting suppression configuration that suppresses the mounting of a toner cartridge 70, different from a compatible toner cartridge 70, to the developing unit 50. The incorrect mounting suppression configuration will be described with reference to FIGS. 13 to 24.

In the following description, one of a recess 30y, a recess 30m, a recess 30c, and a recess 30k (described later) can be referred to as a first recess, one of the remaining three can be referred to as a second recess, one of the remaining two can be referred to as a third recess, and the last one can be referred to as a fourth recess. One of a rib 150y, a rib 150m, a rib 150c, and a rib 150k (described later) can be referred to as a first protrusion, one of the remaining three can be referred to as a second protrusion, one of the remaining two can be referred to as a third protrusion, and the last one can be referred to as a fourth protrusion.

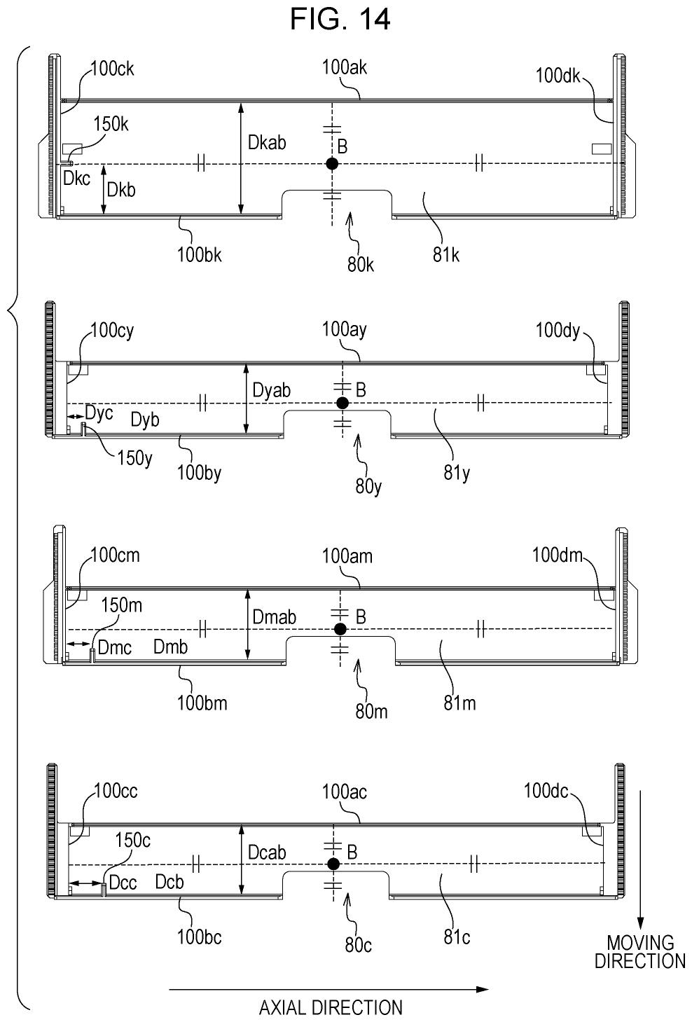

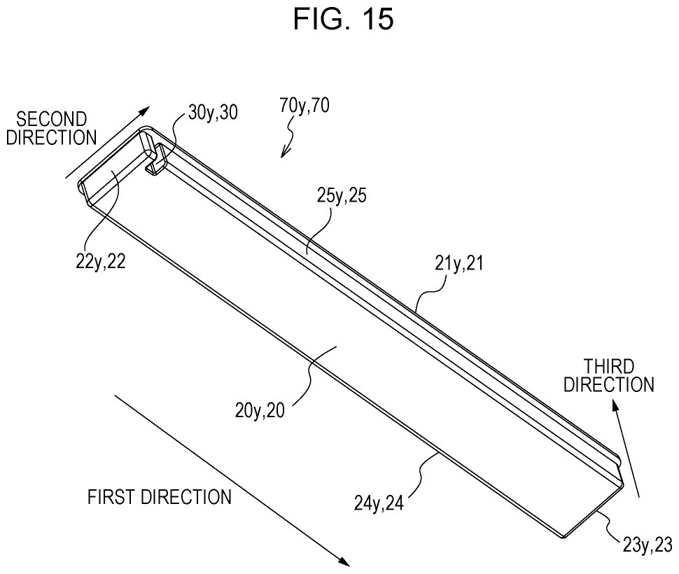

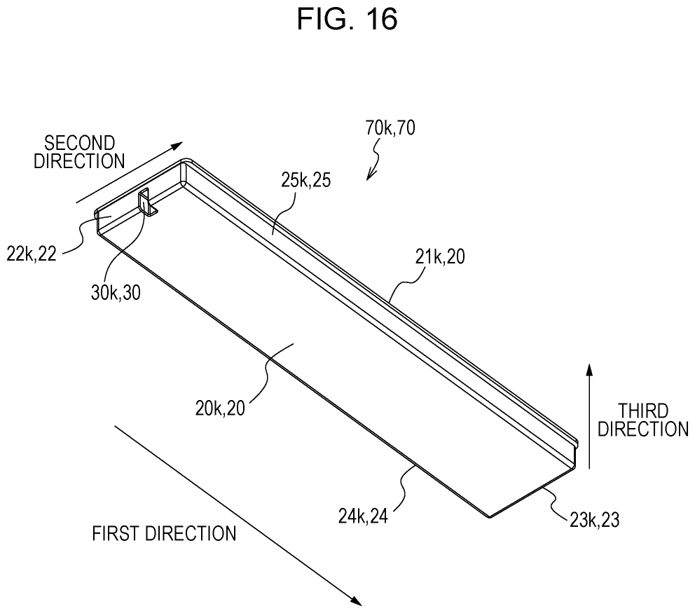

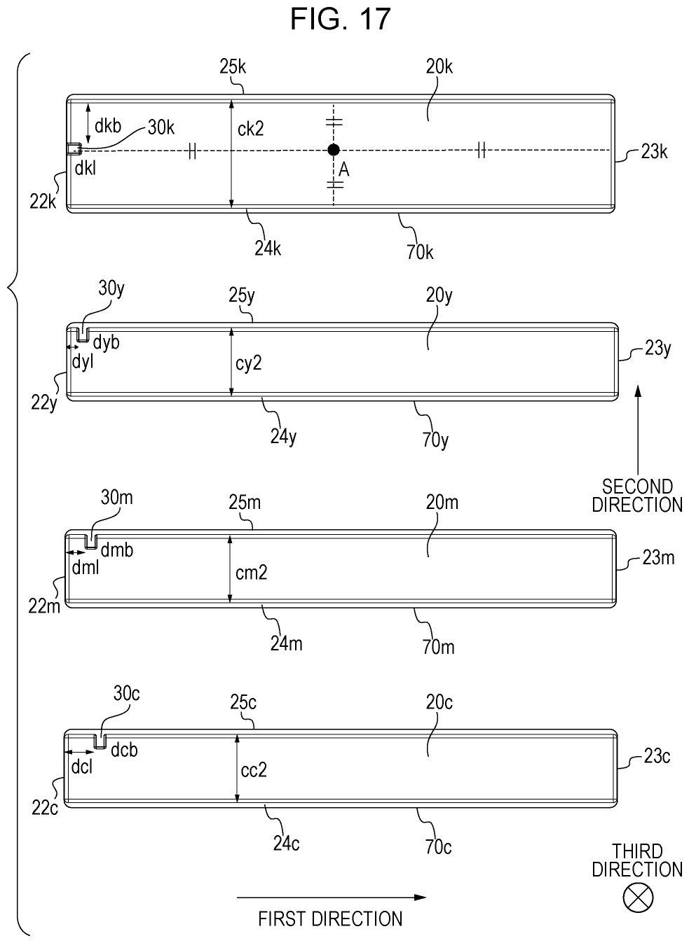

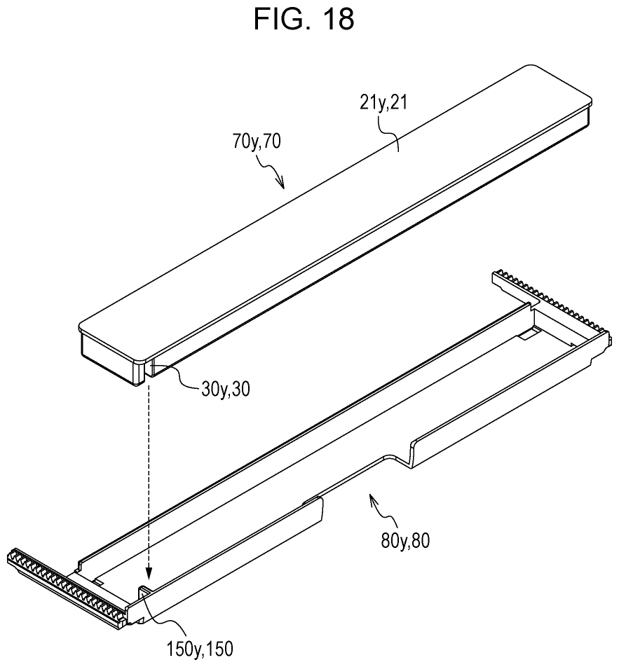

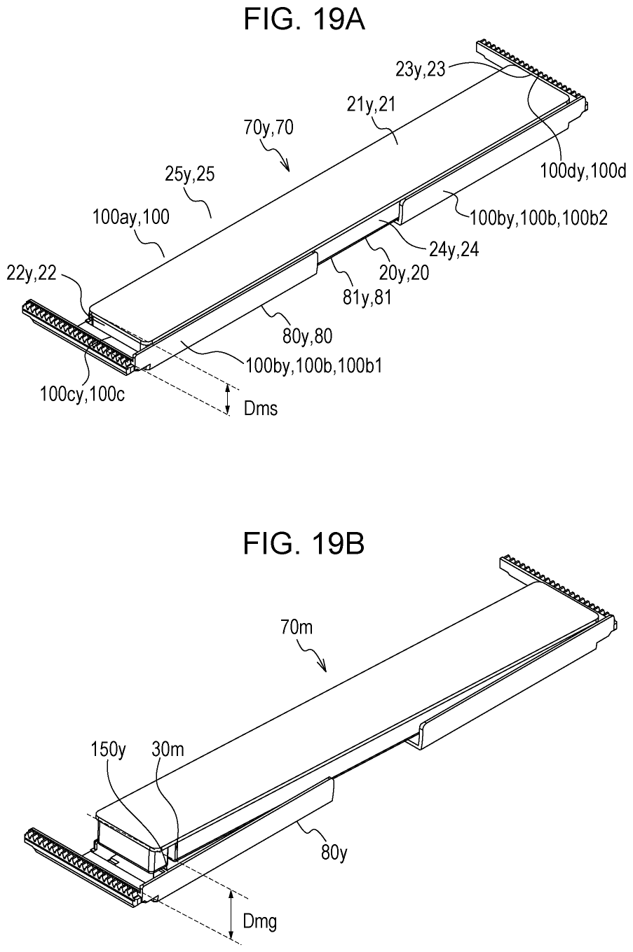

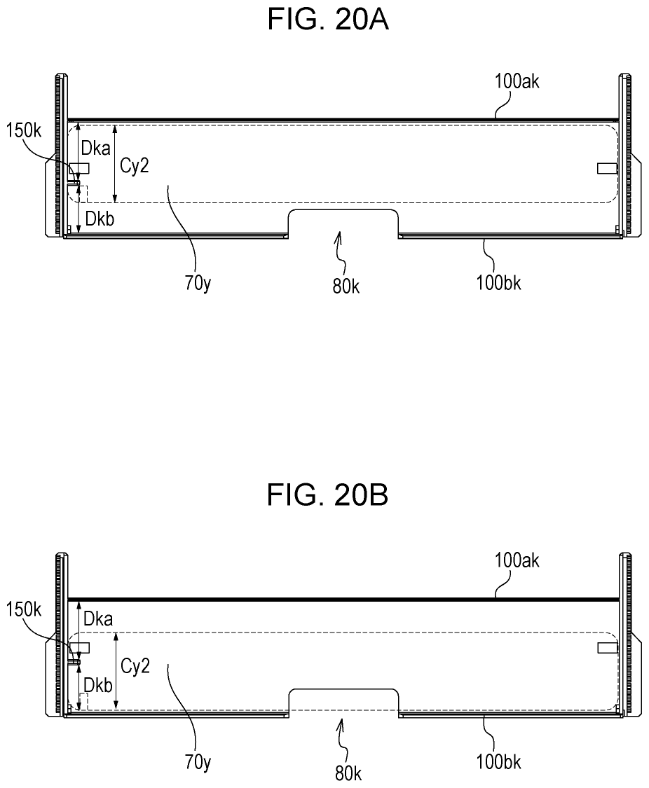

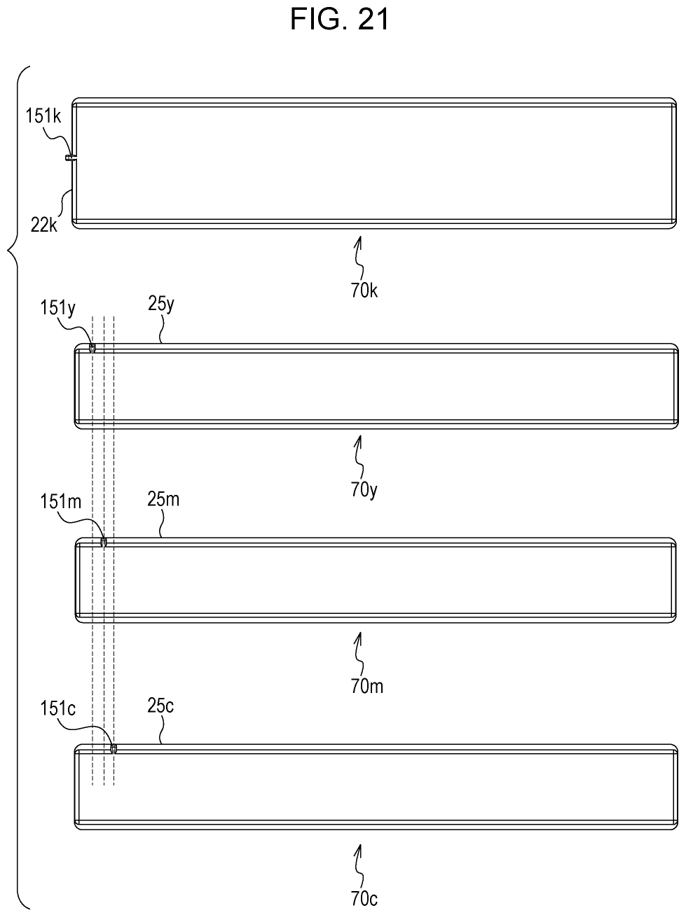

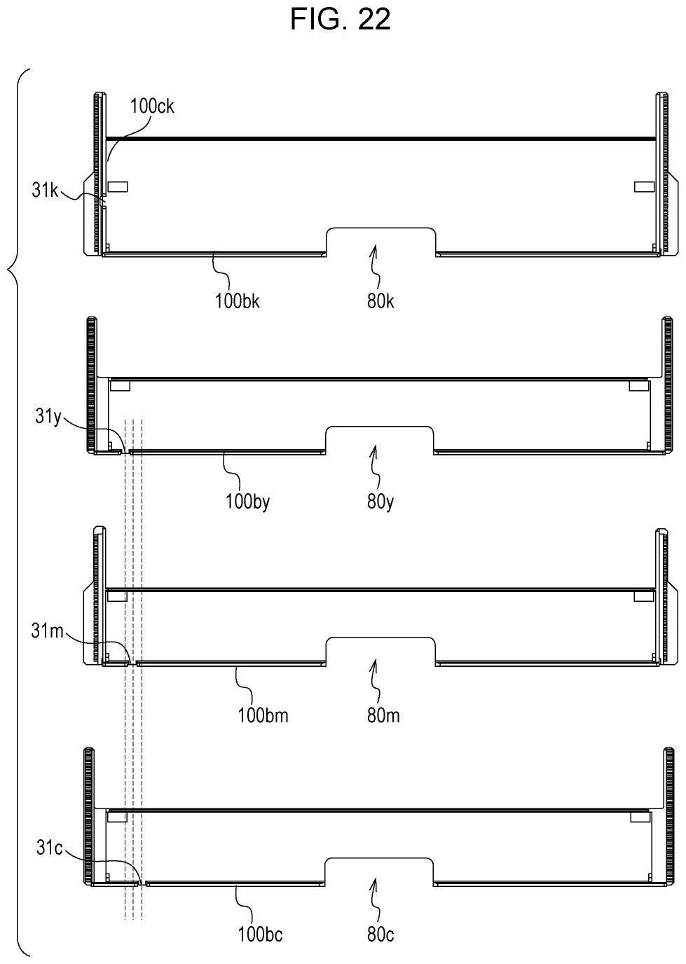

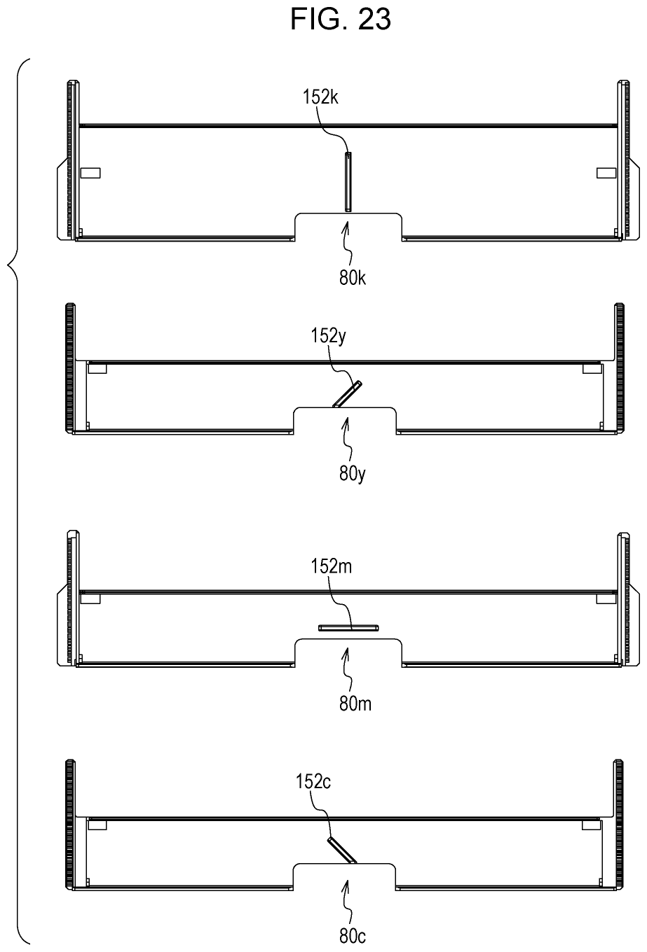

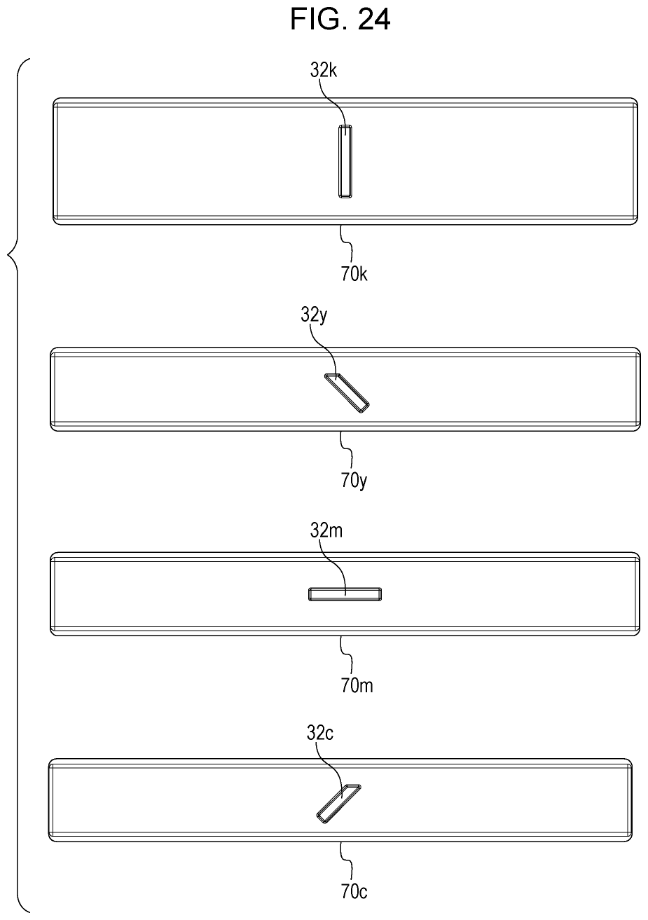

FIG. 13 is a perspective view of the tray 80. FIG. 14 shows plan views of the trays 80y to 80k. More specifically, FIG. 14 is a view of each of the trays 80y to 80k when viewed in a direction orthogonal to a corresponding one of the cartridge holding portions 81y to 81k. FIG. 15 is a perspective view of the toner cartridge 70y. FIG. 16 is a perspective view of the toner cartridge 70k. FIG. 17 shows plan views of the toner cartridges 70y to 70k. More specifically, FIG. 17 is a view of each of the toner cartridges 70y to 70k when viewed in a direction orthogonal to a corresponding one of bottom portions 20y to 20k. FIG. 18 is a view of a state before the toner cartridge 70y is mounted to the tray 80y. FIG. 19A is a view of a state where the toner cartridge 70y is mounted on the tray 80y, and FIG. 19B is a view of a state where the toner cartridge 70m is mounted on the tray 80y. FIG. 20A is a view of a state where the toner cartridge 70y is mounted so as to contact with a side wall 100ak of the tray 80k. FIG. 20B is a view of a state where the toner cartridge 70y is mounted so as to contact with a side wall 100bk of the tray 80k. FIG. 21 shows plan views of toner cartridges 70 according to a modification. FIG. 22 shows plan views of trays 80 according to the modification. FIG. 23 shows plan views of trays 80 according to a modification. FIG. 24 shows plan views of toner cartridges 70 according to the modification.

The shape of the tray 80 will be described with reference to FIG. 13. The tray 80 is a tray that supports the toner cartridge 70 so as to be detachably attachable. As shown in FIG. 13, the tray 80 includes a cartridge holding portion 81 that supports the toner cartridge 70, and a side wall 100 disposed around the cartridge holding portion 81 and extending in a direction orthogonal to the cartridge holding portion 81. When the tray 80 is at the eject position, the side wall 100 extends from the cartridge holding portion 81 in a direction that crosses the horizontal direction (preferably, the vertical direction).

The side wall 100 includes a side wall 100a and a side wall 100b that extend in the direction of the rotation axis 90C (axial direction). In the moving direction of the tray 80, the side wall 100a is positioned on one end side of the tray 80, and the side wall 100b is positioned on the other end side of the tray 80. More specifically, in a direction orthogonal to the axial direction, the side wall 100a is closer to the rotation axis 90C of the rotary body 90 than the cartridge holding portion 81 and the side wall 100b. In the direction orthogonal to the axial direction, the side wall 100b is farther from the rotation axis 90C of the rotary body 90 than the cartridge holding portion 81 and the side wall 100a. In the direction orthogonal to the axial direction, the side wall 100a and the side wall 100b face each other, and the cartridge holding portion 81 is positioned between the side wall 100a and the side wall 100b. The side wall 100a and the side wall 100b do not need to be parallel to each other.

The side wall 100 includes a side wall 100c and a side wall 100d that extend in the moving direction of the tray 80 that moves between the storage position and the eject position. In other words, the first tray includes a first side wall (the side wall 100c or the side wall 100d) that extends in the first direction in which the first tray is displaced from the first position to the second position. The first side wall extends in a direction that crosses (preferably, in a direction orthogonal to) both the first direction and the axial direction of the rotary body 90.

The second tray includes a second side wall (the side wall 100c or the side wall 100d) that extends in the second direction in which the second tray is displaced from the third position to the fourth position. The second side wall extends in a direction that crosses (preferably, in a direction orthogonal to) both the second direction and the axial direction of the rotary body 90.

In the axial direction, the side wall 100c is positioned on one end side of the tray 80, and the side wall 100d is positioned on the other end side of the tray 80. More specifically, when viewed in the moving direction in which the tray 80 moves from the storage position to the eject position, the side wall 100c is positioned on the right side of the cartridge holding portion 81, and the side wall 100d is positioned on the left side of the cartridge holding portion 81. In the axial direction, the side wall 100c and the side wall 100d face each other, and the cartridge holding portion 81 is positioned between the side wall 100c and the side wall 100d. The direction in which the side wall 100c extends is a direction that crosses (preferably, a direction orthogonal to) the direction in which the side wall 100a extends and the direction in which the side wall 100b extends. The direction in which the side wall 100d extends is a direction that crosses (preferably, a direction orthogonal to) the direction in which the side wall 100a extends and the direction in which the side wall 100b extends. Each of the side wall 100c and the side wall 100d has the guided portion 82. The side wall 100c and the side wall 100d do not need to be parallel to each other.

The toner cartridge 70 is mounted to the mounted portion of the tray 80. The mounted portion of the tray 80 is made up of the cartridge holding portion 81 and the side walls 100a to 100d. In the axial direction, the length of the mounted portion is the same as the shortest distance between the side wall 100c and the side wall 100d. In the present embodiment, the shortest distance in the axial direction between the side wall 100c and the side wall 100d is the same as the length of the cartridge holding portion 81 in the axial direction. In the moving direction (the direction orthogonal to the axial direction) of the tray 80, the length of the mounted portion is the same as the shortest distance between the side wall 100a and the side wall 100b. In the present embodiment, the shortest distance in the moving direction of the tray 80 between the side wall 100a and the side wall 100b is the same as the length of the cartridge holding portion 81 in the moving direction of the tray 80. The tray 80 includes the rib (protrusion) 150. In other words, the tray 80y has a first restricting portion (first protrusion), the tray 80m has a second restricting portion (second protrusion), the tray 80c has a third restricting portion (third protrusion), and the tray 80k has a fourth restricting portion (fourth protrusion). The arrangement and function of the rib 150 will be described later.

As shown in FIG. 14, in the moving direction of the tray 80, the length of the cartridge holding portion 81k is longer than the length of each of the cartridge holding portion 81y, the cartridge holding portion 81m, and the cartridge holding portion 81c. In other words, in the moving direction of the tray 80, the shortest distance Dkab between the side wall 100ak and side wall 100bk of the tray 80k is longer than the shortest distance Dyab between the side wall 100ay and side wall 100by of the tray 80y, the shortest distance Dmab between the side wall 100am and side wall 100bm of the tray 80m, and the shortest distance Dcab between the side wall 100ac and side wall 100bc of the tray 80c.

In the present embodiment, the lengths of the cartridge holding portion 81y to the cartridge holding portion 81c in the moving direction of the tray 80 are the same. In other words, in the moving direction of the tray 80, the shortest distance between the side wall 100ay and the side wall 100by, the shortest distance between the side wall 100am and the side wall 100bm, and the shortest distance between the side wall 100ac and the side wall 100bc are the same.

On the other hand, in the present embodiment, the lengths of the cartridge holding portion 81y to the cartridge holding portion 81k in the axial direction are the same. In other words, in the axial direction, the shortest distance between the side wall 100cy and the side wall 100dy, the shortest distance between the side wall 100cm and the side wall 100dm, the shortest distance between the side wall 100cc and the side wall 100dc, and the shortest distance between the side wall 100ck and the side wall 100dk are the same.

The shape and position of the rib 150 of the tray 80 will be described with reference to FIG. 14. The trays 80y to 80k respectively have the ribs 150y to 150k. In the present embodiment, the ribs 150y to 150k have a rectangular parallelepiped shape, and the sizes and shapes of the ribs 150y to 150k are the same.

The rib 150y is connected to the cartridge holding portion 81y and side wall 100by of the tray 80y. The rib 150m is connected to the cartridge holding portion 81m and side wall 100bm of the tray 80m. The rib 150c is connected to the cartridge holding portion 81c and side wall 100bc of the tray 80c. The rib 150k is connected to the cartridge holding portion 81k and side wall 100ck of the tray 80k.

As shown in FIG. 14, in the direction of the rotation axis 90C (axial direction), the shortest distance Dyc between the rib 150y and the side wall 100cy, the shortest distance Dmc between the rib 150m and the side wall 100cm, the shortest distance Dcc between the rib 150c and the side wall 100cc, and the shortest distance Dkc between the rib 150k and the side wall 100ck are different from one another. In the present embodiment, the shortest distance Dkc between the rib 150k and the side wall 100ck in the axial direction is zero.

In the moving direction of the tray 80, the shortest distance Dyb between the rib 150y and the side wall 100by, the shortest distance Dmb between the rib 150m and the side wall 100bm, and the shortest distance Dcb between the rib 150c and the side wall 100bc are the same. In the moving direction of the tray 80, the shortest distance Dkb between the rib 150k and the side wall 100bk is different from Dyb, Dmb, and Dcb. In the present embodiment, Dyb, Dmb, and Dcb are zero in the moving direction of the tray 80.

In the moving direction of the tray 80, the shortest distance between the rib 150y and the side wall 100by, the shortest distance between the rib 150m and the side wall 100bm, the shortest distance between the rib 150c and the side wall 100bc, and the shortest distance between the rib 150k and the side wall 100bk may be different from one another.

For example, the tray 80k can be referred to as the first tray, and the tray 80y can be referred to as the second tray. The side wall 100bk can be referred to as a third side wall, and the side wall 100by can be referred to as a fourth side wall. The first tray includes the third side wall extending in the axial direction, and the second tray includes the fourth side wall extending in the axial direction. The shortest distance in the first direction between the first restricting portion and the third side wall is different from the shortest distance in the second direction between the second restricting portion and the fourth side wall.

The first tray includes the side wall 100ak that faces the third side wall. The side wall 100ak extends in the axial direction. The side wall 100ak can be referred to as a fifth side wall. The second tray includes the side wall 100ay that faces the fourth side wall. The side wall 100ay can be referred to as a sixth side wall. As described above, the shortest distance in the first direction between the third side wall and the fifth side wall is longer than the shortest distance in the second direction between the fourth side wall and the sixth side wall.

The side wall 100dk can be referred to as a seventh side wall. The side wall 100dk extends in the first direction and faces the first side wall. The side wall 100dy can be referred to as an eighth side wall. The side wall 100dy extends in the second direction and faces the second side wall.

Next, the shape of the toner cartridge 70 will be described with reference to FIGS. 15, 16, 17, 18, and 19A. The toner cartridge 70 has a substantially rectangular parallelepiped shape. It is assumed that the longitudinal direction of the toner cartridge 70 is a first direction, the direction orthogonal to the first direction and parallel to the bottom portion 20 is referred to as a second direction (transverse direction), and the direction orthogonal to both the first direction and the second direction is referred to as a third direction (thickness direction). The length of the toner cartridge 70 in the first direction is greater than the length in the second direction, and the length in the second direction is longer than the length in the third direction.

The toner cartridge 70 includes the bottom portion 20, a top portion 21, and side portions 22, 23, 24, 25. The bottom portion 20 has a bottom surface. The top portion 21 has a top surface. The side portions 22 to 25 each have a side surface. The top portion 21 is disposed on the opposite side to the bottom portion 20 in the third direction. The side portions 22, 23 are side surfaces extending in the second direction. The side portions 24, 25 are side surfaces extending in the first direction. In the first direction, the side portion 22 is positioned on the opposite side to the side portion 23. In the second direction, the side portion 24 is positioned on the opposite side to the side portion 25. The length of each of the side portions 24, 25 in the first direction is longer than the length of each of the side portions 22, 23 in the second direction. The length of each of the side portions 22, 23 in the second direction is longer than the length of each of the side portions 22, 23 in the third direction (which is the same as the shortest distance in the third direction between the bottom portion 20 and the top portion 21).

For example, one of the bottom surfaces of the toner cartridges 70y to 70k can be referred to as a first cartridge bottom surface, one of the remaining three can be referred to as a second cartridge bottom surface, one of the remaining two can be referred to as a third cartridge bottom surface, and the last one can be referred to as a fourth cartridge bottom surface.

For example, one of the top surfaces of the toner cartridges 70y to 70k can be referred to as a first cartridge top surface, one of the remaining three can be referred to as a second cartridge top surface, one of the remaining two can be referred to as a third cartridge top surface, and the last one can be referred to as a fourth cartridge top surface.

For example, one of the side surfaces of the toner cartridges 70y to 70k can be referred to as a first cartridge side surface, one of the remaining three can be referred to as a second cartridge side surface, one of the remaining two can be referred to as a third cartridge side surface, and the last one can be referred to as a fourth cartridge side surface.

In other words, the first cartridge side surface extends in a direction that crosses the first cartridge top surface and the first cartridge bottom surface. The second cartridge side surface extends in a direction that crosses the second cartridge top surface and the second cartridge bottom surface. The third cartridge side surface extends in a direction that crosses the third cartridge top surface and the third cartridge bottom surface. The fourth cartridge side surface extends in a direction that crosses the fourth cartridge top surface and the fourth cartridge bottom surface.

The first cartridge top surface is positioned on the opposite side to the first cartridge bottom surface. The second cartridge top surface is positioned on the opposite side to the second cartridge bottom surface. The third cartridge top surface is positioned on the opposite side to the third cartridge bottom surface. The fourth cartridge top surface is positioned on the opposite side to the fourth cartridge bottom surface.

The first tray bottom surface faces the first cartridge bottom surface when the first cartridge is supported by the first tray. The second tray bottom surface faces the second cartridge bottom surface when the second cartridge is supported by the second tray. The third tray bottom surface faces the third cartridge bottom surface when the third cartridge is supported by the third tray. The fourth tray bottom surface faces the fourth cartridge bottom surface when the fourth cartridge is supported by the fourth tray.

As shown in FIG. 19A, in a state where the toner cartridge 70 compatible with the tray 80 is correctly mounted in the tray 80, the bottom portion 20 faces the cartridge holding portion 81 of the tray 80 and is supported by the cartridge holding portion 81. In the axial direction, the side portion 22 faces the side wall 100c, and the side portion 23 faces the side wall 100d. Furthermore, in the moving direction of the tray 80, the side portion 24 faces the side wall 100a, and the side portion 25 faces the side wall 100b.

For example, one of the side portions 22y to 22k can be referred to as a first tray side surface, one of the remaining three can be referred to as a second tray side surface, one of the remaining two can be referred to as a third tray side surface, and the last one can be referred to as a fourth tray side surface.

For example, one of the side portions 23y to 23k can be referred to as a first tray side surface, one of the remaining three can be referred to as a second tray side surface, one of the remaining two can be referred to as a third tray side surface, and the last one can be referred to as a fourth tray side surface.

For example, one of the side portions 24y to 24k can be referred to as a first tray side surface, one of the remaining three can be referred to as a second tray side surface, one of the remaining two can be referred to as a third tray side surface, and the last one can be referred to as a fourth tray side surface.

For example, one of the side portions 25y to 25k can be referred to as a first tray side surface, one of the remaining three can be referred to as a second tray side surface, one of the remaining two can be referred to as a third tray side surface, and the last one can be referred to as a fourth tray side surface.

In other words, when the first cartridge is supported by the first tray, the first cartridge side surface faces the first tray side surface. When the second cartridge is supported by the second tray, the second cartridge side surface faces the second tray side surface. When the third cartridge is supported by the third tray, the third cartridge side surface faces the third tray side surface. When the fourth cartridge is supported by the fourth tray, the fourth cartridge side surface faces the fourth tray side surface.

As shown in FIGS. 15 and 16, the toner cartridge 70 has a recess (opening) 30 that can insert the rib 150 of the tray 80. In other words, the toner cartridge 70y has the first recess, the toner cartridge 70m has the second recess, the toner cartridge 70c has the third recess, and the toner cartridge 70k has the fourth recess. As shown in FIGS. 18 and 19A, in a state where the toner cartridge 70 compatible with the tray 80 is mounted, the rib 150 of the tray 80 is inserted in the recess 30. In other words, the rib 150y of the tray 80y can be inserted into the recess 30y of the toner cartridge 70y, and the rib 150c of the tray 80c can be inserted into the recess 30c of the toner cartridge 70c. The rib 150m of the tray 80m can be inserted into the recess 30m of the toner cartridge 70m, and the rib 150k of the tray 80k can be inserted into the recess 30k of the toner cartridge 70k.

In the present embodiment, the sizes and shapes of the recess 30y to the recess 30k are the same. As shown in FIGS. 15 and 16, each of the recesses 30 of the toner cartridges 70y to 70c is formed across the bottom portion 20 and the side portion 25. The recess 30 of the toner cartridge 70k is formed across the bottom portion 20 and the side portion 23.

Next, the positional relationship among the recesses 30 of toner cartridges 70y to 70k will be described with reference to FIG. 17. As shown in FIG. 17, the length of the toner cartridge 70k in the second direction is longer than the length of each of the toner cartridges 70y to 70c in the second direction. In the first direction, the shortest distance dyl between the recess 30y and the side portion 22y, the shortest distance dml between the recess 30m and the side portion 22m, the shortest distance del between the recess 30c and the side portion 22c, and the shortest distance dkl between the recess 30k and the side portion 22k are different from one another. In the second direction, the shortest distance dyb between the recess 30y and the side portion 25y, the shortest distance dmb between the recess 30m and the side portion 25m, and the shortest distance dcb between the recess 30c and the side portion 25c are the same. In the second direction, the shortest distance dkb between the recess 30k and the side portion 25k is different from each of the shortest distance dyb between the recess 30y and the side portion 25y, the shortest distance dmb between the recess 30m and the side portion 25m, and the shortest distance dcb between the recess 30c and the side portion 25c. When viewed in the third direction, a straight line that passes through the center A of a line segment connecting the side portion 25k and side portion 24k of the toner cartridge 70k at the shortest distance and that extends in the direction of the rotation axis 90C overlaps the recess 30k.

### Normal Mounting of Toner Cartridge

Next, a case where the toner cartridge 70 is mounted in a correct orientation to the compatible tray 80 will be described with reference to FIGS. 18 and 19A.

As shown in FIG. 18, when the toner cartridge 70y is mounted in a correct orientation to the tray 80y, the rib 150y is inserted into the recess 30y.

As shown in FIG. 19A, when the toner cartridge 70y is mounted in the tray 80y in a correct orientation, the toner cartridge 70y takes a normal posture that is a normal posture relative to the tray 80y. At this time, the bottom portion 20y faces the cartridge holding portion 81y of the tray 80y and is supported by the cartridge holding portion 81y. In the axial direction, the side portion 22y faces the side wall 100cy, the side portion 23y faces the side wall 100dy, and the side portion 22y and the side portion 23y are positioned between the side wall 100cy and the side wall 100dy. Furthermore, in the moving direction of the tray 80y, the side portion 24y faces the side wall 100ay, the side portion 25y faces the side wall 100by, and the side portion 24y and the side portion 25y are positioned between the side wall 100ay and the side wall 100by. The rib 150y is inserted into the recess 30y. In other words, when the tray 80y supports the toner cartridge 70y such that the rib 150y is inserted into the recess 30y, the toner cartridge 70y takes a normal posture that is a normal posture relative to the tray 80y.

When the toner cartridge 70y is inverted such that the side portion 22y faces the side wall 100dy and the side portion 23y faces the side wall 100cy in the axial direction, the rib 150y contacts with the toner cartridge 70y, and the toner cartridge 70y is restricted from taking a normal posture relative to the tray 80y. When the toner cartridge 70y is inverted such that the side portion 24y faces the side wall 100by and the side portion 25y faces the side wall 100ay in the moving direction of the tray 80y, the rib 150y contacts with the toner cartridge 70y, and the toner cartridge 70y is restricted from taking a normal posture relative to the tray 80y. When the toner cartridge 70y is inverted such that the top portion 21y of the toner cartridge 70y faces the cartridge holding portion 81y, the rib 150y contacts with the toner cartridge 70y, and the toner cartridge 70y is restricted from taking a normal posture relative to the tray 80y.

In other words, when the toner cartridge 70y is inverted in one or two of the first direction, the second direction, and the third direction from a correct orientation, the rib 150y contacts with the toner cartridge 70y, and the toner cartridge 70y is restricted from taking a normal posture relative to the tray 80y.

The toner cartridge 70 supported in a normal posture moves from the retreat position to the mounting position relative to the rotary body 90 (more specifically, relative to the developing frame 53 of the developing unit 50) when the tray 80 moves from the eject position to the storage position. In other words, the tray 80 is displaced relative to the rotary body 90 between a position (eject position) where the toner cartridge 70 supported in a normal posture is positioned outside the rotary body 90 and between a position (storage position) where the toner cartridge 70 is positioned inside the rotary body 90.

The mounting of the toner cartridge 70y to the tray 80y, the mounting of the toner cartridge 70m to the tray 80m, the mounting of the toner cartridge 70c to the tray 80c, and the mounting of the toner cartridge 70k to the tray 80k are similar to one another. In other words, the toner cartridge 70m is mounted in a normal posture to the tray 80m, the toner cartridge 70c is mounted in a normal posture to the tray 80c, and the toner cartridge 70k is mounted in a normal posture to the tray 80k. Therefore, the description of the mounting of the toner cartridge 70m to the tray 80m, the mounting of the toner cartridge 70c to the tray 80c, and the mounting of the toner cartridge 70k to the tray 80k is omitted.

In this way, the first toner cartridge is supported by the first tray and takes a first posture (normal posture). The second toner cartridge is supported by the second tray and takes a second posture (normal posture).

### Incorrect Mounting of Toner Cartridge

A case where the toner cartridge 70 is mounted in the incompatible tray 80 (incorrect mounting of the toner cartridge) will be described with reference to FIG. 19B.

The toner cartridges 70y to 70k take an incorrect mounting posture that is not a normal posture when supported by the incompatible trays 80y to 80k. More specifically, the rib 150 contacts with the toner cartridge 70 and takes an incorrect mounting posture that is not a normal posture.

For example, when the tray 80y supports the toner cartridge 70m as shown in FIG. 19B, the toner cartridge 70m takes an incorrect mounting posture. In other words, the rib 150y has a function of a restricting portion that restricts the toner cartridge 70m from taking the same posture for the tray 80y as the normal posture that the toner cartridge 70y takes for the tray 80y. In a state where the tray 80y supports the toner cartridge 70m, the rib 150y contacts with the toner cartridge 70m. As a result, the toner cartridge 70m is restricted from taking the same posture for the tray 80y as the normal posture that the toner cartridge 70y takes for the tray 80y. In other words, when the first tray supports the second cartridge, the first restricting portion of the first tray contacts with the second cartridge to restrict the second cartridge from taking the same posture as the first posture for the first tray. When the second tray supports the first cartridge, the second restricting portion of the second tray contacts with the first cartridge to restrict the first cartridge from taking the same posture as the second posture for the second tray.

As shown in FIG. 19B, in a state where the toner cartridge 70m is supported by the tray 80y, the distance between the topmost part of the toner cartridge 70m and the rib 150y in a direction orthogonal to the cartridge holding portion 81y (that is, a direction orthogonal to the moving direction of the tray 80 and the direction of the rotation axis 90C) is defined as distance Dmg. On the other hand, as shown in FIG. 19A, in a state where the toner cartridge 70y is supported in a normal posture by the tray 80y, the distance between the topmost part of the tray 80y and the rib 150y in a direction orthogonal to the cartridge holding portion 81y is defined as distance Dms. At this time, the distance Dmg is longer than the distance Dms. The incorrect mounting posture shown in FIG. 19B is one example, and the incorrect mounting posture can be various postures depending on how the toner cartridge 70 is supported by the tray 80.

In the present embodiment, as shown in FIGS. 19A and 19B, the normal posture of the toner cartridge 70 differs in inclination from the incorrect mounting posture of the toner cartridge 70. More specifically, as shown in FIG. 19B, when incorrectly mounted, the bottom surface 20 of the toner cartridge 70 inclines relative to the cartridge holding portion 81. For example, any one of the cartridge holding portions 81y to 81k can be referred to as a first support surface. One of the remaining three may be referred to as a second support surface. The tray 80 having the first support surface can be referred to as the first tray, and the tray 80 having the second support surface can be referred to as the second tray. The correct toner cartridge 70 for the first tray can be referred to as the first cartridge, and the correct toner cartridge 70 for the second tray can be referred to as the second cartridge. The bottom surface of the second cartridge inclines relative to the first support surface in a state where the first tray supports the second cartridge. The bottom surface of the first cartridge inclines relative to the second support surface in a state where the second tray supports the first cartridge.

As a result, when the user mounts the toner cartridge 70 to the incompatible tray 80, the toner cartridge 70 takes an incorrect mounting posture that is different from the normal posture, so the user easily recognizes the incorrect mounting. The position of the toner cartridge 70 relative to the tray 80 just needs to be different between the normal posture and incorrect mounting posture of the toner cartridge 70, and the toner cartridge 70 in the incorrect mounting posture does not need to incline relative to the tray 80.

The mounting of the toner cartridge 70c to the tray 80y, the mounting of the toner cartridges 70y, 70c to the tray 80m, and the mounting of the toner cartridges 70y, 70m to the tray 80c are similar to the mounting of the toner cartridge 70m to the tray 80y. Therefore, the description of them is omitted.

In this present embodiment, the length of each of the toner cartridges 70y to 70k in the first direction is longer than the distance from the side wall 100c of each of the tray 80y to the tray 80k to the rib 150 and is also longer than the distance from the side wall 100d to the rib 150. Therefore, even when the cartridge holding portion 81 and the bottom portion 20 face each other and the incorrect toner cartridge 70 is moved in the direction of the rotation axis 90C so as not to overlap the rib 150 and supported by the tray 80, the toner cartridge 70 contacts with the side wall 100c or the side wall 100d and cannot be correctly mounted.

Next, a case where the incorrect toner cartridge 70 is mounted on the tray 80k will be described with reference to FIGS. 20A and 20B. As described above, in the moving direction of the tray 80, the length of the cartridge holding portion 81k is longer than the length of each of the cartridge holding portion 81y, the cartridge holding portion 81m, and the cartridge holding portion 81c. Therefore, the tray 80k can support the toner cartridge 70y such that the toner cartridge 70y contacts with the side wall 100ak of the tray 80k as shown in FIG. 20A, and can support the toner cartridge 70y such that the toner cartridge 70y contacts with the side wall 100bk of the tray 80k as shown in FIG. 20B. However, the shortest distance Dka between the side wall 100ak and rib 150k of the tray 80k in the moving direction of the tray 80 and the shortest distance Dkb between the side wall 100bk and rib 150k of the tray 80k in the moving direction of the tray 80 both are shorter than the length Cy2 of the toner cartridge 70y in the second direction. Therefore, even when the position to support the toner cartridge 70y is moved in the moving direction of the tray 80, the toner cartridge 70y contacts with the rib 150k and takes an incorrect mounting posture. In other words, the toner cartridge 70y is restricted from being supported by the tray 80k while avoiding the rib 150k.

The shortest distance Dka between the side wall 100ak and rib 150k of the tray 80k and the shortest distance Dkb between the side wall 100bk and rib 150k of the tray 80k both are shorter than the length Cm2 of the toner cartridge 70m in the second direction, and shorter than the length Cc2 of the toner cartridge 70c in the second direction. For this reason, the mounting of the toner cartridges 70m, 70c to the tray 80k is the same as the mounting of the toner cartridge 70y to the tray 80k. Therefore, the description of them is omitted.

On the other hand, the shortest distance Dya between the side wall 100ay and rib 150y of the tray 80y in the moving direction of the tray 80 and the shortest distance Dyb between the side wall 100by and rib 150y of the tray 80y in the moving direction of the tray 80 both are shorter than the length Ck2 of the toner cartridge 70k in the second direction. The shortest distance Dyab between the side wall 100ay and side wall 100by of the tray 80y in the moving direction of the tray 80y is shorter than the length Ck2 of the toner cartridge 70k in the second direction. Therefore, when the tray 80y supports the toner cartridge 70k, at least one of the side wall 100a and the side wall 100b contacts with the toner cartridge 70k, and the toner cartridge 70k is restricted from taking the same posture as its normal posture for the tray 80y.

Furthermore, the shortest distance Dmab between the side wall 100am and side wall 100bm of the tray 80m in the moving direction of the tray 80m is shorter than the length Ck2 of the toner cartridge 70k in the second direction. The shortest distance Dcab between the side wall 100ac and side wall 100bc of the tray 80c in the moving direction of the tray 80c is shorter than the length Ck2 of the toner cartridge 70k in the second direction. For this reason, the mounting of the toner cartridge 70k to the trays 80m, 80c is similar to the mounting of the toner cartridge 70k to the tray 80y. Therefore, the description of them is omitted.

### Modifications

In the present embodiment, the tray 80 has the rib 150, and the toner cartridge 70 has the recess 30. However, as shown in FIGS. 21 and 22, the side wall of the tray 80 may have a recess 31, and the side portion of the toner cartridge 70 may have a rib 151.

FIG. 21 shows plan views of toner cartridges 70 according to a modification. FIG. 22 shows plan views of the trays 80 corresponding to the toner cartridges 70 of FIG. 21. As shown in FIG. 21, the ribs 151y to 151c are respectively provided at the side portions 25y to 25c. The rib 151k is provided at the side portion 22k. On the other hand, as shown in FIG. 22, the recesses 31y to 31k are respectively formed in the side walls 100by to 100bc and side wall 100ck of the trays 80. Each of the side walls 100by to 100bc and the side wall 100ck extends in a direction that crosses the direction in which the tray 80 is displaced from the eject position to the storage position and the axial direction of the rotary body 90.

In other words, when the toner cartridges 70y to 70k are respectively mounted to the compatible trays 80y to 80k, the ribs 151y to 151k are inserted into the recesses 31y to 31k. On the other hand, when the toner cartridges 70y to 70k are mounted to the incompatible trays 80y to 80k, the ribs 151y to 151k contact with the side walls 100y to 100k of the trays 80y to 80k. In this case, a contact portion of the tray 80, which contacts with the rib 151, restricts the toner cartridge 70 from taking a normal posture relative to the tray 80. In other words, the first cartridge has a first protrusion, the first tray has a first recess, the second cartridge has a second protrusion, and the second tray has a second recess. When the first tray supports the second cartridge, the first restricting portion contacts with the second protrusion. When the second tray supports the first cartridge, the second restricting portion contacts with the first protrusion. In this modification, the example in which the tray 80 has the recess 31 has been described. Alternatively, the side wall of the tray 80 may have an opening instead of a recess.

The shapes of the rib 150y to rib 150k are the same. Alternatively, as shown in FIG. 23, the shapes of rib 152y to rib 152k may be different when viewed in a direction orthogonal to the cartridge holding portion 81 (that is, in a direction orthogonal to the axis direction of the rotary body 90). In response to this, as shown in FIG. 24, the shapes of recess 32y to recess 32k may be different. The difference in shape includes similarity shapes of different sizes, and similarity shapes of the same size but different in orientation, like the tray 80y and the tray 80c shown in FIG. 24.

In the present embodiment, the tray 80 has a single rib 150. Alternatively, the tray 80 may have one or more ribs 150 or recesses 30. In response to this, the toner cartridge 70 may have one or more ribs 150 or recesses 30.

As shown in FIG. 17, the recess 30 of the toner cartridge 70 is positioned closer to the side portion 22 of the cartridge than to the center A of the toner cartridge 70. In other words, when viewed in the third direction, the shortest distance between the recess 30 and the center between the side portion 22 and the side portion 23 is longer than the shortest distance between the recess 30 and the side portion 22. In response to this, as shown in FIG. 14, in the rib 150 of the tray 80 as well, where a position at the center between the side wall 100a and the side wall 100b and at the center between the side wall 100c and the side wall 100d is a center B when viewed in a direction orthogonal to the cartridge holding portion 81, the rib 150 is closer to the side wall 100a than to the central position. In this way, by disposing the recess 30 at a position close to the side wall, the design flexibility of the interior of the toner cartridge 70 can be improved.

In the present embodiment, the tray 80 has the side wall 100a to the side wall 100d. Alternatively, the tray 80 may have at least one or more side walls. The tray 80 does not need to have the side wall 100.

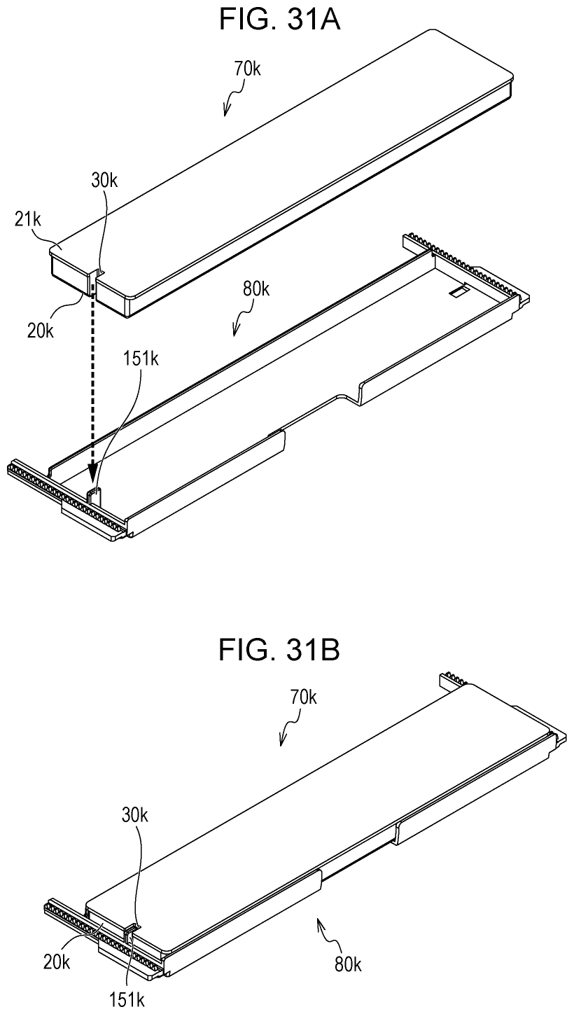

FIGS. 31A and 31B are perspective views showing a modification of the present disclosure. FIG. 31A shows a state before the toner cartridge 70k is mounted to the tray 80k, and FIG. 31B shows a state after being mounted. Here, the toner cartridge 70k is referred to as a first cartridge, and the tray 80k is referred to as a first tray. The bottom surface 20k of the toner cartridge 70k is referred to as a first cartridge bottom surface, and a top surface 21k is referred to as a first cartridge top surface. As shown in FIG. 31B, the first cartridge has a first cartridge bottom surface supported by the first tray in a first posture, and a first cartridge top surface that is a surface on the opposite side to the first cartridge bottom surface. The recess 30k of the first cartridge is continuous from the first cartridge bottom surface to the first cartridge top surface. By adopting this configuration, as shown in FIG. 31B, the rib 151k is exposed, so a user easily checks that the rib 151k is inserted in the recess 30k.

FIGS. 31A and 31B illustrate the toner cartridge 70k in an example. At least one of the toner cartridges 70y to 70c may have a similar configuration to the configuration of the toner cartridge 70k shown in FIGS. 31A and 31B.

In the present embodiment, the rib 150 of the toner cartridge 70 may be formed integrally with the tray 80 or may be formed separately.

In the present embodiment, the tray 80 includes a single rib 150. Alternatively, the tray 80 may be configured to include a plurality of ribs 150.

### Incorrect Mounting Suppression Configuration by Restricting Movement of Tray

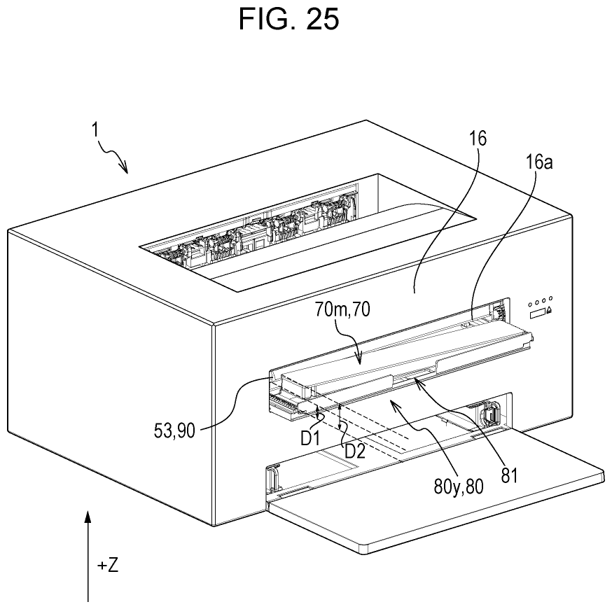

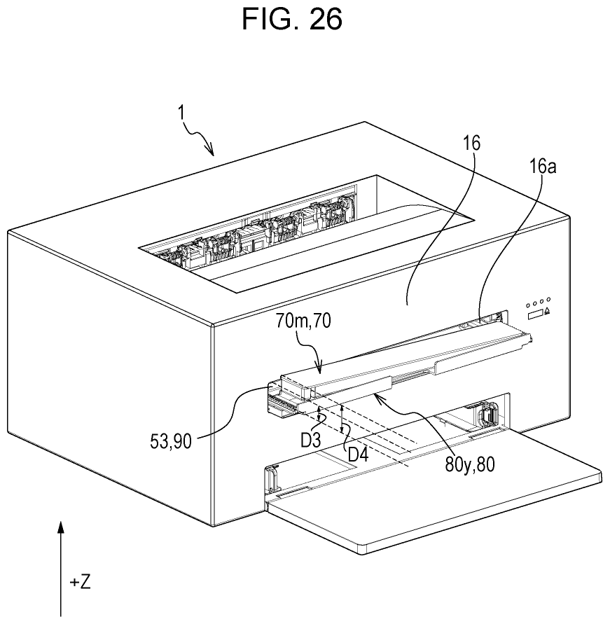

A configuration that restricts the toner cartridge 70 from moving to the mounting position when the toner cartridge 70 not compatible with the tray 80 is supported by the tray 80 will be described with reference to FIGS. 25 and 26.

FIGS. 25 and 26 are views that show a state where the toner cartridge 70 not compatible with the tray 80 is supported by the tray. FIGS. 25 and 26 show a state where the toner cartridge 70m is mounted on the tray 80y.

In the image forming apparatus 1 according to the present embodiment, when the tray 80 is moved from the eject position to the storage position in a state where the toner cartridge 70 not compatible with the tray 80 is supported by the tray 80, the movement of the tray 80 to the storage position is restricted.

As shown in FIG. 25, the toner cartridge 70m that is the toner cartridge 70 not compatible with the tray 80y is supported by the cartridge holding portion 81y of the tray 80y. In this state, the toner cartridge 70m takes an incorrect mounting posture for the tray 80y.

When the tray 80y is moved from the eject position toward the storage position in a state where the toner cartridge 70m takes an incorrect mounting posture for the tray 80y, the toner cartridge 70m contacts with the developing frame 53 of the rotary body 90. As a result, the tray 80y is restricted from moving to the storage position, and the toner cartridge 70m is restricted from moving to the mounting position. An example of incorrect mounting of the tray 80y and the toner cartridge 70m has been described. The above description also similarly applies to other incorrect mounting patterns. In other words, in a state where the first cartridge holding portion of the first tray supports the second cartridge, the first tray is restricted from moving to the second position, and, in a state where the second cartridge holding portion of the second tray supports the first cartridge, the second tray is restricted from moving to the fourth position.

In a state where the toner cartridge 70m is taking an incorrect mounting posture for the tray 80y, the distance D2 from the cartridge holding portion 81 to the topmost end of the toner cartridge 70m is longer than the shortest distance D1 from the cartridge holding portion 81 to the developing frame 53 in the vertical direction (+Z). Therefore, when the tray 80y is moved from the eject position toward the storage position, the toner cartridge 70m contacts with the developing frame 53 of the rotary body 90.

The toner cartridge 70 taking an incorrect mounting posture may be brought into contact with the frame 16 that accommodates the rotary body 90. As shown in FIG. 26, when the tray 80y is moved from the eject position toward the storage position in a state where the toner cartridge 70m is taking an incorrect mounting posture for the tray 80y, the toner cartridge 70m contacts with the frame 16 to restrict the movement of the tray 80 to the storage position.

In a state where the toner cartridge 70m is taking an incorrect mounting posture for the tray 80y, the distance D4 from the cartridge holding portion 81 to the topmost end of the toner cartridge 70m is longer than the shortest distance D3 from the cartridge holding portion 81 to the upper end of the opening 16a of the frame 16 in the vertical direction.

In other words, in the image forming apparatus 1 according to the present embodiment, when the tray 80 is moved from the eject position to the storage position in a state where the incorrect toner cartridge 70 is supported by the tray 80, the toner cartridge 70 contacts with the rotary body 90 (developing frame 53) or the frame 16. At this time, the moving device 85 may be stopped. The motor M2 may be stopped.

As described above, in the present embodiment, when the tray 80 is moved from the eject position to the storage position in a state where the incorrect toner cartridge 70 is supported by the tray 80, the toner cartridge 70 contacts with the rotary body 90 (developing frame 53) or the frame 16 to restrict the movement of the tray 80 to the storage position. As a result, it is possible to restrict the incorrect toner cartridge 70 from moving to the mounting position for the developing frame 53.

The mounting of the toner cartridge 70m to the tray 80y has been described. When a toner cartridge 70 not compatible with the tray 80y to the tray 80k is mounted as well, the movement of the trays 80y to 80k to the storage position will be similarly restricted.

### Modification of Incorrect Mounting Suppression Configuration by Restricting Movement of Tray

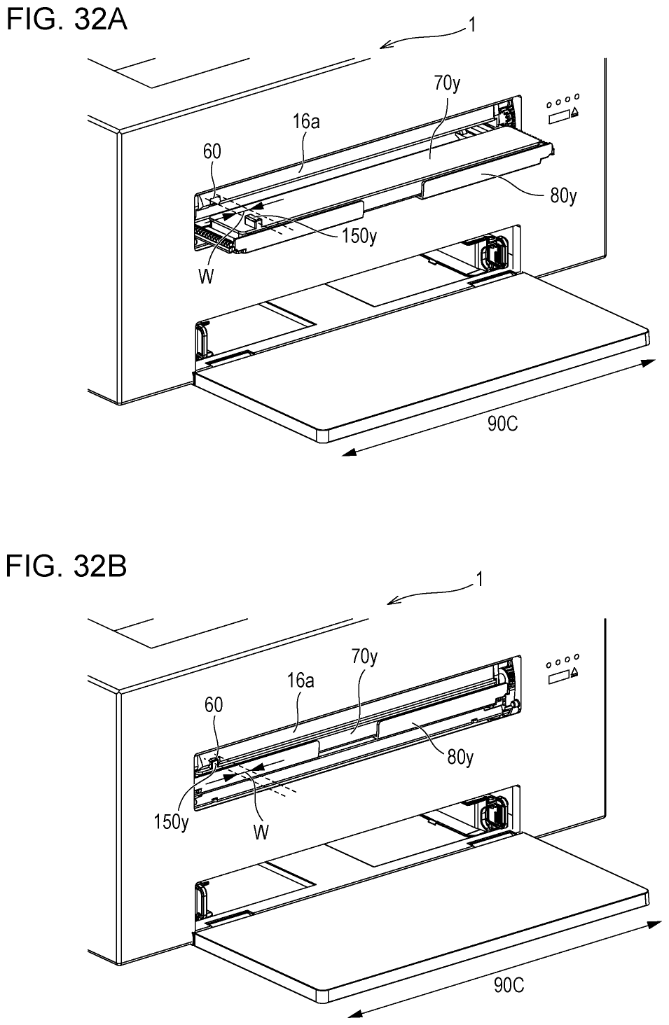

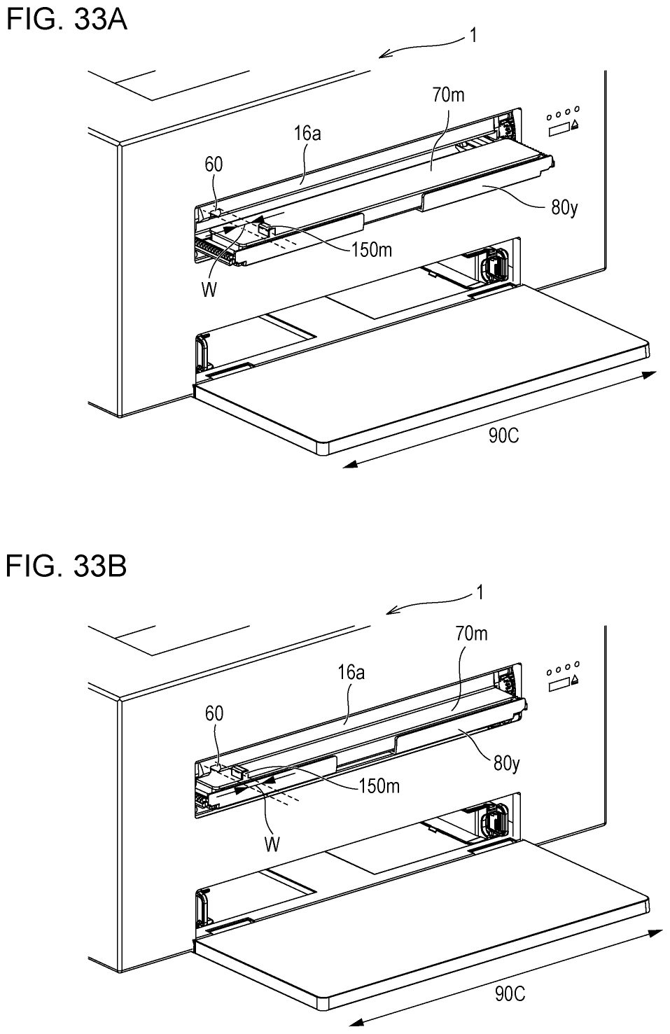

In the present embodiment, the movement of the tray 80 is restricted when the toner cartridge 70 takes an incorrect mounting posture. However, the movement of the tray 80 is desirably suppressed even when the toner cartridge 70 is incorrectly mounted in a normal posture. Therefore, a modification of the incorrect mounting suppression configuration by restricting the movement of the tray will be described with reference to FIGS. 32A, 32B, 33A, and 33B.

FIGS. 32A, 32B, 33A, and 33B are perspective views of the image forming apparatus 1. FIG. 32A shows a state where the toner cartridge 70y is supported by the tray 80y at the first position. FIG. 32B shows a state where the tray 80y is at the second position. FIG. 33A shows a state where the toner cartridge 70m is supported by the tray 80y at the first position. FIG. 33B shows a state after the tray 80y has moved from the state of FIG. 33A toward the second position.

The frame 16 has a recess 60. The toner cartridge 70y has a protrusion 150y. The toner cartridge 70m has a protrusion 150m. In the state of FIG. 32A, the protrusion 150y is positioned within the width (within the range of W) of the recess 60 in the direction of the rotation axis 90C. Therefore, when the tray 80y moves from the first position to the second position, the protrusion 150y passes through the recess 60, and the tray 80y moves to the second position, as shown in FIG. 32B.

On the other hand, in the state of FIG. 33A, the protrusion 150m is positioned outside the width (outside the range of W) of the recess 60 in the direction of the rotation axis 90C. Therefore, when the tray 80y moves from the first position toward the second position, the protrusion 150m contacts with the frame 16, and the tray 80y is restricted from reaching the second position from the first position, as shown in FIG. 33B.

Here, a frame 16 is referred to as a first frame, the toner cartridge 70y is referred to as a first cartridge, and the toner cartridge 70m is referred to as a second cartridge. The tray 80y is referred to as a first tray, and the tray 80m is referred to as a second tray. The recess 60 is referred to as a first recess, the protrusion 150y is referred to as a first protrusion, and the protrusion 150m is referred to as a second protrusion.

The first frame has the first recess, the first cartridge has the first protrusion, and the second cartridge has the second protrusion. In a state where the first tray at the first position supports the first cartridge, the first protrusion is positioned within the width of the first recess in the axial direction of the rotary body 90. When the first tray has moved from the first position to the second position, the first protrusion moves to the second position by passing through the first recess. In a state where the first tray at the first position supports the second cartridge, the second protrusion is positioned outside the width of the first recess in the axial direction of the rotary body 90. When the first tray moves from the first position to the second position, the second protrusion contacts with the first frame, and the first tray is restricted from moving to the second position.

### Right and Left Connecting Configuration of Tray Drive System

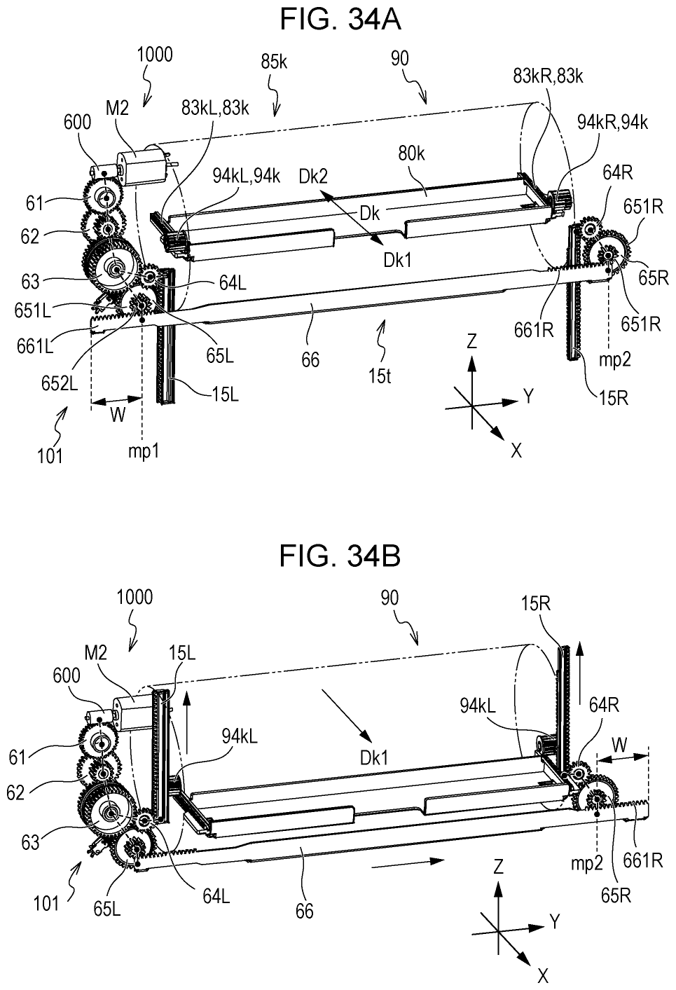

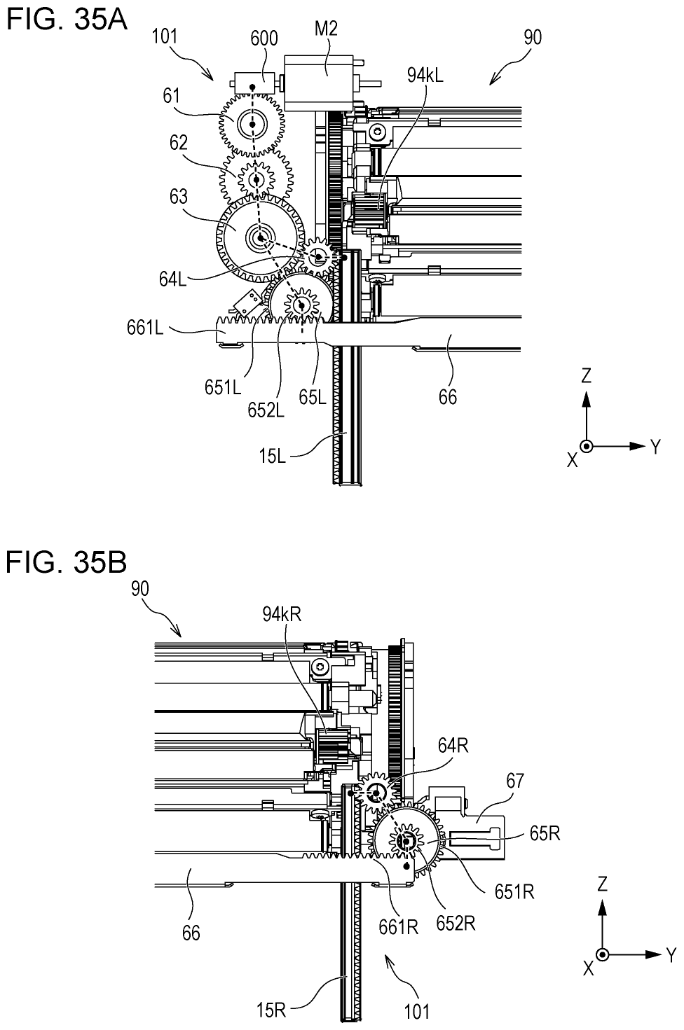

A drive system 1000 for moving the tray 80k as an example of a moving member and a configuration for connecting the right and left drive racks 15R, 15L (right and left connecting configuration) will be described with reference to FIGS. 34A, 34B, 35A, and 35B. The drive system 1000 for moving the tray 80k relative to the rotary body 90 will be described. Drive systems for moving the trays 80y to 80c that are other examples of the moving member are substantially similar to the drive system 1000 that will be described below, so the description is omitted.

For the purpose of description, when the apparatus body 1A is viewed from the −X side (when viewed from the front), the +Y side can be referred to as the right side of the apparatus body 1A, and the −Y side can be referred to as the left side of the apparatus body 1A. For example, one drive rack 15L is provided at the left side of the apparatus body 1A, and the other drive rack 15R is provided at the right side of the apparatus body 1A.

FIGS. 34A and 34B are perspective views of the drive system 1000 for the tray 80k. FIG. 34A shows a state where the tray 80k is positioned inside the rotary body 90 (a state where the tray 80k is at the storage position). FIG. 34B shows a state where the tray 80k has moved to the outside of the rotary body 90 (a state where the tray 80k is at the eject position). FIGS. 35A and 35B are views illustrating the configuration of the drive system 1000 for the tray 80k. FIG. 35A shows the configuration of the drive system 1000 at the left side of the apparatus body 1A. FIG. 35B shows the configuration of the drive system 1000 at the right side of the apparatus body 1A. FIGS. 35A and 35B show the state of the drive system 1000 when the tray 80k is at the storage position.

As shown in FIGS. 34A and 34B, the drive system 1000 of the tray 80k includes the motor M2 as a drive source, and a drive transmission mechanism 101 that transmits the driving force of the motor M2 to the tray 80k. The drive transmission mechanism 101 includes a rotating member that transmits the driving force of the motor M2 by rotation, and a linear motion member that transmits the driving force of the motor M2 by linear motion. More specifically, the drive transmission mechanism 101 of the present embodiment includes a worm gear 600, stepped gears 61, 62, an idle gear 63, drive rack input gears 64R, 64L, and the drive racks 15R, 15L.

The drive transmission mechanism 101 of the present embodiment includes stepped gears 65R, 65L, a connecting rack 66, and the pinions 94k (94kR, 94kL). The tray 80k includes the rack portions 83k (83kR, 83kL) as a force receiving portion that receives the driving force from the drive transmission mechanism 101. The connecting rack 66 is an example of the linear motion member.

The drive system 1000 for the tray 80k may also be regarded as being made up of the drive device 98 of the apparatus body 1A and the moving device 85k of the rotary body 90 (FIG. 2).

The drive device 98 includes the motor M2, the drive racks 15R, 15L, and the transmitting unit 15t that transmits driving force from the motor M2 to the drive racks 15R, 15L. The transmitting unit 15t includes the worm gear 600, the stepped gears 61, 62, the idle gear 63, the drive rack input gears 64R, 64L, the stepped gears 65R, 65L, and the connecting rack 66. The moving device 85k includes the pinions 94k (94kR, 94kL) and the rack portions 83k (83kR, 83kL). Therefore, the “drive transmission mechanism 101” includes elements of the drive device 98 other than the motor M2, elements of the moving device 85k other than the elements provided in the tray 80k (the rack portions 83kR, 83kL).

The drive system for the tray 80y is obtained by replacing the moving device 85k of the drive system 1000 with the moving device 85y corresponding to the tray 80y, and the drive device 98 is common.

The drive system for the tray 80m is obtained by replacing the moving device 85k of the drive system 1000 with the moving device 85m corresponding to the tray 80m, and the drive device 98 is common. The drive system for the tray 80c is obtained by replacing the moving device 85k of the drive system 1000 with the moving device 85c corresponding to the tray 80c, and the drive device 98 is common.

As shown in FIG. 34A, the tray 80k of the present embodiment includes two rack portions 83kR, 83kL. The rack portion 83kL is an example of a first force receiving portion, and the rack portion 83kR is an example of a second force receiving portion.

The rack portion 83kR (second force receiving portion) is disposed at a position away from the rack portion 83kL (first force receiving portion) in a direction that crosses the moving direction Dk of the tray 80k. In the present embodiment, the rack portion 83kR is positioned away from the rack portion 83kL in the rotation axis direction (Y direction) of the rotary body 90. In the present embodiment, the rack portion 83kL is disposed at one end (left end) of the tray 80k in the rotation axis direction (Y direction) of the rotary body 90. On the other hand, the rack portion 83kR is disposed at the other end (right end) of the tray 80k in the rotation axis direction (Y direction) of the rotary body 90.

The rotary body 90 of the present embodiment includes two pinions 94kR, 94kL corresponding to two rack portions 83kR, 83kL. The two pinions 94kR, 94kL include the pinion 94kR corresponding to the rack portion 83kR and the pinion 94kL corresponding to the rack portion 83kL.

As shown in FIG. 34A, the worm gear 600 is secured to the output shaft of the motor M2. The stepped gear 61 integrally has a large-diameter gear that meshes with the worm gear 600 and a small-diameter gear smaller in diameter than the large-diameter gear. The stepped gear 62 integrally has a large-diameter gear that meshes with the small-diameter gear of the stepped gear 61, and a small-diameter gear smaller in diameter than the large-diameter gear. The idle gear 63 is in mesh with each of the small-diameter gear of the stepped gear 62, the stepped gear 65L, and the drive rack input gear 64L. The drive rack input gear 64L is in mesh with the drive rack 15L.

As shown in FIGS. 35A and 35B, the stepped gear 65L integrally has a large-diameter gear 651L that meshes with the idle gear 63, and a small-diameter gear 652L (third small-diameter gear) smaller in diameter than the large-diameter gear 651L. The stepped gear 65L is configured to transmit the driving force of the motor M2, received by the large-diameter gear 651L, to the connecting rack 66 via the small-diameter gear 652L. The connecting rack 66 has a first rack portion 661L that meshes with the small-diameter gear 652L of the stepped gear 65L, and a second rack portion 661R that meshes with the small-diameter gear 652R of the stepped gear 65R. The stepped gear 65R integrally has the large-diameter gear 651R that meshes with the drive rack input gear 64R, and the small-diameter gear 652R smaller in diameter than the large-diameter gear 651R. The stepped gear 65R is configured to transmit the driving force of the motor M2, received by the small-diameter gear 652R from the connecting rack 66, to the rack portion 83kR via the large-diameter gear 651R. The drive rack input gear 64R is in mesh with the drive rack 15R.

The connecting rack 66 is a rack member that is capable of reciprocating in a direction that crosses (preferably, a direction orthogonal to) the moving direction Dk of the tray 80k. In the present embodiment, the connecting rack 66 reciprocates in the Y direction that is the rotation axis direction of the rotary body 90. In other words, the connecting rack 66 moves in a direction different from the moving direction of the drive racks 15R, 15L (a direction that crosses the Y direction, and the Z direction in the present embodiment) that are the other rack members of the drive transmission mechanism 101. The connecting rack 66 of the present embodiment is elongated so as to extend in the Y direction. In other words, the longitudinal direction of the connecting rack 66 is the Y direction. The first rack portion 661L is provided at one end of the connecting rack 66 in the Y direction, and the second rack portion 661R is provided at the other end of the connecting rack 66 in the Y direction. The first rack portion 661L and the second rack portion 661R may be continuous.

The left drive rack 15L is an example of a first transmission member for transmitting the driving force of the motor M2 to the rack portion 83kL of the tray 80k, which serves as the first force receiving portion. The right drive rack 15R is an example of a second transmission member for transmitting the driving force of the motor M2 to the rack portion 83kR of the tray 80k, which serves as the second force receiving portion. The right and left drive racks 15R, 15L are connected to each other via the connecting rack 66 so as to operate in conjunction with each other. Specifically, the left drive rack 15L is connected to the right drive rack 15R via the drive rack input gear 64L, the idle gear 63, the stepped gear 65L, the connecting rack 66, the stepped gear 65R, and the drive rack input gear 64R.

The connecting rack 66 is configured to transmit the force received from one of the drive racks 15R, 15L to the other one of the drive racks 15R, 15L. The drive transmission mechanism 101 including the connecting rack 66 is configured to transmit the force received from one of the two rack portions 83kR, 83kL of the tray 80k to the other one of the rack portions 83kR, 83kL. The benefits of this configuration will be described later.

The operation of the drive system 1000 when the tray 80k is moved from the storage position (FIG. 34A) to the eject position (FIG. 34B) will be described. Hereinafter, the rotation direction of the motor M2 (first rotation direction, first direction) when the tray 80k is moved from the storage position toward the eject position is referred to as a forward direction. The rotation direction of the motor M2 (second rotation direction, second direction) when the tray 80k is moved from the eject position toward the storage position is referred to as a reverse direction. In the moving direction Dk in which the tray 80k moves between the eject position and the storage position, the direction from the eject position toward the storage position is referred to as an insertion direction Dk2, and the direction from the storage position toward the eject position is referred to as an ejection direction Dk1.

When the motor M2 rotates in the forward direction, the driving force is transmitted in order of the worm gear 600, the stepped gear 61, the stepped gear 62, and the idle gear 63. Subsequently, the driving force is transmitted from the idle gear 63 to both the drive rack input gear 64L and the stepped gear 65L. The left drive rack 15L is slid upward (+Z direction) by the drive rack input gear 64L to which the driving force is transmitted from the idle gear 63.

The left drive rack 15L engages with the left pinion 94kL during the process of moving upward to rotate the pinion 94kL. When the pinion 94kL is rotated, the driving force is transmitted to the rack portion 83kL of the tray 80k that is in mesh with the pinion 94kL. As a result, the rack portion 83kL of the tray 80k receives the force in the ejection direction Dk1 from the storage position toward the eject position via the left drive train (the drive rack input gear 64L, the drive rack 15L, and the pinion 94kL) of the drive transmission mechanism 101.

On the other hand, the driving force of the idle gear 63 is also transmitted to the right drive train (the drive rack input gear 64R, the drive rack 15R, and the pinion 94kR) of the drive transmission mechanism 101 via the stepped gear 65L and the connecting rack 66. In other words, the connecting rack 66 is slid to the right side (in the +Y direction) of the apparatus body 1A by the stepped gear 65L to which the driving force is transmitted from the idle gear 63. When the connecting rack 66 is slid, the driving force is transmitted to the drive rack input gear 64R via the stepped gear 65R, and the right drive rack 15R is slid upward (in the +Z direction).

The right drive rack 15R meshes with the right pinion 94kR during the process of moving upward to rotate the pinion 94kR. When the pinion 94kR is rotated, the driving force is transmitted to the rack portion 83kR of the tray 80k, which is in mesh with the pinion 94kR. As a result, the tray 80k receives the force in the ejection direction Dk1 from the storage position toward the eject position via the right drive train (the drive rack input gear 64R, the drive rack 15R, and the pinion 94kR) of the drive transmission mechanism 101.

In this way, when the motor M2 rotates in the forward direction, the tray 80k moves from the storage position (FIG. 34A) toward the eject position (FIG. 34B) by receiving the force in the ejection direction Dk1 at the right and left rack portions 83kR, 83kL.

The operation of the drive system 1000 when the tray 80k is moved from the eject position to the storage position is similar to the case when the tray 80k is moved from the storage position to the eject position, except that the rotation direction or sliding direction of each element of the drive system 1000 is reversed. In other words, when the motor M2 rotates in the reverse direction, the left drive rack 15L is slid downward (in the −Z direction) via the worm gear 600, the stepped gear 61, the stepped gear 62, the idle gear 63, and the drive rack input gear 64L. When the drive rack 15L is slid, the driving force in the insertion direction Dk2 is transmitted to the rack portion 83kL of the tray 80k via the pinion 94kL. On the other hand, the driving force is transmitted from the idle gear 63 to the connecting rack 66 via the stepped gear 65L, and the connecting rack 66 is slid to the left side (in the −Y direction) of the apparatus body 1A. When the connecting rack 66 is slid, the right drive rack 15R is slid downward (in the −Z direction) via the stepped gear 65R and the drive rack input gear 64R. When the drive rack 15R is slid, the driving force in the insertion direction Dk2 is transmitted to the rack portion 83kR of the tray 80k via the pinion 94kR.

In this way, when the motor M2 rotates in the reverse direction, the tray 80k moves from the eject position (FIG. 34B) toward the storage position (FIG. 34A) by receiving the force in the insertion direction Dk2 at the right and left rack portions 83kR, 83kL.

As described above, during the tray ejection operation or the tray insertion operation of the tray 80k (hereinafter, collectively referred to as ejection or insertion operation), the driving force of the motor M2 is transmitted to the right and left rack portions 83kR, 83kL of the tray 80k by the drive transmission mechanism 101. In other words, during the tray ejection operation, the driving force in the ejection direction Dk1 is transmitted to each of the two rack portions 83kR, 83kL, and during the tray insertion operation, the driving force in the insertion direction Dk2 is transmitted to each of the two rack portions 83kR, 83kL. For this reason, compared to the configuration that the driving force is transmitted to only one rack portion of the tray 80k during the ejection or insertion operation of the tray 80k, the tray 80k is less likely to tilt, so further stable ejection or insertion operation is possible.

### Benefits of Right and Left Connecting Configuration

Hereinafter, the benefits of the configuration that the right and left drive racks 15R, 15L are connected by the connecting rack 66 will be described.

The connecting rack 66 of the present embodiment transmits the force received from the left drive rack 15L to the right drive rack 15R, and transmits the force received from the right drive rack 15R to the left drive rack 15L. The drive transmission mechanism 101 of the present embodiment, including the connecting rack 66, transmits the force received from the left rack portion 83kL of the tray 80k to the right rack portion 83kR, and transmits the force received from the right rack portion 83kR of the tray 80k to the left rack portion 83kL. In other words, the drive transmission mechanism is configured to transmit the force received by the drive transmission mechanism from the first force receiving portion of the moving member to the second force receiving portion, and to transmit the force received by the drive transmission mechanism from the second force receiving portion of the moving member to the first force receiving portion.

Therefore, the right and left drive racks 15R, 15L are connected to each other via the connecting rack 66 so as to move in conjunction with each other. The drive transmission mechanism 101 including the connecting rack 66 can move the rack portion 83kL of the tray 80k and the rack portion 83kR of the tray 80k in conjunction with each other. Thus, the tray 80k is less likely to tilt.

More specifically, when the tray 80k is at the eject position, a user is able to execute the tray insertion operation by operating the operating unit provided on the apparatus body 1A (for example, buttons on the operating panel) to move the tray 80k to the storage position.

On the other hand, when the user pushes in the tray 80k in a state where the tray 80k is at the eject position, the tray 80k is allowed to move toward the storage position (the details of a mechanism that allows this movement will be described later). At this time, the user does not necessarily push the center of the tray 80k in the width direction (right and left direction, Y direction) of the apparatus body 1A. If an area near one end of the tray 80k in the Y direction is pushed by the user, one end moves in the insertion direction Dk2, and the other end does not move, the tray 80k tilts. When the tray 80k tilts, it is difficult for the user to smoothly push the tray 80k into the rotary body 90. When the tray 80k tilts, the drive system 1000 can have difficulty in smoothly executing the tray insertion operation.

When the right and left drive racks 15R, 15L for the tray 80k are connected as in the case of the present embodiment, it is possible to suppress the tilting of the tray 80k. This is because, even when one end of the tray 80k in the Y direction is pushed and moved in the insertion direction Dk2, the other end of the tray 80k also moves in the insertion direction Dk2 since the right and left drive racks 15R, 15L are connected to each other.

For example, assuming that, in the state shown in FIG. 34B, the user pushes in an area near the left end (−Y side) of the tray 80k in the insertion direction Dk2. In this case, the drive rack 15L is moved downward via the pinion 94kL by the movement of the rack portion 83kL in the insertion direction Dk2. When the drive rack 15L moves downward, the drive rack input gear 64L, the idle gear 63, and the stepped gear 65L rotate, and the connecting rack 66 moves to the left side (in the −Y direction). When the connecting rack 66 moves to the left side, the stepped gear 65R and the drive rack input gear 64R rotate, and the drive rack 15R moves downward. When the drive rack 15 moves downward, the rack portion 83kR receives the force in the insertion direction Dk2 via the pinion 94kR.

In other words, the tray 80k receives the force in the insertion direction Dk2 from the user near the rack portion 83kL provided at the left-side (−Y-side) end and also receives the force in the insertion direction Dk2 at the rack portion 83kR provided at the right-side (+Y-side) end. The drive transmission mechanism 101 enables the transmission of force in the insertion direction Dk2 to the rack portion 83kR by transmitting part of the force received by the drive rack 15L from the tray 80k via the pinion 94kL to the drive rack 15R via the pinion 94kR. Therefore, it is possible to suppress the tilting of the tray 80k compared to the configuration that the force in the insertion direction Dk2 acts only near the left-side (−Y-side) end of the tray 80k. This also applies to the case where an area near the rack portion 83kR is pushed in the insertion direction Dk2.

The drive transmission mechanism 101 is configured such that, when the tray 80k is pushed in the insertion direction Dk2, the force rotates the idle gear 63, but the force is not transmitted from the idle gear 63 to the motor M2. In the present embodiment, the force transmission path when the tray 80k is pushed in the insertion direction Dk2 is interrupted by the idle gear 63 as will be described later. Therefore, when one end of the tray 80k in the Y direction is pushed and moved in the insertion direction Dk2 without being affected by the static torque of the motor M2, the other end of the tray 80k can move in the insertion direction Dk2 together.

Therefore, the tray 80k is less likely to tilt, so it is possible to achieve smooth operability at the time when the user pushes the tray 80k in.

### Benefits in Using Stepped Gear in Right and Left Connecting Configuration

As shown in FIG. 34A, in a state where the tray 80k is at the storage position, the connecting rack 66 is in mesh with both the right and left stepped gears 65R, 65L. As shown in FIG. 34B, in a state where the tray 80k is at the eject position as well, the connecting rack 66 is in mesh with both the right and left stepped gears 65R, 65L.

As described earlier, the connecting rack 66 moves to the right side (in the +Y direction) of the apparatus body 1A when the tray 80k moves from the storage position to the eject position. The amount of movement of the connecting rack 66 during the movement of the tray 80k from the storage position to the eject position is denoted as W. In this case, in a state where the tray 80k is at the storage position (FIG. 34A), the first rack portion 661L of the connecting rack 66 extends at least the length of the amount of movement W to the left side (in the −Y direction) from a meshing position mp1 with the stepped gear 65L. In a state where the tray 80k is at the eject position (FIG. 34B), the second rack portion 661R of the connecting rack 66 extends at least the length of the amount of movement W to the right side (in the +Y direction) from a meshing position mp2 with the stepped gear 65R. In other words, the length of the connecting rack 66 in the moving direction (the Y direction in the present embodiment) of the connecting rack 66 is equal to or greater than the sum of the distance from the meshing position mp1 with the stepped gear 65L to the meshing position mp2 with the stepped gear 65R and the amount of movement W of the connecting rack 66.

Therefore, in order to achieve downsizing in the right and left direction (width direction, Y direction) of the apparatus body 1A, the amount of movement W of the connecting rack 66 is desirably small. Hereinafter, a configuration that reduces the amount of movement W of the connecting rack 66 and that enables downsizing of the apparatus body 1A in the width direction (Y direction) will be described.

As shown in FIG. 35A, the stepped gear 65L (first stepped gear) includes the large-diameter gear 651L (first large-diameter gear) and the small-diameter gear 652L (first small-diameter gear) smaller in pitch radius than the large-diameter gear 651L. The large-diameter gear 651L is in mesh with the idle gear 63 and can receive the driving force of the motor M2 via the idle gear 63. In other words, the large-diameter gear 651L (first large-diameter gear) is drivably connected to the motor M2 (drive source). The small-diameter gear 652L is in mesh with the first rack portion 661L of the connecting rack 66.

The large-diameter gear 651L is connected to the rack portion 83kL of the tray 80k via the idle gear 63, the drive rack input gear 64L, the drive rack 15L, and the pinion 94kL. In other words, the large-diameter gear 651L (first large-diameter gear) is drivably connected to the rack portion 83kL (first force receiving portion).

The ratio (r2/r1) of the pitch radius r2 of the small-diameter gear 652L to the pitch radius r1 of the large-diameter gear 651L is referred to as the pitch radius ratio of the stepped gear 65L. With the configuration that the driving force is transmitted to the connecting rack 66 via the stepped gear 65L, the amount of movement W of the connecting rack 66 reduces depending on the pitch radius ratio (r2/r1) of the stepped gear 65L. In other words, when the speed is reduced with the stepped gear 65L, it is possible to reduce the amount of movement W during the ejection or insertion operation of the tray 80k and achieve downsizing in the width direction (Y direction) of the apparatus body 1A.

More specifically, if a spur gear instead of the stepped gear 65L meshes with both the idle gear 63 and the connecting rack 66 for power transmission, the ratio of the moving distance of the connecting rack 66 to the moving distance of the teeth of the idle gear 63 is one. The moving distance of the teeth of the idle gear 63 is the length of a circular arc traced by a point on the pitch circle of the idle gear 63 as the idle gear 63 rotates. In contrast, by interposing the stepped gear 65L between the idle gear 63 and the connecting rack 66, the ratio of the moving distance of the connecting rack 66 to the moving distance of the teeth of the idle gear 63 is less than one. In other words, the stepped gear 65L can decelerate the movement of the teeth of the idle gear 63 and transmit the movement to the connecting rack 66. Therefore, it is possible to reduce the amount of movement W of the connecting rack 66.

Here, the amounts of movement of the right and left rack portions 83kR, 83kL when the tray 80k is moved are desirably equal to each other. The moving speeds of the right and left rack portions 83kR, 83kL when the tray 80k is moved are desirably equal to each other. This is because, when the amounts of movement (moving speeds) of the right and left rack portions 83kR, 83kL are different, the tray 80k inclines during the movement, and, as a result, it is difficult to stably move the tray 80k. In the present embodiment, the numbers of teeth of the right and left pinions 94kR, 94kL are equal to each other. In other words, the amounts of movement (moving speeds) of the right and left drive racks 15R, 15L are equal to each other.

However, as described above, the stepped gear 65L decelerates the movement of the teeth of the idle gear 63 and transmits the movement to the connecting rack 66. For this reason, depending on the configuration of power transmission from the connecting rack 66 to the drive rack 15R, the amount of movement (moving speed) of the drive rack 15R may be less (slower) than the amount of movement (moving speed) of the drive rack 15L.

In the present embodiment, the stepped gear 65R is interposed between the connecting rack 66 and the drive rack input gear 64R. The stepped gear 65R has a function to increase the amount of movement (movement speed) of the drive rack 15R relative to the amount of movement (moving speed) of the connecting rack 66.

As shown in FIG. 35B, the stepped gear 65R (second stepped gear) includes the large-diameter gear 651R (second large-diameter gear) and the small-diameter gear 652R (second small-diameter gear) smaller in pitch radius than the large-diameter gear 651R. The large-diameter gear 651R is in mesh with the drive rack input gear 64R, and is connected to the rack portion 83kR of the tray 80k via the drive rack input gear 64R, the drive rack 15R, and the pinion 94kR. In other words, the large-diameter gear 651R (second large-diameter gear) is drivably connected to the rack portion 83kR (second force receiving portion). The small-diameter gear 652R (second small-diameter gear) is in mesh with the second rack portion 661R of the connecting rack 66.

By transmitting the driving force from the connecting rack 66 to the drive rack 15R via the stepped gear 65R, the amount of movement of the drive rack 15R for the amount of movement W of the connecting rack 66 increases compared to when a spur gear is used instead of the stepped gear 65R. According to the pitch radius ratio of the stepped gear 65R, the amount of movement of the drive rack 15R increases for the amount of movement W of the connecting rack 66.

In other words, the stepped gear 65R can accelerate the movement of the connecting rack 66 and transmit the movement to the drive rack 15R.

The ratio (r3/r4) of the pitch radius r3 of the small-diameter gear 652R to the pitch radius r4 of the large-diameter gear 651R is referred to as the pitch radius ratio of the stepped gear 65R. To equalize the amounts of movement (moving speeds) of the rack portions 83kR, 83kL, it is advisable to satisfy the condition (Pitch radius of the large-diameter gear 651L)/(Pitch radius of the small-diameter gear 652L)×(Pitch radius of the small-diameter gear 652R)/(Pitch radius of the large-diameter gear 651R)=1. In other words, it is preferable that the ratio of the pitch radius of the first small-diameter gear to the pitch radius of the first large-diameter gear is equal to the ratio of the pitch radius of the second large-diameter gear to the pitch radius of the second small-diameter gear. For example, the pitch radii of the large-diameter gears 651R, 651L of the right and left stepped gears 65R, 65L are set so as to be equal to each other, and the pitch radii of the small-diameter gears 652R, 652L are set so as to be equal to each other. As a result, the pitch radius ratio of the stepped gear 65L can be made equal to the pitch radius ratio of the stepped gear 65R, and the amounts of movement (moving speeds) of the rack portions 83kR, 83kL can be made equal to each other. Then, in addition to the advantages of downsizing achieved by using the above-described stepped gear 65L, it is possible to realize a more stable movement of the tray 80k.

In the present embodiment, the amount of movement of the rack portion 83kL and the amount of movement of the drive rack 15L are almost equal to each other, and the amount of movement of the rack portion 83kR and the amount of movement of the drive rack 15R are almost equal to each other. On the other hand, the amount of movement W of the connecting rack 66 is less than the amounts of movement of the rack portion 83kL and the drive rack 15L and the amounts of movement of the rack portion 83kR and the drive rack 15R. Therefore, it is possible to reduce the amount of movement W of the connecting rack 66 compared to the amounts of movement of the tray 80k and the drive rack 15R during the ejection or insertion operation of the tray 80k. Therefore, it is possible to move the tray 80k by the desired amount of movement and achieve downsizing in the width direction (Y direction) of the apparatus body 1A.

### Lock Mechanism of Rotary

When the tray 80 is moved to attach or detach the toner cartridge 70, the pinion 94 is preferably positioned such that the pinion 94 (driven unit) of the rotary body 90 and the drive rack 15 (drive member) of the apparatus body 1A are reliably engaged with each other. The pinion 94 is preferably accurately positioned at a position where the pinion 94 can appropriately mesh with the corresponding drive rack 15 (hereinafter, referred to as meshing position).

One of the factors for the pinion 94 to be misaligned from its meshing position is the variation in the position of the rotary body 90 in a yellow/magenta/cyan/black replacement posture.

When the drive rack 15 meshes with the pinion 94, the gear tooth surface of the pinion 94 receives force from the gear tooth surface of the drive rack 15. If the rotary body 90 rotates around the rotation axis 90C due to this force, the pinion 94 may be misaligned from its meshing position. In a state where the tray 80 is at the eject position, when the user touches the rotary body 90 to rotate the rotary body 90, the pinion 94 may move from the meshing position.

Therefore, in the present embodiment, a lock mechanism 90L is provided to restrict (lock) the rotation of the rotary body 90 in a state where the rotary body 90 is in the replacement posture. The lock mechanism 90L switches between a locked state where the rotation of the rotary body 90 is restricted and an unlocked state where the rotation of the rotary body 90 is allowed. The lock mechanism 90L is configured to take the locked state when the rotary body 90 takes any one of the yellow, magenta, cyan, and black replacement postures. The lock mechanism 90L of the present embodiment switches between the locked state and the unlocked state in conjunction with the ejection or insertion operation of the tray 80.

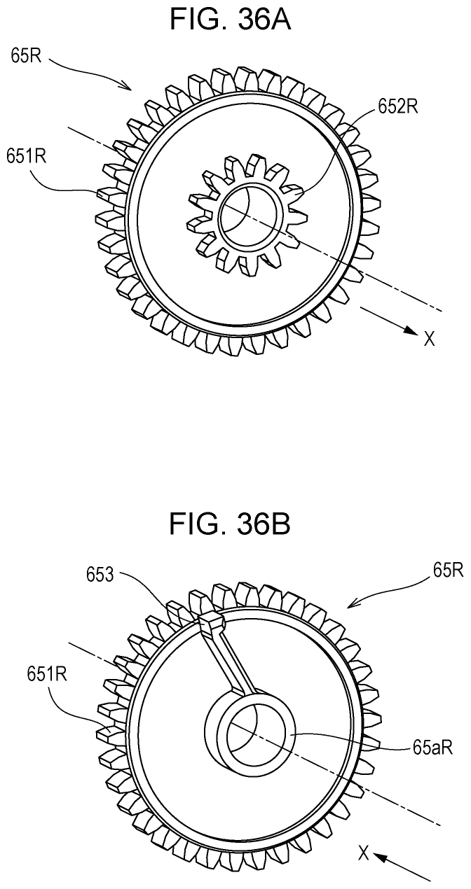

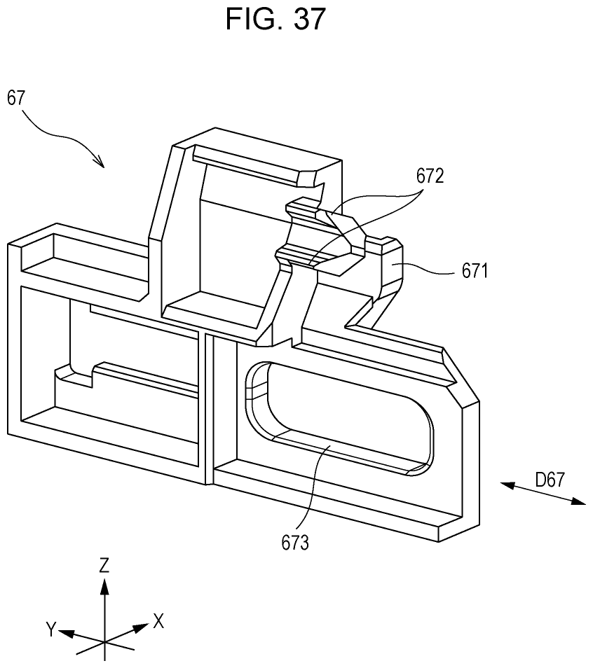

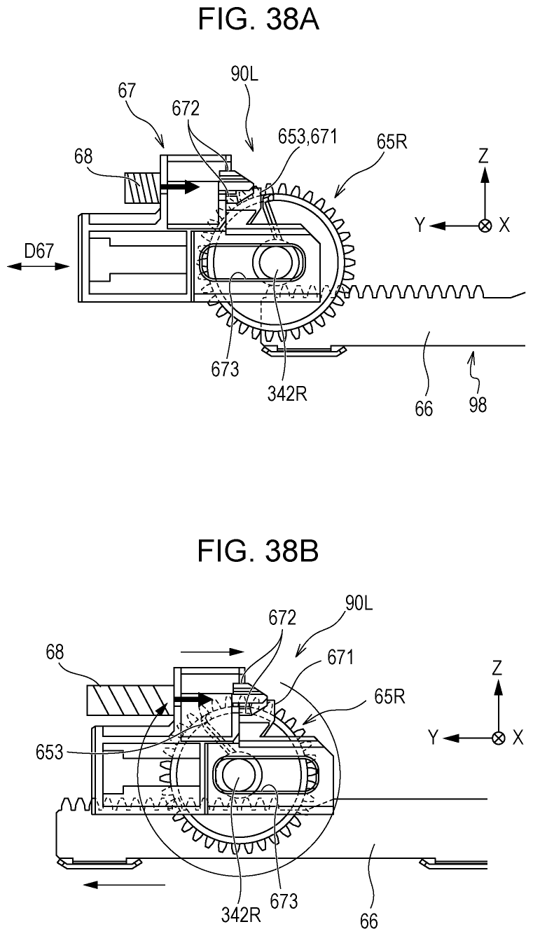

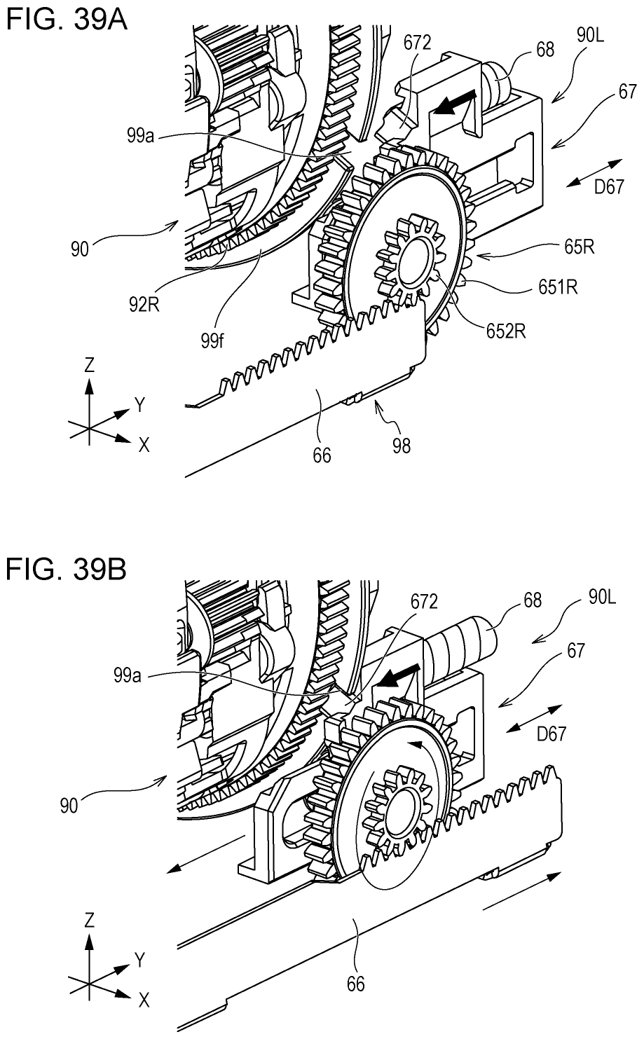

The lock mechanism 90L of the rotary body 90 will be described with reference to FIGS. 36A, 36B, 37, 38A, 38B, 39A, and 39B. FIGS. 36A and 36B are perspective views of the stepped gear 65R. FIG. 37 is a view showing the lock member 67. FIGS. 38A and 38B are views illustrating the configuration of the lock mechanism 90L. FIGS. 39A and 39B are perspective views showing the configuration of the lock mechanism 90L.

As shown in FIGS. 36A, 36B, 37, 38A, 38B, 39A, and 39B, the lock mechanism 90L includes a pressing portion 653 provided on the stepped gear 65R, the lock member 67, an urging member 68, and an engaged portion 99a provided in the rotary body 90.

As shown in FIG. 36B, the pressing portion 653 is formed on the large-diameter gear 651R of the stepped gear 65R. As will be described later, the pressing portion 653 has a function to move the lock member 67 in conjunction with the ejection or insertion operation of the tray 80. The stepped gear 65R is a part of the above-described drive device 98. Therefore, the lock member 67 can move in conjunction with the operation of the drive device 98 when the toner cartridge 70 is moved. In other words, the lock member 67 is moved by the driving force of the motor M2.

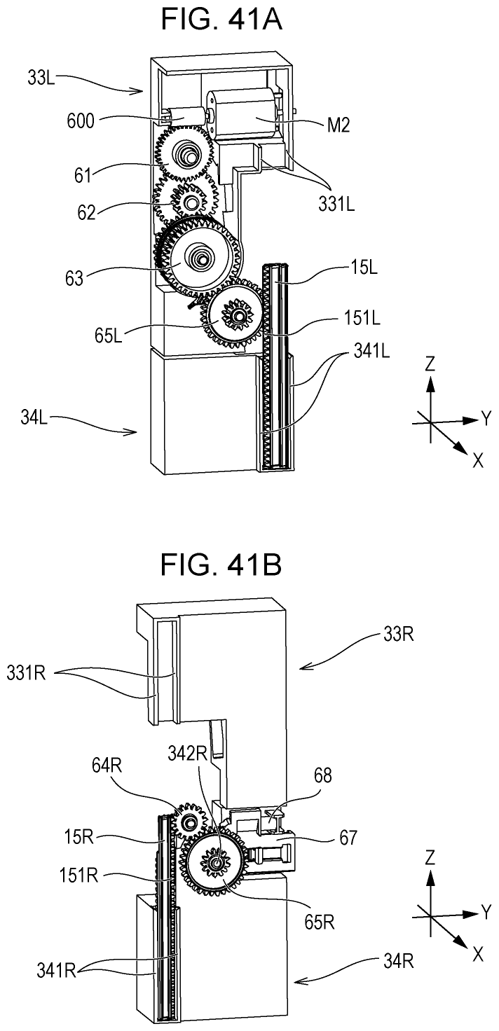

The pressing portion 653 is a protruding portion provided at a predetermined position in the rotation direction of the stepped gear 65R and extending radially outward from a boss portion 65aR of the stepped gear 65R. The boss portion 65aR is fitted to a support shaft 342R of a lower holding member 34R (FIG. 41B) (described later), with the result that the stepped gear 65R is rotatably supported by the lower holding member 34R.

The pressing portion 653 may be integrally formed with the large-diameter gear 651R and the small-diameter gear 652R of the stepped gear 65R by methods such as injection molding. Thus, it is possible to impart multiple functions to the stepped gear 65R that is a single gear. The multiple functions include the function to link the drive device 98 with the lock mechanism 90L, and the function to accelerate the movement of the connecting rack 66 and transmit the movement to the drive rack 15R. In the present embodiment, the pressing portion 653 is provided on one-side (−X-side) side surface of the large-diameter gear 651R in the rotation axis direction of the stepped gear 65R, and the small-diameter gear 652R is provided on the other-side (+X-side) side surface of the large-diameter gear 651R. In the state viewed in the rotation axis direction of the stepped gear 65R, some teeth of the small-diameter gear 652R overlap the pressing portion 653.

As shown in FIG. 37, the lock member 67 has a pressed portion 671 pressed by the pressing portion 653 of the stepped gear 65R, and an engagement portion 672 that can engage with the engaged portion 99a of the rotary body 90. The lock member 67 is movably supported by the frame 16 of the apparatus body 1A. The lock member 67 of the present embodiment is capable of reciprocating in a moving direction D67 along the Y direction that is the moving direction of the connecting rack 66. The engagement portion 672 has a protruded shape that protrudes in one direction (+Y direction) of the moving direction D67.

The lock member 67 is movable between an engaged position (lock position) in which the engagement portion 672 is engaged with the engaged portion 99a of the rotary body 90 and a disconnected position (unlock position) in which the engagement portion 672 is disconnected from the engaged portion 99a of the rotary body 90. The lock member 67 is supported so as to be slidable by the lower holding member 34R (FIG. 41B) (described later).

The lock member 67 is configured to move in conjunction with the drive rack 15 (drive member) as will be described below. The lock member of the present embodiment is connected to the connecting rack 66 (rack member) serving as a transmitting unit that transmits force to actuate the right and left drive racks 15R, 15L (second drive member, first drive member), and operates in conjunction with the drive racks 15R, 15L via the connecting rack 66. The lock member 67 may be configured to operate in conjunction with the transmitting unit (right and left connecting configuration) described in a second embodiment and later.

The lock member 67 has an elongated hole 673 formed in the moving direction D67. When the elongated hole 673 is engaged with the support shaft 342R of the lower holding member 34R (FIG. 41B), the lock member 67 is guided to move in the moving direction D67 relative to the lower holding member 34R. In other words, the support shaft 342R that holds the stepped gear 65R also functions as a guide portion that guides the lock member 67.

As shown in FIG. 39A, the urging member 68 urges the lock member 67 toward any one side of the moving direction D67. The urging member 68 of the present embodiment urges the lock member 67 in a direction from the unlock position toward the lock position (in the −Y direction). The urging member 68 is a compression spring disposed between, for example, a spring receiving surface of the lock member 67 and a spring receiving surface provided on the frame 16 of the apparatus body 1A.

As shown in FIG. 39A, the rotary body 90 includes a number (four in the present embodiment) of the engaged portions 99a, corresponding to the number of the trays 80. The engaged portions 99a of the present embodiment are formed in a flange portion 99f provided at the end of the rotary body 90 in the rotation axis direction (Y direction) of the rotary body 90. The flange portion 99f projects outward from a disk gear 92R (see also FIG. 5) in the radial direction (the radial direction of the rotary body 90) with respect to the rotation axis 90C. The engaged portion 99a has a recessed shape where part of the outer edge of the flange portion 99f is recessed radially inward.

The engaged portions 99a are provided at positions in the rotation direction of the rotary body 90. The positions correspond to the replacement postures that the rotary body 90 can take. In the present embodiment, four engaged portions 99a (99ay, 99am, 99ac, 99ak) respectively corresponding to the yellow, magenta, cyan, and black replacement postures are disposed at equal intervals of 90 degrees in the rotation direction (see FIGS. 41A and 41B). When the rotary body 90 is viewed in the rotation axis direction of the rotary body 90 in a state where the rotary body 90 is in any one of the replacement postures, one of the engaged portions 99a overlaps the engagement portion 672 of the lock member 67.

When the engagement portion 672 of the lock member 67 engages with the engaged portion 99a of the rotary body 90, the rotation of the rotary body 90 is restricted. The state of the lock mechanism 90L when the engagement portion 672 of the lock member 67 is engaged with any one of the engaged portions 99a of the rotary body 90 is referred to as a locked state. The state of the lock mechanism 90L when the engagement portion 672 of the lock member 67 is disconnected from all the engaged portions 99a of the rotary body 90 is referred to as an unlocked state. The locked state is a state where the lock mechanism 90L restricts the rotation of the rotary body 90 around the rotation axis 90C, and the unlocked state is a state where the lock mechanism 90L allows the rotation of the rotary body 90 around the rotation axis 90C. In the locked state, the lock mechanism 90L restricts the rotation of the rotary body 90 around the rotation axis 90C in the first direction and in the second direction opposite to the first direction.

The operation of the lock mechanism 90L to switch from the unlocked state to the locked state is referred to as locking operation, and the operation of the lock mechanism 90L to switch from the locked state to the unlocked state is referred to as unlocking operation. The locking operation and the unlocking operation are performed in conjunction with the ejection and insertion operations of the tray 80.

FIGS. 38A and 39A show the lock mechanism 90L in the unlocked state.

FIGS. 38B and 39B show the lock mechanism 90L in the locked state. Hereinafter, the operation of the lock mechanism 90L will be described in detail.

As described earlier, when the tray 80 is at the storage position, the rotary body 90 is rotatable. In other words, the engagement portion 672 of the lock member 67 is disconnected from the engaged portion 99a of the rotary body 90, and the lock mechanism 90L is in the unlocked state (FIGS. 38A and 39A). During the process in which the tray 80 moves from the storage position to the eject position, the engagement portion 672 of the lock member 67 engages with the engaged portion 99a of the rotary body 90. In other words, during the process of the tray ejection operation, the lock mechanism 90L switches from the unlocked state to the locked state (FIGS. 38B and 39B).

As shown in FIG. 38A, when the rotary body 90 is in any one of the yellow, magenta, cyan, and black replacement postures and the tray 80 is at the storage position, the lock member 67 is held at the disconnected position by the pressing portion 653 of the stepped gear 65R. In other words, the pressing portion 653 of the stepped gear 65R contacts with the pressed portion 671 of the lock member 67 to prevent the lock member 67 from moving in the urging direction of the urging member 68 (−Y direction). At this time, as shown in FIG. 39A, the engagement portion 672 of the lock member 67 is placed at a position away from the engaged portion 99a of the rotary body 90 in the +Y direction.

In this way, when the rotary body 90 is in any one of the yellow, magenta, cyan, and black replacement postures and the toner cartridge 70 corresponding to the posture of the rotary body 90 is at the mounting position, the lock mechanism 90L is maintained in the unlocked state.

Next, the case where the tray 80 is moved from the storage position to the eject position (when the tray ejection operation is performed) will be described. When the tray 80 is moved from the storage position toward the eject position, the connecting rack 66 moves to the left side in the drawing (to the right side of the apparatus body 1A, in the +Y direction) as shown in FIG. 38B. The stepped gear 65R rotates clockwise in the drawing under the driving force from the connecting rack 66. Then, the pressing portion 653 of the stepped gear 65R rotates to move in the direction to retract from the pressed portion 671 of the lock member 67 (to the left side of the apparatus body 1A, in the −Y direction). As the pressing portion 653 rotates to move, the lock member 67 moves to the right side in the drawing (in the −Y direction) due to the urging force of the urging member 68, and, as shown in FIG. 39B, the engagement portion 672 of the lock member 67 engages with the engaged portion 99a of the rotary body 90. In other words, when the pressing portion 653 retracts from the lock member 67, the lock member 67 is moved from the disconnected position (unlock position) to the engaged position (lock position).

In this way, in a state where the rotary body 90 is in any one of the yellow, magenta, cyan, and black replacement postures, when the corresponding toner cartridge 70 is moved from the mounting position to the retreat position, the lock mechanism 90L switches from the unlocked state to the locked state.

After the engagement portion 672 engages with the engaged portion 99a, the pressing portion 653 of the stepped gear 65R separates from the pressed portion 671 of the lock member 67. The rotation angle of the stepped gear 65R during the period from the start to the end of the tray ejection operation is set to smaller than 360°, and the pressing portion 653, which is separated from the pressed portion 671 in the middle of the tray ejection operation, is configured not to collide with the pressed portion 671 until the end of the tray ejection operation.

As shown in FIG. 39B, when the rotary body 90 is in any one of the yellow, magenta, cyan, and black replacement postures and the tray 80 is at the eject position, the lock member 67 is held at the engaged position by the urging force of the urging member 68. In other words, when the rotary body 90 is in any one of the yellow, magenta, cyan, and black replacement postures and the corresponding toner cartridge 70 is at the retreat position, the lock mechanism 90L is maintained in the locked state.

The operation of each element of the lock mechanism 90L when the tray 80 is moved from the eject position to the storage position (when the tray insertion operation is performed) is reverse to when the tray 80 is moved from the storage position to the eject position. In other words, the connecting rack 66 moves to the right in FIG. 38B (to the left side of the apparatus body 1A, in the −Y direction). The stepped gear 65R rotates counterclockwise in the drawing under the driving force from the connecting rack 66. Then, the pressing portion 653 of the stepped gear 65R contacts with the pressed portion 671 of the lock member 67 to push in the lock member 67 in the direction (+Y direction) opposite to the urging direction of the urging member 68. As a result, the lock member 67 moves to the left side in the drawing (in the +Y direction) in FIG. 38A against the urging force of the urging member 68, and, as shown in FIG. 39A, the engagement portion 672 of the lock member 67 disconnects from the engaged portion 99a of the rotary body 90. In other words, when the pressing portion 653 presses the lock member 67, the lock member 67 is moved from the engaged position (lock position) to the disconnected position (unlock position).

In this way, in a state where the rotary body 90 is in any one of the yellow, magenta, cyan, and black replacement postures, when the corresponding toner cartridge 70 is moved from the retreat position to the mounting position, the lock mechanism 90L switches from the locked state to the unlocked state.

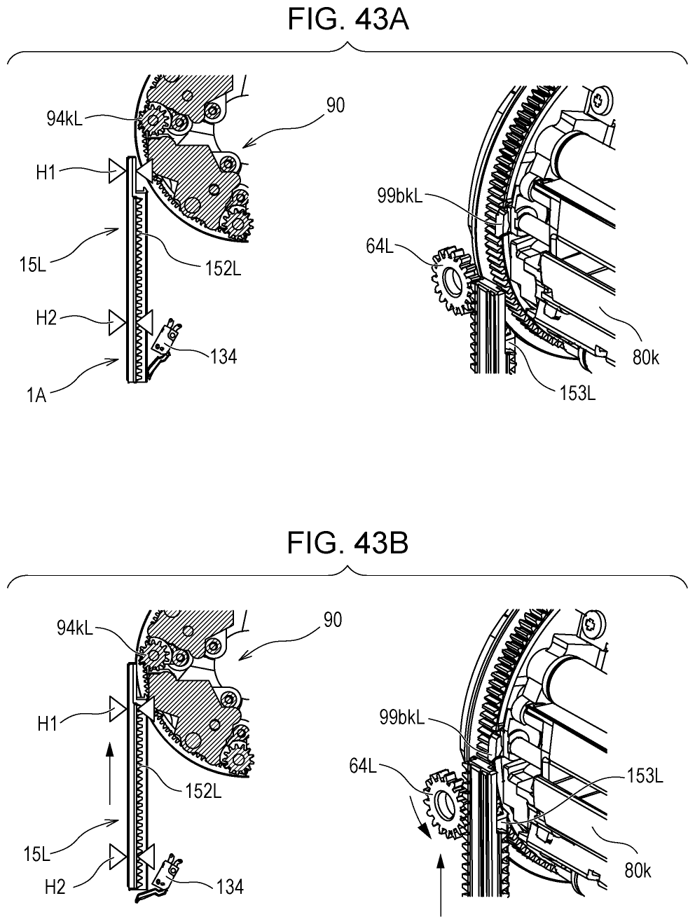

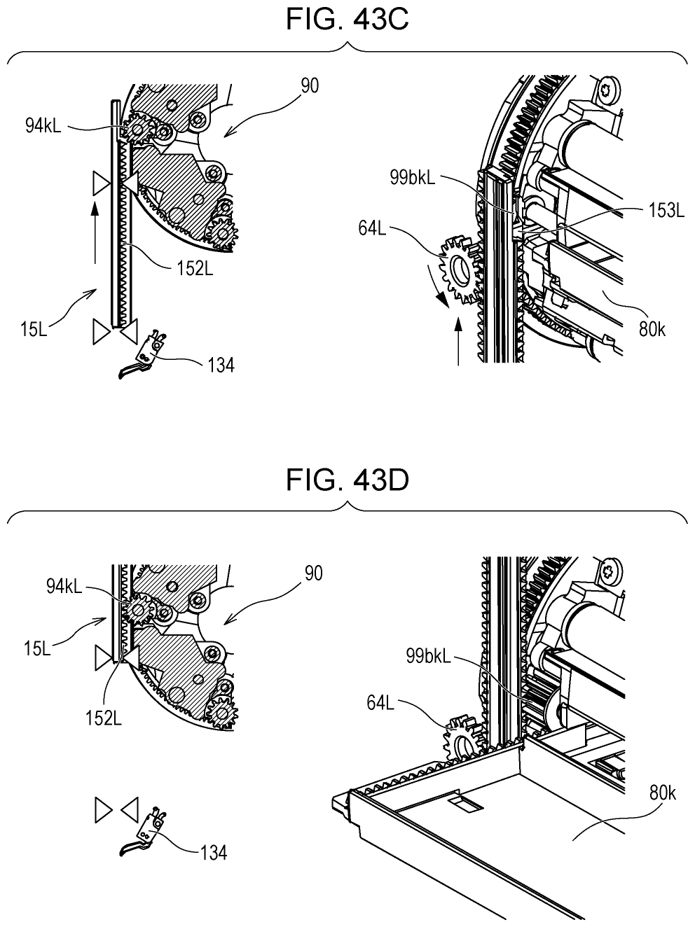

Here, as will be described later with reference to FIGS. 43A to 43D, when the tray ejection operation is performed, the drive rack 15 (drive member) is configured to start moving from a position away from the pinion 94 (lower position) toward the pinion 94. The lock mechanism 90L of the present embodiment is configured such that, during the process of the tray ejection operation, the lock mechanism 90L switches from the unlocked state to the locked state and then the drive rack 15 meshes with the pinion 94. In other words, the lock mechanism 90L switches from the unlocked state to the locked state after the drive rack 15 (drive member) starts moving from a position away from the pinion 94 (driven unit) toward the pinion 94 and before the drive rack 15 contacts with the pinion 94.

As a result, the drive rack 15 meshes with the pinion 94 in a state where the rotation of the rotary body 90 is restricted (in other words, a state where misalignment of the pinion 94 is suppressed). Thus, it is possible to achieve further reliable meshing of the drive rack 15 with the pinion 94.

The lock mechanism 90L of the present embodiment is configured to switch from the locked state to the unlocked state after the meshing of the drive rack 15 with the pinion 94 is released during the process in which the tray 80 moves from the eject position to the storage position. Thus, it is possible to reduce the possibility of misalignment in the rotation direction of the rotary body 90 due to the force received by the pinion 94 from the drive rack 15.

As described above, with the lock mechanism 90L of the rotary body 90, the rotary body 90 is locked in a replacement posture in a state where the tray 80 is at the eject position. Therefore, it is possible to suppress the occurrence of poor meshing between the pinion 94 and the drive rack 15 during the ejection/insertion operation of the tray 80.

### Modification of Lock Mechanism

In the present embodiment, the lock mechanism 90L is disposed only on one end side of the rotary body 90 in the rotation axis direction (Y direction) of the rotary body 90. Alternatively, lock mechanisms 90L similar to the lock mechanism 90L may be respectively disposed on both sides of the rotary body 90.

The shapes of the engagement portion 672 of the lock member 67 and the engaged portion 99a of the rotary body 90 are not limited to those described in the present embodiment, as long as engagement of the engagement portion 672 with the engaged portion 99a can restrict the rotation of the rotary body 90. For example, it is applicable that a protruded shape (engaged portion) provided on the rotary body 90 contacts with a flat contact surface (engagement portion) provided on the lock member 67 to restrict the rotation of the rotary body 90.

The lock member 67 may be connected to members other than the connecting rack 66. The lock member 67 is desirably connected to any of the elements of the drive device 98 provided in the apparatus body 1A within the drive system for moving the toner cartridge 70. For example, the lock member 67 may be moved in conjunction with the drive rack 15 by adding a rack portion to the lock member 67 and connecting the lock member 67 to the drive rack 15 via a pinion.

In the present embodiment, the configuration that the drive device 98 (transmission device) for moving the toner cartridge 70 between the mounting position and the retreat position mechanically operates in conjunction with the lock mechanism 90L has been illustrated. Not limited to this configuration, a lock mechanism that does not mechanically operate in conjunction with the drive device 98 (transmission device) and that switches between the locked state and the unlocked state based on an instruction from the control unit (FIG. 2) may be used. For example, a solenoid unit including a plunger that is movable between an engaged position to engage with the engaged portion 99a of the rotary body 90 and a disconnected position to disconnect from the engaged portion 99a may be used as the lock mechanism. In this case, the state of the solenoid unit when the plunger is at the engaged position is a locked state, and the state of the solenoid unit when the plunger is at the disconnected position is an unlocked state.

### Regulation of Gear Clearance Between Pinion and Drive Rack

Next, the configuration to suppress the variation in gear clearance between the pinion 94 and the drive rack 15 (hereinafter, which may be simply referred to as gear clearance) will be described. If there is variation in the gear clearance, the meshing between the drive rack 15 and the pinion 94 may become shallow, and in some cases, tooth skipping may occur. Therefore, it is desirable to suppress variation in the gear clearance.

The gear clearance between the pinion 94 and the drive rack 15 is the distance between the pitch circle of the pinion 94 and the pitch line of the rack portion of the drive rack 15 meshing with the pinion 94 when viewed in the rotation axis direction of the pinion 94. The pitch circle referred to here is a circle that is a reference for the shape of the gear (reference pitch circle). The pitch line referred to here is a straight line on a plane (reference plane) that is a reference for the shape of the rack.

When the pinion 94 and the drive rack 15 are in an ideal relative position, the pitch circle of the pinion 94 and the pitch line of the drive rack 15 are in contact at a single point (pitch point), and the gear clearance is “zero”. When the relative position of the pinion 94 or the drive rack 15 is misaligned, the value of the gear clearance mainly increases. In cases where misalignment of the relative position occurs, the rotary body 90 may rotate around the rotation axis 90C or pivot around the pivot shaft 91 (see FIG. 4A), or the drive rack 15 may move in a direction different from the sliding direction (Z direction) due to backlash (play). When the gear clearance is a relatively small value, the pinion 94 and the drive rack 15 can transmit power without any problem; however, when the gear clearance exceeds an allowable range and becomes too large, the stability of power transmission may be impaired.

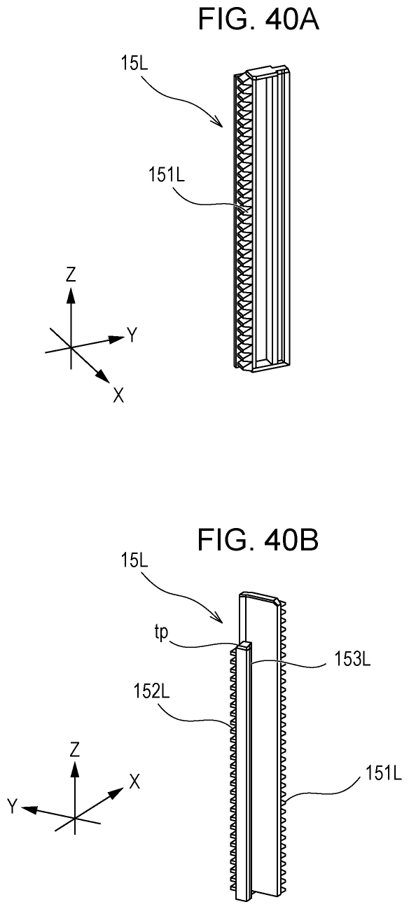

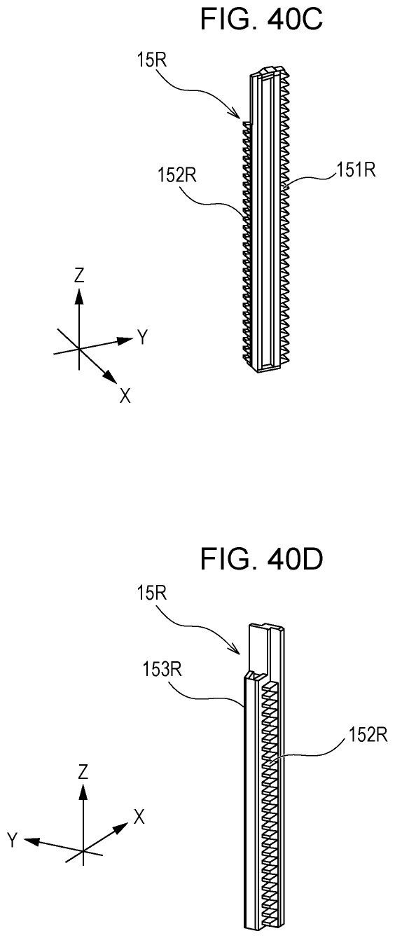

The configuration for regulating the gear clearance will be described with reference to FIGS. 40A to 40D, 41A, 41B, 42A, 42B, 43A to 43D, and 44.

FIGS. 40A and 40B are perspective views of the drive rack 15L. FIGS. 40C and 40D are perspective views of the drive rack 15R.

As shown in FIGS. 40A and 40B, the drive rack 15L has an input rack portion 151L, an output rack portion 152L, and an engagement portion 153L. The input rack portion 151L has a rack shape for meshing with the drive rack input gear 64L to receive (input) the driving force from the motor M2. The output rack portion 152L has a rack shape for meshing with any one of the pinions 94 (94yL to 94kL) to transmit (output) the driving force from the motor M2 to the pinion 94. The input rack portion 151L and the output rack portion 152L each are formed such that a plurality of teeth is arranged in the Z direction that is the sliding direction of the drive rack 15L. When viewed in the Z direction, the protruding direction of the teeth of the input rack portion 151L and the protruding direction of the teeth of the output rack portion 152L are perpendicular. The engagement portion 153L will be described later.

As shown in FIGS. 40C and 40D, the drive rack 15R, as in the case of the drive rack 15L, has an input rack portion 151R, an output rack portion 152R, and an engagement portion 153R. The input rack portion 151R has a rack shape for meshing with the drive rack input gear 64R to receive (input) the driving force from the motor M2. The output rack portion 152R has a rack shape for meshing with any one of the pinions 94 (94yR to 94kR) to transmit (output) the driving force from the motor M2 to the pinion 94. The input rack portion 151R and the output rack portion 152R each are formed such that a plurality of teeth is arranged in the Z direction that is the sliding direction of the drive rack 15R. When viewed in the Z direction, the protruding direction of the teeth of the input rack portion 151R and the protruding direction of the teeth of the output rack portion 152R are perpendicular. The engagement portion 153R will be described later.

The output rack portions 152R, 152L are examples of a force transmitting portion configured to transmit the driving force by engaging with the pinion 94 serving as the driven unit. The engagement portions 153R, 153L have a function to restrict the relative movement (movement relative to each other) of the drive racks 15R, 15L (drive members) and the rotary body 90 (rotary) such that the output rack portions 152R, 152L (force transmitting portions) separate from the pinions 94 (driven units).

The driven units of the present embodiment include the pinion 94 (94yL to 94kL) serving as a first force receiving portion provided at one end of the rotary body 90 in the rotation axis direction of the rotary body 90, and the pinion 94 (94yR to 94kR) serving as a second force receiving portion provided at the other end of the rotary body. The drive members of the present embodiment include the drive rack 15L serving as a first force application member that engages with the first force receiving portion, and the drive rack 15R serving as a second force application member that engages with the second force receiving portion. The output rack portion 152R (force transmitting portion) and the engagement portion 153R are provided in the drive rack 15R. The output rack portion 152L (force transmitting portion) and the engagement portion 153L are provided in the drive rack 15L.

FIGS. 41A and 41B are views showing the holding configurations of the drive racks 15R, 15L. FIG. 41A shows the holding configuration of the drive rack 15L. FIG. 41B shows the holding configuration of the drive rack 15R.

As shown in FIGS. 41A and 41B, the drive rack 15L is held so as to be slidable by the lower holding member 34L and an upper holding member 33L provided in the apparatus body 1A. The drive rack 15R is held so as to be slidable by the lower holding member 34R and an upper holding member 33R provided in the apparatus body 1A. The lower holding members 34R, 34L and the upper holding members 33R, 33L are members fixed to the frame 16 of the apparatus body 1A.

More specifically, as shown in FIG. 41A, the drive rack 15L is supported so as to be slidable in the up and down direction (Z direction) of the apparatus body 1A by a lower guide portion 341L of the lower holding member 34L. When the drive rack 15L moves from the position in FIG. 41A upward (+Z direction) of the apparatus body 1A, the drive rack 15L is supported so as to be slidable by an upper guide portion 331L of the upper holding member 33L.

The lower guide portion 341L and the upper guide portion 331L of the present embodiment have a groove shape formed in the sliding direction of the drive rack 15L. The width of the groove shape in the direction (here, the Y direction) that crosses the sliding direction of the drive rack 15L corresponds to the width of the drive rack 15L. Therefore, it is possible to suppress the misalignment of the drive rack 15R in the direction that crosses the sliding direction. The upper holding member 33L supports the motor M2 and also supports the stepped gears 61, 62, the idle gear 63, and the stepped gear 65L such that they are rotatable.

As shown in FIG. 41B, the drive rack 15R is supported so as to be slidable in the up and down direction (Z direction) of the apparatus body 1A by a lower guide portion 341R of the lower holding member 34R. When the drive rack 15R moves from the position in FIG. 41B upward (+Z direction) of the apparatus body 1A, the drive rack 15R is supported so as to be slidable by an upper guide portion 331R of the upper holding member 33R.

The lower guide portion 341R and the upper guide portion 331R of the present embodiment have a groove shape formed in the sliding direction of the drive rack 15R. The width of the groove shape in the direction (here, the Y direction) that crosses the sliding direction of the drive rack 15R corresponds to the width of the drive rack 15R. Therefore, it is possible to suppress the misalignment of the drive rack 15R in the direction that crosses the sliding direction. The lower holding member 34R supports the stepped gear 65R and the drive rack input gear 64R such that they are rotatable, and also supports the lock member 67 such that the lock member 67 is slidable in the right and left direction (Y direction) of the apparatus body 1A.

In the present embodiment, the upper holding member 33L supports the motor M2 and a plurality of gears together with the drive rack 15L; however, the motor M2 and the like may be supported by another member. The lower holding member 34R supports the stepped gear 65R, the drive rack input gear 64R, and the lock member 67; however, the stepped gear 65R, the drive rack input gear 64R, and the lock member 67 may be supported by another member.

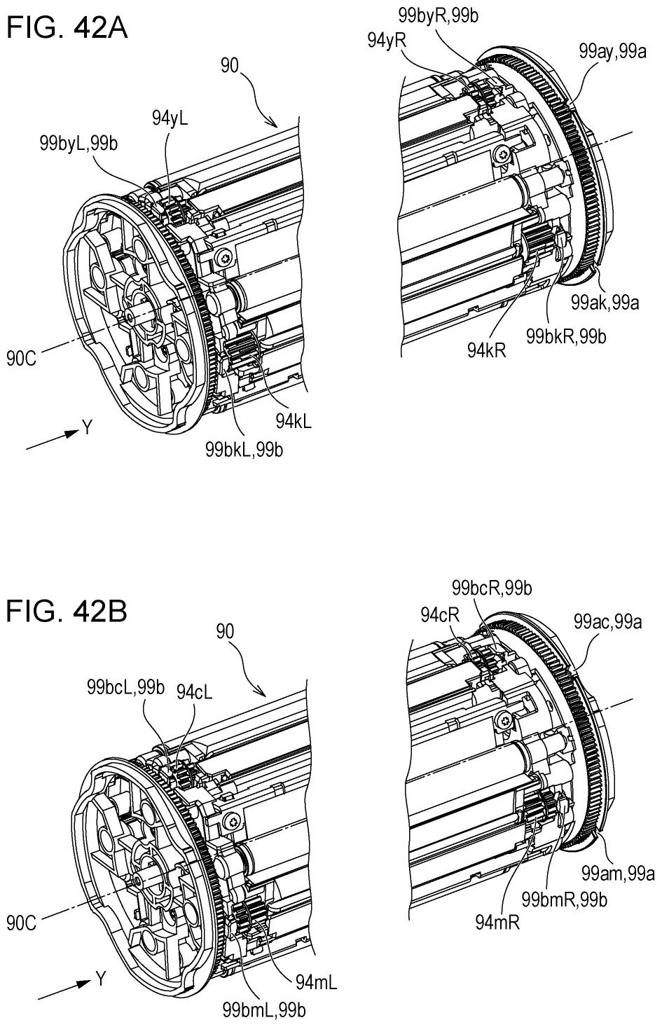

FIGS. 42A and 42B are perspective views of the rotary body 90. FIG. 42B shows a state where the rotary body 90 of FIG. 42A is rotated 180° around the rotation axis 90C.

The center area of the rotary body 90 in the Y direction is not shown in FIGS. 42A and 42B.

As shown in FIGS. 42A and 42B, an engaged portion 99b is provided one by one near each of the pinions 94 of the rotary body 90. In other words, the rotary body 90 includes an engaged portion 99byL corresponding to the pinion 94yL, an engaged portion 99bmL corresponding to the pinion 94mL, an engaged portion 99bcL corresponding to the pinion 94cL, and an engaged portion 99bkL corresponding to the pinion 94kL. The rotary body 90 includes an engaged portion 99byR corresponding to the pinion 94yR, an engaged portion 99bmR corresponding to the pinion 94mR, an engaged portion 99bcR corresponding to the pinion 94cR, and an engaged portion 99bkR corresponding to the pinion 94kR. The left-side four engaged portions 99byL to 99bkL are disposed at intervals of 90° around the rotation axis 90C, and the right-side four engaged portions 99byR to 99bkR are disposed at intervals of 90° around the rotation axis 90C.

Each of the left-side engaged portions 99byL to 99bkL is an example of a first engaged portion engaged with the engagement portion 153L of the drive rack 15L serving as the first force application member. Each of the right-side engaged portions 99byR to 99bkR is an example of a second engaged portion that engages with the engagement portion 153R of the drive rack 15R serving as the second force application member.

FIGS. 43A to 43D are views illustrating the configuration related to the regulation of the gear clearance. The left-side view of each of FIGS. 43A to 43D is a cross section orthogonal to the rotation axis C of the rotary body 90. The right-side view of each of FIGS. 43A to 43D is a perspective view of the left side of the rotary body 90. In the right-side view (perspective view) of each of FIGS. 43A to 43C, the pinion 94kL is not shown.

Hereinafter, the operation of the drive rack 15 and the pinion 94k in the tray ejection operation of the tray 80k will be described. Here, the operation of the drive rack 15 and each of the pinions 94y to 94c in the tray ejection operation of a corresponding one of the trays 80y to 80c is substantially similar to the operation of the drive rack 15 and the pinion 94k, so the description is omitted. The following description will be performed by using the drive rack 15L and the pinion 94kL disposed at the left side of the apparatus body 1A. The operation of the drive rack 15R and the pinion 94kR disposed at the right side of the apparatus body 1A is substantially similar to the operation of the drive rack 15L and the pinion 94kL, so the description is omitted.

The lower-side (−Z-side) end position of the apparatus body 1A in the range in which the drive rack 15L is slidable is referred to as the lower position of the drive 15L. The upper-side (+Z-side) end position of the apparatus body 1A in the range in which the drive rack 15L is slidable is referred to as the upper position of the drive rack 15L. During the process in which the drive rack 15L moves from the lower position toward the upper position, the position of the drive rack 15L when the output rack portion 152L of the drive rack 15L first contacts with the teeth of the pinion 94k is referred to as a meshing start position. During the process in which the drive rack 15L moves from the lower position to the upper position, the position of the drive rack 15L when the engagement portion 153L of the drive rack 15L starts engaging with the engaged portion 99bkL of the rotary body 90 is referred to as an engagement start position.

FIG. 43A shows the state of the drive rack 15L in a case where the tray 80k is at the storage position. In this case, the drive rack 15L is at the lower position. The output rack portion 152L is not in mesh with the pinion 94kL. In other words, the lower position of the drive rack 15L is a position (disengaged position) at which the output rack portion 152L (force transmitting portion) of the drive rack 15L is away from the pinion 94kL (driven unit). The engagement portion 153L of the drive rack 15L is not engaged with the engaged portion 99bkL of the rotary body 90.

When the drive rack 15L is at the lower position, the drive rack 15L is positioned in the front and rear direction (X direction) of the apparatus body 1A at two locations, that is, a support portion H1 (first support portion) and a support portion H2 (second support portion). In other words, the support portions H1, H2 restrict the movement of the drive rack 15L (drive member) in a direction to separate from the rotary body 90 (rotary). The support portions H1, H2 are provided on the frame 16 of the apparatus body 1A (main body frame) to support the drive rack 15L (drive member). The support portions H1, H2 are disposed at positions spaced apart from each other in the moving direction of the drive rack 15L. Because the movement of the drive rack 15L in the front and rear direction (X direction) of the apparatus body 1A is restricted at least at two locations spaced apart in the up and down direction, the tilting of the drive rack 15L is also suppressed.

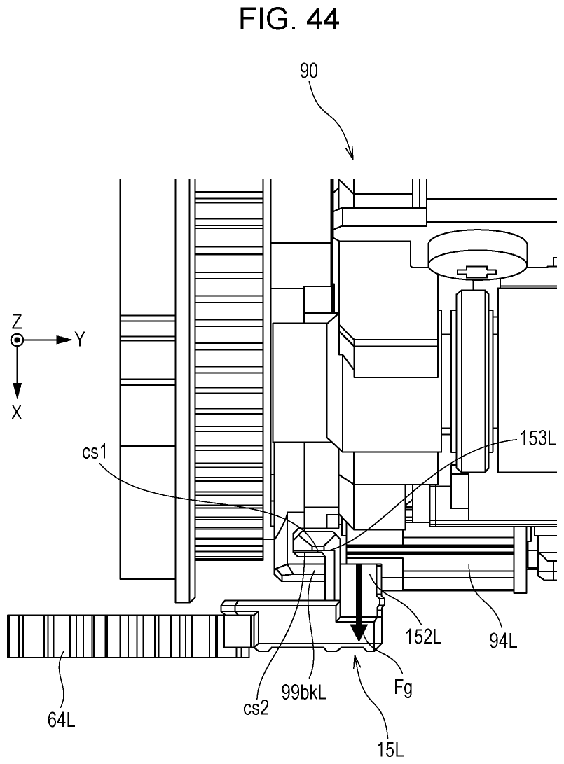

In the present embodiment, the support portions H1, H2 are provided on the lower guide portion 341L of the lower holding member 34L (FIG. 43A). Alternatively, the support portions H1, H2 may be provided on another member. The support portions H1, H2, as in the case of the engaged portion 99bkL (FIG. 44), have a shape (hook shape) that engages with the engagement portion 153L of the drive rack 15L.

Subsequently, when the tray ejection operation is started, the drive rack 15L moves upward (in the +Z direction) of the apparatus body 1A. Then, in the state shown in FIG. 43B, the rotation of the rotary body 90 is restricted by the lock mechanism 90L. At this time, the output rack portion 152L of the drive rack 15L has not yet meshed with the pinion 94kL. The drive rack 15L is positioned in the front and rear direction (X direction) of the apparatus body 1A at two locations, that is, the support portions H1, H2.

As the tray ejection operation progresses further, the drive rack 15L reaches the engagement start position at which the engagement portion 153L of the drive rack 15L engages with the engaged portion 99bkL of the rotary body 90 as shown in FIG. 43C. After that, the meshing of the output rack portion 152L of the drive rack 15L with the pinion 94kL starts.

In other words, by the time the output rack portion 152L meshes with the pinion 94kL, the engagement portion 153L of the drive rack 15L is engaged with the engaged portion 99bkL of the rotary body 90. In other words, the drive rack 15L (drive member) moves from the lower position (disengaged position) at which the output rack portion 152L (force transmitting portion) is away from the pinion 94kL (driven unit), in the direction in which the output rack portion 152L approaches the pinion 94kL. Then, after the drive rack 15L starts moving from the lower position, the engagement portion 153L engages with the rotary body 90 (rotary) before the output rack portion 152L engages with the pinion 94kL.

FIG. 44 is a view of the configuration related to the regulation of the gear clearance between the pinion 94kL and the drive rack 15L when viewed from the upper side (−Z side) of the apparatus body 1A. As shown in FIG. 44, when the output rack portion 152L meshes with the pinion 94kL, the tooth surface of the output rack portion 152L receives the force Fg including the component in the direction of the arrow in the drawing (+X direction, the direction in which the gear tooth surfaces move away from each other) from the tooth surface of the pinion 94kL. In other words, when viewed in the sliding direction of the drive rack 15L, the drive rack 15L receives the force including the component in the direction (+X direction) to move away from the rotation axis of the pinion 94kL.

Here, as shown in FIG. 44, the engagement portion 153L of the drive rack 15L has a contact surface cs1 (first surface) facing in the direction away from the rotation axis of the pinion 94kL (+X direction). The engaged portion 99bkL of the rotary body 90 has a contacted surface cs2 (second surface) configured to face in the −X direction when the rotary body 90 is in the black replacement posture. As a result, when the engagement portion 153L engages with the engaged portion 99bkL, the drive rack 15L is restricted from moving in the +X direction relative to the rotary body 90. When the engagement portion 153L engages with the engaged portion 99bkL, the rotary body 90 is restricted from moving in the −X direction relative to the drive rack 15L.

In other words, in the orthogonal direction (X direction) orthogonal to both the moving direction (Z direction) of the drive rack 15L and the rotation axis direction (Y direction) of the pinion 94kL, the drive rack 15L is disposed on the first side (+X side) relative to the pinion 94kL. The contact surface cs1 (first surface) of the engagement portion 153L is facing the first side (+X side) in the orthogonal direction. The contacted surface cs2 (second surface) of the engaged portion 99bkL is facing the second side (−X side) opposite to the first side in the orthogonal direction. Therefore, when the contact surface cs1 contacts with the contacted surface cs2, the relative movement between the drive rack 15L and the pinion 94kL to cause the drive rack 15L to move away from the rotation axis of the pinion 94kL in the orthogonal direction is restricted.

In the present embodiment, the engagement portion 153L extends in the moving direction (Z direction) of the drive rack 15L. When viewed in the moving direction (Z direction) of the drive rack 15L, the engagement portion 153L protrudes toward the pinion 94kL side (−X side, second side) and has a hook shape such that the tip of the −X side is bent. As long as the shape can restrict the relative movement between the drive rack 15L and the rotary body 90, the engagement portion 153L may have a shape other than a hook shape.

In this way, when the engagement portion 153L of the drive rack 15L engages with the engaged portion 99bkL of the rotary body 90, the relative movement of the drive rack 15L and the rotary body 90, which causes the tooth surfaces of the output rack portion 152L and the pinion 94kL to move apart from each other, is suppressed. Therefore, it is possible to suppress variation in gear clearance between the pinion 94kL and the drive rack 15L.

Incidentally, the tooth surface of the pinion 94kL receives force from the tooth surface of the output rack portion 152L of the drive rack 15L. Due to this force, a moment in the clockwise direction in the drawing acts on the rotary body 90, as shown on the left side of FIG. 43C. However, since the rotation of the rotary body 90 is restricted by the above-described lock mechanism 90L, the rotary body 90 can maintain the black replacement posture. The rotation of the rotary body 90 can suppress the movement of the pinion 94kL away from the drive rack 15L.

FIG. 43D shows the state of the drive rack 15L in a state where the tray 80k is at the eject position (a state after completion of the tray ejection operation). At this time, the drive rack 15L is at the upper position. The engagement of the engagement portion 153L of the drive rack 15L with the engaged portion 99bkL of the rotary body 90 is maintained. In other words, during the period from when the drive rack 15L passes through the engagement start position (FIG. 43C) to when the tray 80k reaches the eject position (FIG. 43D), the engagement of the engagement portion 153L of the drive rack 15L with the engaged portion 99bkL of the rotary body 90 is maintained. As described earlier, the drive rack 15L starts engaging with the engaged portion 99bkL at the engagement start position and then starts meshing with the pinion 94kL at the meshing start position.

Therefore, in the present embodiment, the engagement of the engagement portion 153L of the drive rack 15L with the engaged portion 99bkL of the rotary body 90 is maintained throughout the entire period of time during which the output rack portion 152L of the drive rack 15L is in mesh with the pinion 94kL in the tray ejection operation. It is possible to further suppress variation in gear clearance between the pinion 94kL and the drive rack 15L.

Here, if not only the support portions H1, H2 but also the engaged portion 99bkL of the rotary body 90 engages with the engagement portion 153L of the drive rack 15L, the drive rack 15L is positioned in the front and rear direction (X direction) of the apparatus body 1A at three locations that are spaced apart from each other in the up and down direction. However, when the support portions H1, H2 and the engagement portion 153L are not arranged on the same straight line due to the influence of tolerances of components, interference of the drive rack 15L with the support portions H1, H2 and the engagement portion 153L may occur. When the interference occurs, the load on the motor M2 for driving the drive rack 15L increases, so the stability of the operation of the drive rack 15L may be impaired.

In the present embodiment, the lower end of the drive rack 15L is configured to pass through the lower-side support portion H2 before the drive rack 15L reaches the engagement start position with the engaged portion 99bkL (FIG. 43C). In other words, after the drive rack 15L starts moving from the lower position (disengaged position), the drive rack 15L preferably disconnects from any one of the first support portion (H1) and the second support portion (H2) before the engagement portion 153L engages with the rotary body 90. As a result, the interference is less likely to occur, with the result that it is possible to further stably operate the drive rack 15L. The timing at which the lower end of the drive rack 15L passes through the lower-side support portion H2 may be just before the drive rack 15L reaches the engagement start position with the engaged portion 99bkL.

A tapered or other guiding portion (entry guide) can be provided at at least one of the upper end of the engagement portion 153L of the drive rack 15L and the entrance-side end (lower end in the posture of FIG. 42A) of the engaged portion 99bkL. In the present embodiment, a tapered guiding portion tp is provided at the upper end of the engagement portion 153L (FIG. 40B). The guiding portion tp adjusts the position of the engagement portion 153L when viewed in the up and down direction according to the engaged portion 99bkL so that the engagement portion 153L can engage with the engaged portion 99bkL without a collision of the upper end of the engagement portion 153L with the engaged portion 99bkL. By the time the lower end of the drive rack 15L passes through the lower-side support portion H2, the guiding portion tp has preferably entered the engaged portion 99bkL (the tip of the guiding portion tp can be above the lower end of the engaged portion 99bkL).

The engagement of the engagement portion 153L of the drive rack 15L with the engaged portion 99bkL of the rotary body 90 restricts the pivot of the rotary body 90 around the pivot shaft 91 (rotary support portion, FIG. 4A) that pivotably supports the rotary body 90. As a result, it is possible to suppress fluctuations in gear clearance between the output rack portion 152L and the pinion 94kL due to the pivot of the rotary body 90.

In the above description, the benefits of suppressing variation in gear clearance in the operation to move the tray 80k from the storage position to the eject position (tray ejection operation) have been described. However, there are similar benefits also in the operation to move the tray 80k from the eject position to the storage position (tray insertion operation). In other words, according to the present embodiment, it is possible to suppress variation in gear clearance between the drive rack 15L and the pinion 94kL during the ejection/insertion operation of the tray 80k, so a further stable operation is achieved.

Automatic Insertion Function when Tray Pushing Action Is Detected

When the tray 80k is at the eject position, a user is able to instruct the image forming apparatus 1 to perform the tray insertion operation by operating the operating unit (for example, buttons on the operating panel) of the apparatus body 1A. However, with the configuration that the tray 80k at the eject position is automatically pulled in to the storage position when the user pushes the tray 80k in, further intuitive operation is possible, so the operability improves.

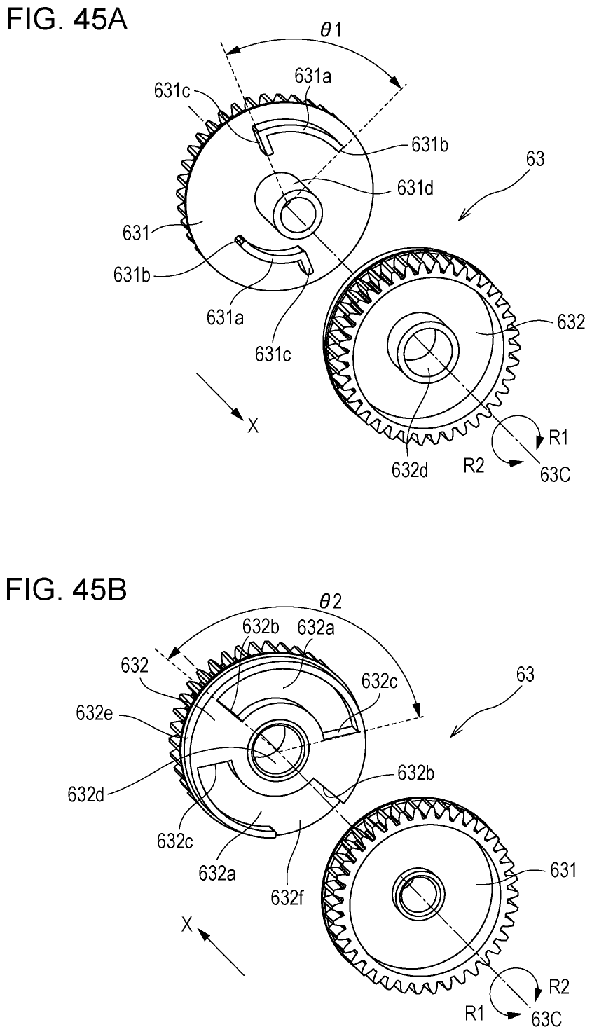

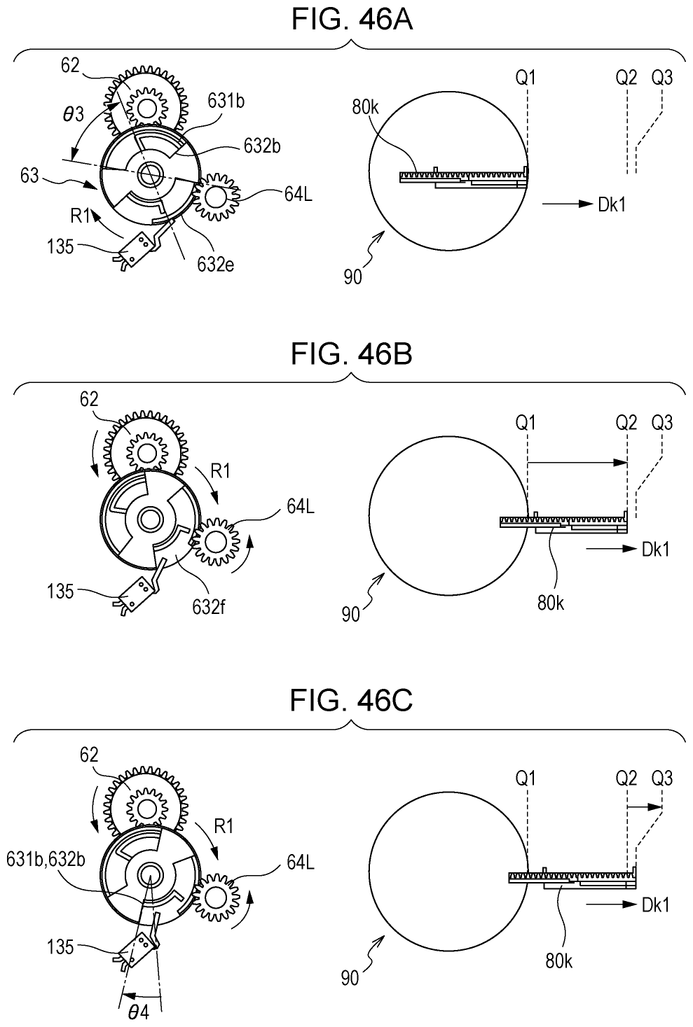

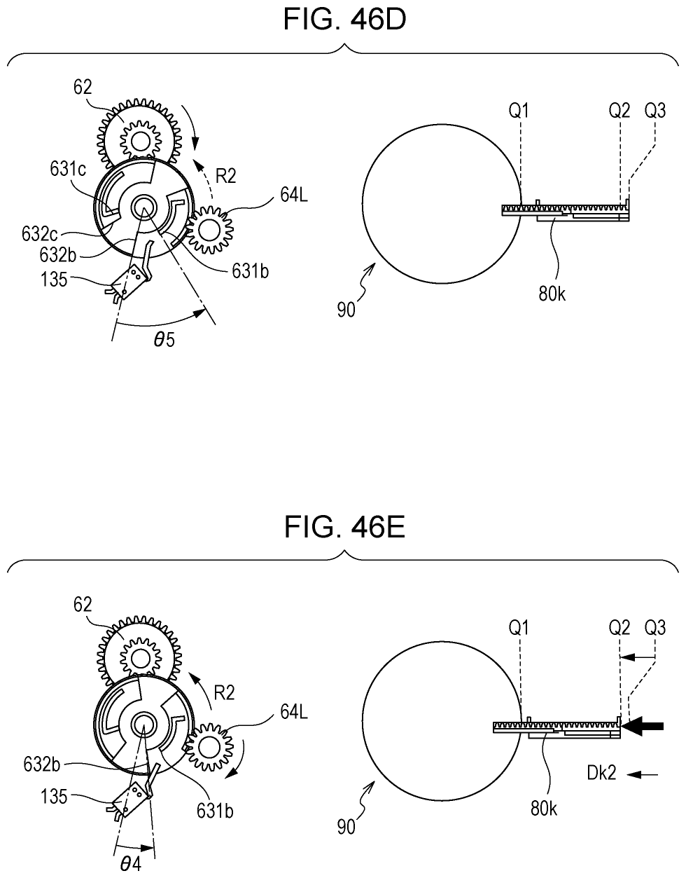

Hereinafter, the function (automatic tray insertion function) to automatically start tray insertion operation by detecting that the user pushes the tray 80k in will be described with reference to FIGS. 45A, 45B, and 46A to 46E. “Automatically” means that the control unit determines to execute the tray insertion operation in a state where the user has not explicitly provided an instruction to execute the tray insertion operation through the operating unit or the like. In the following description, the push-in detection configuration and the automatic insertion function for the tray 80k will be described; however, the image forming apparatus 1 also has substantially the same push-in detection configuration and automatic insertion function for the trays 80y to 80c.

To enable the control unit to detect that the user pushes the tray 80k in, it is sufficient to provide a configuration that detects the movement of the tray 80k itself or the movement of a component that operates in conjunction with the tray 80k. In the present embodiment, as will be described below in detail, a sensor (tray eject sensor 135) that detects the rotation of the idle gear 63 serving as a member that operates in conjunction with the tray 80k is provided. The tray eject sensor 135 is an example of a detector configured such that a signal changes when the tray 80k (support member) supporting the toner cartridge 70k (cartridge) is moved from the eject position (second position) toward the storage position (first position). The signal output from the tray eject sensor 135 varies between a state where the tray 80k is at the eject position and a state where the tray 80k is at the storage position. The signal output from the tray eject sensor 135 varies between a state where the toner cartridge 70k (cartridge) is at the mounting position and a state where the toner cartridge 70k (cartridge) is at the retreat position.

Incidentally, as described earlier, the drive system 1000 of the tray 80k includes the motor M2 that is the drive source, and the drive transmission mechanism 101 that transmits the driving force of the motor M2 to the tray 80k (FIGS. 34A and 34B). The drive transmission mechanism 101 includes the worm gear 600 and the stepped gears 61, 62, 65R, 65L as a speed reduction mechanism that can reduce and transmit the rotation speed (angular velocity) of the output shaft of the motor M2 to downstream drive transmission elements. With the speed reduction mechanism, the motor M2 with a small output power can be used to perform the tray insertion operation. In other words, with the speed reduction mechanism, a small-size motor can be used as the drive source, with the result that it is possible to achieve downsizing and cost reduction of the apparatus body 1A.

Here, when the user attempts to push the tray 80k in at the eject position, the user's pushing force is transmitted toward the upstream side (the motor M2 side) through the drive transmission elements of the drive transmission mechanism 101. If the motor M2 is configured to rotate in conjunction with the pushing-in of the tray 80k, pushing force needed to move the tray 80k increases due to the load to rotate the motor M2 in a stopped state. Particularly, in the case of the configuration that the force of the motor M2 is transmitted to the tray 80k through the speed reduction mechanism, the force for pushing the tray 80k in to rotate the motor M2 further increases. When the speed reduction mechanism includes a worm gear like the present embodiment, the worm gear self-locks even when the user attempts to push the tray 80k in, so the motor M2 cannot be reversed. In this case, the user cannot basically push the tray 80k in.

Therefore, in the present embodiment, the idle gear 63 is disposed in the drive transmission path from the worm gear 600 to the tray 80k, and the idle gear 63 is configured to rotate freely in conjunction with the pushing-in of the tray 80k. Due to the free rotation of the idle gear 63, the drive transmission element (stepped gear 62) does not operate in conjunction with the pushing-in of the tray 80k compared to the idle gear 63, so the user is able to push the tray 80k in with a light pushing force. Furthermore, in the present embodiment, the sensor (tray eject sensor 135) capable of detecting the rotation of the idle gear 63 serving as a transmission unit is used to detect pushing-in of the tray 80k and automatically execute the tray insertion operation.

Hereinafter, a push-in detection mechanism for detecting the pushing-in of the tray 80k will be described. FIGS. 45A and 45B are exploded views of the idle gear 63 according to the present embodiment. FIG. 45A is a perspective view of the idle gear 63 when viewed from one side in the direction along the rotation axis 63C of the idle gear 63. FIG. 45B is a perspective view of the idle gear 63 when viewed from the other side in the direction along the rotation axis 63C.

As shown in FIGS. 45A and 45B, the idle gear 63 is a gear unit including two gears, that is, an input gear 631 and an output gear 632. The input gear 631 and the output gear 632 are arranged in the direction of the rotation axis 63C. The input gear 631 and the output gear 632 each are rotatable around the rotation axis 63C.

The input gear 631 has a gear portion that meshes with the stepped gear 62 (FIG. 34A), and the driving force of the motor M2 is input to the input gear 631. In other words, the input gear 631 is drivably connected to the motor M2 via the stepped gear 62 and the like. The output gear 632 has a gear portion (tooth portion) that meshes with the drive rack input gear 64L and the stepped gear 65L (see FIG. 34A), and outputs driving force toward the tray 80k. In other words, the output gear 632 is configured to be drivably connected to the tray 80k via the drive rack input gear 64L, the stepped gear 65L, and the like.

The idle gear 63 is an example of a transmission unit configured to transmit the driving force of the motor M2 to the tray 80k. In the present embodiment, the idle gear 63 functions as a transmission unit capable of taking an interrupted state in which the transmission of force from the tray 80k to the motor M2 is interrupted. The input gear 631 is an example of an input portion of the transmission unit. The output gear 632 is an example of an output portion of the transmission unit.

Hereinafter, the rotation direction of the input gear 631 when the motor M2 rotates in the forward direction is referred to as the forward rotation direction R1 of the idle gear 63. The rotation direction of the input gear 631 when the motor M2 rotates in the reverse direction is referred to as the reverse rotation direction R2 of the idle gear 63.

As shown in FIG. 45A, the input gear 631 has a protrusion 631a. The protrusion 631a protrudes toward the output gear 632 in the direction along the rotation axis 63C.

A forward rotation contact portion 631b is provided at one end (the end in the forward rotation direction R1) of the protrusion 631a. A reverse rotation contact portion 631c is provided at the other end (the end in the reverse rotation direction R2) of the protrusion 631a. In the present embodiment, two protrusions 631a are disposed at positions 180° apart from each other around the rotation axis 63C.

As shown in FIG. 45B, a groove 632a is provided on the output gear 632. The groove 632a is a recess recessed from the input gear 631 side toward the output gear 632 in the direction along the rotation axis 63C. A forward rotation contacted portion 632b is provided at one end (the end in the forward rotation direction R1) of the groove 632a. A reverse rotation contacted portion 632c is formed at the other end (the end in the reverse rotation direction R2) of the groove 632a. In the present embodiment, two grooves 632a are provided at positions 180° apart from each other around the rotation axis 63C.

The output gear 632 has a substantially cylindrical (arc-shaped) outer peripheral surface 632e centered on the rotation axis 63C, and an outer peripheral recess 632f recessed toward the side closer to the rotation axis 63C relative to the outer peripheral surface 632e. The outer peripheral recess 632f is continuously connected to one of the grooves 632a.

The protrusion 631a of the input gear 631 is formed within the range of angle θ1 in the forward rotation direction R1. The groove 632a of the output gear 632 is formed within the range of angle θ2 in the forward rotation direction R1. The range in which the protrusion 631a is formed is narrower than the range in which the groove 632a is formed. In other words, θ1<θ2. In this present embodiment, two of each of the protrusion 631a and the groove 632a are provided. Alternatively, one of each of the protrusion 631a and the groove 632a may be provided or three or more of each may be provided.

A cylindrical shaft portion 631d is formed at the center of the input gear 631 (FIG. 45A). A hole 632d is formed at the center of the output gear 632 (FIG. 45B). When the shaft portion 631d of the input gear 631 engages with the hole 632d of the output gear 632, the input gear 631 and the output gear 632 are connected so as to be rotatable around the common rotation axis 63C and relatively rotatable. The input gear 631 is rotatably supported by fitting the shaft portion 631d into a support shaft provided on the upper holding member 33L (see FIG. 41A).

The protrusion 631a is accommodated within the space inside the groove 632a in a state where the input gear 631 and the output gear 632 are connected. At this time, since θ1<θ2, the protrusion 631a and the groove 632a allow the input gear 631 and the output gear 632 to rotate relative to each other within an angle of θ3=θ2−θ1. In other words, the input gear 631 and the output gear 632 can rotate (freely rotate) relative to each other within the range of angle θ3.

FIGS. 46A to 46E are views for illustrating the push-in detection mechanism for the tray 80k. The right-side views of FIGS. 46A to 46E show the positions of the tray 80k. The left-side views of FIGS. 46A to 46E are views showing the states of the idle gear 63 and the tray eject sensor 135, corresponding to the right-side views.

As shown in FIGS. 46A to 46E, the tray eject sensor 135 is disposed so that the tray eject sensor 135 can contact with the outer peripheral surface 632e of the output gear 632. The tray eject sensor 135 is configured to switch a detection signal between a state where the tray eject sensor 135 is in contact with the outer peripheral surface 632e of the output gear 632 and a state where the tray eject sensor 135 is not in contact with the outer peripheral surface 632e (that is, a state where the tray eject sensor 135 faces the outer peripheral recess 632f).

In other words, the tray eject sensor 135 can detect whether the output gear 632 is within a predetermined rotation range (the range in which the tray eject sensor 135 faces the outer peripheral recess 632f).

The output gear 632 is an example of a rotating member rotatable around the rotation axis. The signal output by the tray eject sensor 135 serving as the detector of the present embodiment changes according to the rotation of the output gear 632. In the present embodiment, the rotation angle of the output gear 632 (rotating member) during the period when the tray 80k (support member) moves from the storage position (first position) to the eject position (second position) is smaller than 360°. In other words, because the position of the tray 80k when the signal of the tray eject sensor 135 changes is uniquely determined, accurate control according to the position of the tray 80k can be achieved.

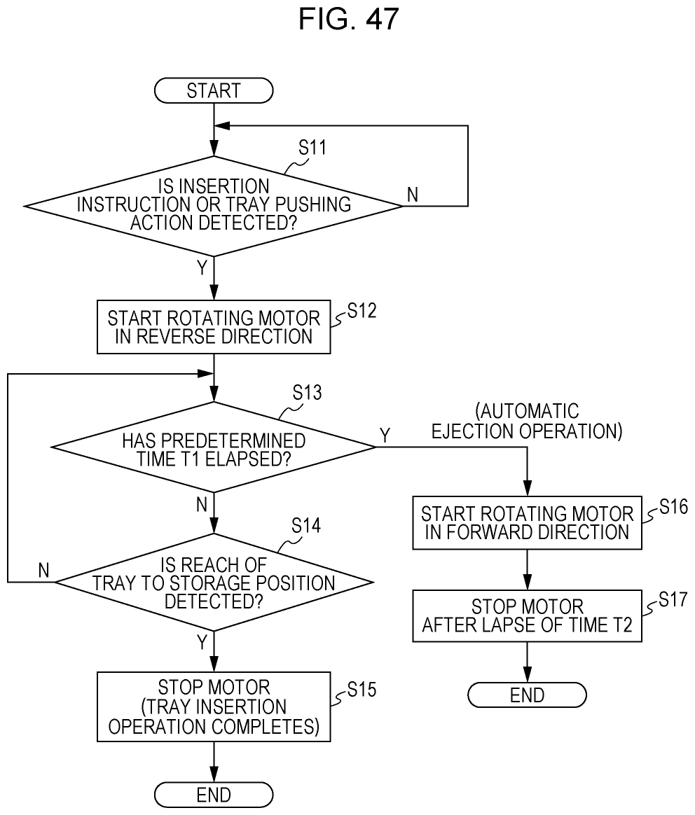

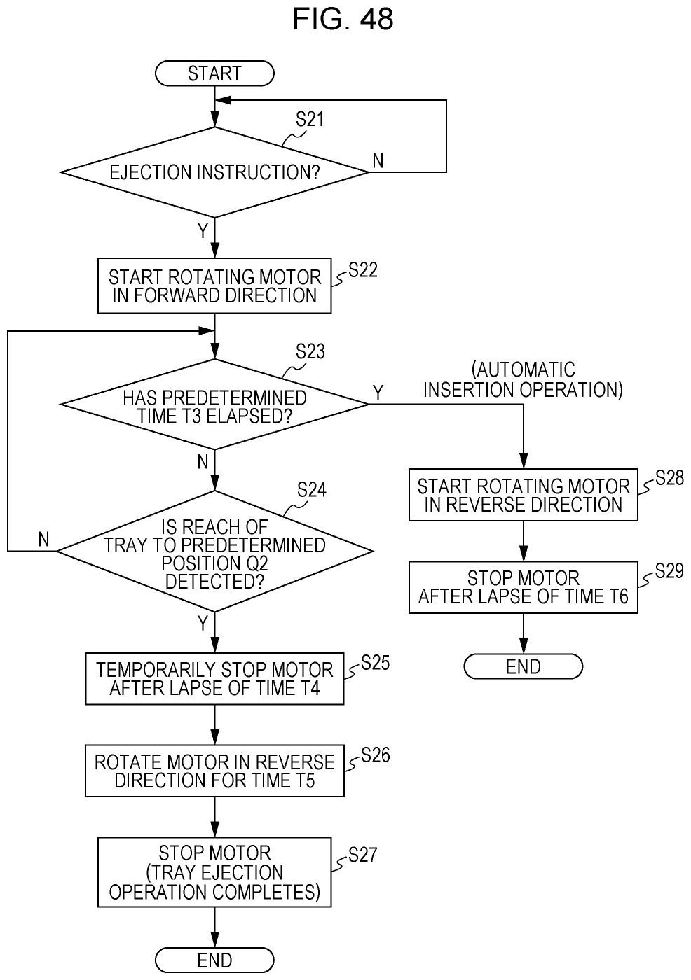

The operations from when the tray ejection operation for the tray 80k is performed to when the tray insertion operation is automatically performed as a result of user's pushing-in of the tray 80k will be described with reference to FIGS. 46A to 46E and the flowcharts of FIGS. 47 and 48.

FIG. 47 is a flowchart that shows the procedure by which the control unit (FIG. 2) executes the tray ejection operation. However, the process when an abnormality is detected during the tray insertion operation (Y in S13) will be described later. FIG. 48 is a flowchart that shows the procedure by which the control unit executes the tray ejection operation. However, the process when an abnormality is detected during the tray ejection operation (Y in S23) will be described later.

FIG. 46A shows the state of the idle gear 63 and the tray eject sensor 135 when the tray 80k is at the storage position Q1. At this time, the tray eject sensor 135 is in contact with the outer peripheral surface 632e of the output gear 632. FIGS. 46A to 46E show the positions of the tray 80k with reference to the tip of the tray 80k in the ejection direction Dk1.

When the user provides an instruction for the tray ejection operation by operating the buttons and the like on the control panel (S1 in FIG. 48), the control unit rotates the motor M2 in the forward rotation direction (S22 in FIG. 48). As a result, the driving force of the motor M2 is transmitted to the tray 80k, with the result that the tray 80k moves in the ejection direction Dk1. At this time, the input gear 631 of the idle gear 63 rotates in the forward rotation direction R1 under the driving force from the motor M2. The forward rotation contact portion 631b (first engagement portion) of the input gear 631 contacts with the forward rotation contacted portion 632b (first contacted portion) of the output gear 632, the driving force is transmitted from the input gear 631 to the output gear 632, and the output gear 632 also rotates in the forward rotation direction R1.

FIG. 46B shows the state of the idle gear 63 and the tray eject sensor 135 when the tray 80k is ejected to a predetermined position Q2 between the storage position and the eject position. When the tray 80k reaches the predetermined position Q2, the tray eject sensor 135 switches from a state where the tray eject sensor 135 faces the outer peripheral surface 632e of the output gear 632 to a state where the tray eject sensor 135 faces the outer peripheral recess 632f of the output gear 632. The control unit detects that the tray 80k has reached the predetermined position Q2 based on the change in the detection signal of the tray eject sensor 135 (Y in S24 in FIG. 48).

The control unit stops the motor M2 after the forward rotation of the motor M2 is continued for a predetermined time T4 even after the tray 80k has reached the predetermined position Q2 (S25 in FIG. 48). As a result, the tray 80k moves to the eject position Q3 as shown in FIG. 46C. At this time, the input gear 631 rotates clockwise in the drawing by an angle of θ4. In other words, the angle θ4 is the amount of rotation of the input gear 631 during the period when the tray 80k moves from the predetermined position Q2 to the eject position Q3.

FIG. 46C shows the state of the idle gear 63 and the tray eject sensor 135 when the tray 80k is ejected to the eject position Q3. In this state, the forward rotation contact portion 631b of the input gear 631 is in contact with the forward rotation contacted portion 632b of the output gear 632. The tray eject sensor 135 is in the state of facing the outer peripheral recess 632f of the output gear 632.

In a state where the tray 80k is ejected to the eject position Q3, the control unit rotates the motor M2 in the reverse direction for a predetermined time T5 (S26 in FIG. 48), and then the motor M2 is stopped (S27).

As shown in FIG. 46D, the input gear 631 rotates in the reverse rotation direction R2 under the driving force from the motor M2 due to the reverse rotation of the motor M2. As a result, the forward rotation contact portion 631b of the input gear 631 separates from the forward rotation contacted portion 632b of the output gear 632. In other words, after the tray 80k (support member) has moved from the storage position (first position) to the eject position (second position), when the motor M2 (drive source) rotates in the reverse direction R2 (the second direction opposite to the first direction), the engagement between the forward rotation contact portion 631b (first engagement portion) and the forward rotation contacted portion 632b (first engaged portion) is released.

The angle by which the input gear 631 rotates in the reverse rotation direction R2 during the period when the motor M2 reverses for a period of time T5 is denoted as θ5. The angle θ5 is smaller than the angle θ3 by which the input gear 631 and the output gear 632 can freely rotate (θ5>θ3). Therefore, the reverse rotation contact portion 631c of the input gear 631 does not contact with the reverse rotation contacted portion 632c of the output gear 632 while the motor M2 reverses. In other words, the driving force of the motor M2 is not transmitted to the output gear 632, and the tray 80k does not move in the insertion direction Dk2 from the eject position Q3. Thus, the tray ejection operation from the storage position to the eject position of the tray 80k is completed.

FIG. 46D shows the state of the idle gear 63 and the tray eject sensor 135 when the tray ejection operation for the tray 80k completes. In this state, the forward rotation contact portion 631b of the input gear 631 is spaced apart from the forward rotation contacted portion 632b of the output gear 632. The reverse rotation contact portion 631c of the input gear 631 is also spaced apart from the reverse rotation contacted portion 632c of the output gear 632. The tray eject sensor 135 is in the state of facing the outer peripheral recess 632f of the output gear 632.

Here, considering the case where the user pushes in the tray 80k in the insertion direction Dk2 as shown in FIG. 46E. In this case, the pushing force that the user pushes the tray 80k in is transmitted to the output gear 632 in the reverse direction along the drive transmission path from the motor M2 to the tray 80k. As a result, the output gear 632 rotates in the reverse rotation direction R2.

On the other hand, because of the reverse rotation of the motor M2 during the tray ejection operation, there is the above-described gap of angle θ5 between the forward rotation contact portion 631b and the forward rotation contacted portion 632b. Therefore, even when the output gear 632 rotates in the reverse rotation direction R2, the input gear 631 does not rotate in the reverse rotation direction R2. In other words, the input gear 631 and the drive transmission elements on the upstream side (motor M2 side) of the input gear 631 do not operate in conjunction with the pushing-in of the tray 80k. In other words, the idle gear 63 (transmission unit) is configured to be in an interrupted state where transmission of force from the tray 80k (support member) to the motor M2 (drive source) is interrupted after the tray 80k (support member) has moved from the storage position (first position) to the eject position (second position). Therefore, the user can push the tray 80k in with a light pushing force.

The angle by which the output gear 632 rotates during the period when the tray 80k is pushed in from the eject position Q3 to the predetermined position Q2 is denoted as θ4. The angle θ4 is preferably smaller than the angle θ5 of the gap present between the forward rotation contact portion 631b and the forward rotation contacted portion 632b at the completion of the tray ejection operation (θ4<θ5). The angle θ5 is the angle by which the output gear 632 can rotate in the reverse rotation direction R2 in a state where the input gear 631 is stopped. In other words, the angle (θ5) in which the output gear 632 (output portion) can rotate relative to the input gear 631 (input portion) in a state where the engagement of the forward rotation contact portion 631b (first engagement portion) with the forward rotation contacted portion 632b (first engaged portion) is released is larger than the angle (θ4) in which the output gear 632 rotates while the tray 80k (support member) is moved from the eject position Q3 (second position) to the predetermined position Q2. Therefore, where the relationship θ4<θ5 holds, the user is able to push the tray 80k in with a light pushing force until at least the tray 80k reaches the predetermined position Q2.

When the tray 80k is pushed in to the predetermined position Q2 as shown in FIG. 46E, the tray eject sensor 135 switches from a state where the tray eject sensor 135 faces the outer peripheral recess 632f of the output gear 632 to a state where the tray eject sensor 135 faces the outer peripheral surface 632e of the output gear 632. The control unit detects that the tray 80k has been pushed into the predetermined position Q2 based on the change in detection signal from the tray eject sensor 135 (Y in S11 in FIG. 47).

When the control unit detects the pushing-in of the tray 80k, the control unit rotates the motor M2 in the reverse direction and starts the tray insertion operation (S12 in FIG. 47). When the motor M2 is reversed, the input gear 631 rotates in the reverse rotation direction R2, and the reverse rotation contact portion 631c (second engagement portion) of the input gear 631 engages with the reverse rotation contacted portion 632c (second engaged portion) of the output gear 632. As a result, the output gear 632 rotates in the reverse rotation direction R2, and the tray 80k moves toward the storage position. Then, when the control unit detects that the tray 80k has reached the storage position Q1 (Y in S14), the control unit stops the motor M2 (S15) and completes the tray insertion operation.

As shown in FIG. 43A, a tray insertion sensor 134 capable of detecting that the tray 80k has reached the storage position is disposed in the apparatus body 1A. The tray insertion sensor 134 of the present embodiment is held by the lower holding member 34L.

The tray insertion sensor 134 is disposed so as to contact with the drive rack 15L when the tray 80k is at the storage position Q1. In other words, the tray insertion sensor 134 is configured to change the detection signal in accordance with whether the drive rack 15L is at the lower position.

The control unit can detect that the drive rack 15L has reached the lower position, that is, the tray 80k has reached the storage position Q1, based on the change in the detection signal of the tray insertion sensor 134. The tray insertion sensor 134 is an example of a detector configured such that a signal changes when the tray 80k (support member) supporting the toner cartridge 70k (cartridge) is moved from the eject position (second position) toward the storage position (first position). The signal output from the tray insertion sensor 134 varies between a state where the tray 80k is at the storage position Q1 and a state where the tray 80k is at the eject position Q3. The signal output from tray insertion sensor 134 varies between a state where the toner cartridge 70k (cartridge) is at the mounting position and a state where the toner cartridge 70k (cartridge) is at the retreat position.

As described above, the control unit is configured to automatically execute the tray insertion operation when the control unit detects that the tray 80k has been pushed in from the eject position Q3 to the predetermined position Q2. In other words, the control unit moves the tray 80k (support member) from the eject position (second position) toward the storage position (first position) in a state where the tray 80k is not being moved by the motor M2 (drive source), and, when the signal of the tray eject sensor 135 has changed, moves the tray 80k toward the storage position by the motor M2. Thus, more intuitive operation is possible, so it is possible to improve operability.

In the present embodiment, the idle gear 63 is disposed in the drive transmission mechanism 101 that transmits driving force from the motor M2 to the tray 80k, so the idle gear 63 is configured to rotate freely when the user pushes the tray 80k in the insertion direction Dk2. As a result, the user can push the tray 80k from the eject position Q3 to the predetermined position Q2 with a light pushing force, so it is possible to further improve operability.

### Modification of Push-in Detection Mechanism

In the present embodiment, the pushing-in of the tray 80k can be detected by detecting the rotation angle of the output gear 632 linked with the pushing-in of the tray 80k using the tray eject sensor 135. Not limited to this, a sensor that detects another member linked with the pushing-in of the tray 80k may be used to detect the pushing-in of the tray 80k. For example, a sensor capable of detecting that the connecting rack 66 is at a position corresponding to the eject position of the tray 80k may be used.

In this case, when the sensor has changed from a state of detecting the connecting rack 66 to a state of not detecting the connecting rack 66, the control unit determines that there has been the pushing-in of the tray 80k.

The sensor that detects the pushing-in of the tray 80k is not limited to a sensor that detects contact with a target member. For example, the sensor may be an optical sensor that detects a target member using light.

In the present embodiment, the tray eject sensor 135 is used as a detector of which the signal changes when the tray 80k moves from the eject position toward the storage position. Alternatively, a detector that detects that the tray 80k receives a force in the direction from the eject position toward the storage position may be used. For example, a force/torque sensor, such as a load cell, is used as the detector. In this case, the control unit just needs to reverse the motor M2 to execute the tray insertion operation based on the change in force/torque sensor signal when the user attempts to push the tray 80k in after the tray 80k has been ejected to the eject position and the motor M2 is not being driven.

In the present embodiment, an example in which the tray insertion operation is started due to the start of the motor M2 in a stopped state when the movement of the tray 80k is detected by the detector. Not limited to this, when the movement of the tray 80k is detected by the detector, the tray insertion operation may be started by connecting a clutch interposed between the motor M2 and the tray 80k in a state where the motor M2 is rotating.

### Automatic Ejection Function in Case of Tray Insertion Abnormality

If an abnormality occurs in the tray insertion operation, the tray 80 can possibly stop at a position (abnormal position) that is neither the storage position nor the eject position. An abnormality occurs when, for example, a foreign object is caught between the tray 80 and another member to hinder the movement of the tray 80 in the insertion direction Dk2.

At this time, it is desirable to perform restoration work to return the apparatus to a state where the tray insertion operation can be executed by eliminating the cause of the abnormality (such as removing a foreign object). However, in a state where the tray insertion operation is continuing, the user finds it difficult to perform restoration work. In a state where the tray 80 has stopped at an abnormal position, it is difficult for the user to determine what operation to perform next, which is not favorable for the operability of the user.

Therefore, in the present embodiment, the image forming apparatus 1 has a function (tray automatic ejection function) to automatically move the tray 80 to the eject position if an abnormality occurs while the tray 80 is moving from the eject position to the storage position (during the tray insertion operation).

Hereinafter, the contents of the process that is executed by the control unit (FIG. 2) when an abnormality is detected during the tray insertion operation will be described according to the flowchart of FIG. 47.

When the tray 80 is at the eject position, the user is able to provide an instruction to start the tray insertion operation with a method of operating the operating unit (for example, buttons on the operating panel) provided on the apparatus body 1A or the above-described method of pushing the tray 80 in. When the control unit detects a tray insertion operation instruction (insertion instruction) or pushing-in of the tray 80 (Y in S11), the control unit rotates the motor M2 in the reverse rotation direction (S12). As a result, the tray insertion operation is started, and the tray 80 starts moving from the eject position toward the storage position under the driving force of the motor M2.

As shown in FIGS. 43A to 43D, when the tray 80 moves from the eject position to the storage position, the drive rack 15 (15L) moves downward (−Z direction) of the apparatus body 1A.

When the drive rack 15 has moved to the lower position corresponding to the storage position of the tray 80 (the state shown in FIG. 43A), the tray insertion sensor 134 detects the drive rack 15. The control unit (FIG. 2) determines that the tray insertion operation is complete based on the fact that the tray insertion sensor 134 has detected the drive rack 15 (Y in S14), and stop the drive of the motor M2 to complete the tray insertion operation (S15).

Here, assuming that an abnormality has occurred in the tray insertion operation and the movement of the tray 80 is hindered. In this case, the drive rack 15 cannot move to the lower position, and the tray insertion sensor 134 does not detect the drive rack 15. In other words, the control unit determines that the tray insertion operation is not complete (N in S14).

In the present embodiment, when the tray insertion sensor 134 does not detect the drive rack 15 even after a predetermined time T1 has elapsed since the start of reverse rotation of the motor M2 (S12), the control unit determines that an abnormality has occurred in the tray insertion operation (Y in S13). The predetermined time T1 is, for example, a value obtained by adding a predetermined margin to a time needed from the start of reverse rotation of the motor M2 to when the tray insertion sensor 134 detects that the drive rack 15 reaches the lower position in a case where the tray insertion operation normally proceeds. The value of the predetermined time T1 is assumed to be stored in a storage section of the control unit in advance.

When the control unit determines that an abnormality has occurred in the tray insertion operation, the control unit temporarily stops the motor M2 and then rotates the motor M2 in the forward rotation direction (S16). As a result, the tray 80 starts moving from the abnormal position toward the eject position under the driving force of the motor M2. The control unit determines that the tray 80 has reached the eject position, for example, after a predetermined time T2 has elapsed from the start of forward rotation of the motor M2, stops the motor M2 (S17), and ends the automatic ejection operation. Instead of S17, the tray 80 may be configured to be moved to the eject position using the tray eject sensor 135 through control similar to the normal tray ejection operation (S24 to S27 in FIG. 48).

In this way, the control unit causes the motor M2 to start outputting a driving force in the reverse direction (second direction) in a state where the tray 80 is positioned at the eject position Q3 corresponding to the retreat position of the toner cartridge 70, to start the tray insertion operation. The control unit causes the motor M2 to output a driving force in the forward direction (first direction) when the tray 80 does not reach the storage position Q1 corresponding to the mounting position of the toner cartridge 70 after a lapse of the predetermined time T1 from the start of the drive of the motor M2.

In other words, when the cartridge does not reach the mounting position after a lapse of a predetermined time from when the control unit causes the drive source to output a driving force in the second direction in a state where the cartridge is positioned at the retreat position, the control unit causes the drive source to output a driving force in the first direction.

In other words, the control unit causes the drive device 98 to start the first operation in a state where the toner cartridge 70 (cartridge) is positioned at the retreat position and, when the toner cartridge 70 does not reach the mounting position after a lapse of the predetermined time, causes the drive device 98 to execute the second operation. The first operation is an operation in which the drive device 98 drives the moving device 85 such that the moving device 85 moves the toner cartridge 70 from the retreat position toward the mounting position. The second operation is an operation in which the drive device 98 drives the moving device 85 such that the moving device 85 moves the toner cartridge 70 from the mounting position toward the retreat position.

According to the above control, when an abnormality occurs in the tray insertion operation, the tray 80 temporarily stops at the abnormal position and is then automatically ejected to the eject position. Therefore, the user can perform restoration work, such as removal of foreign objects, in a state where the tray 80 is ejected to the eject position. In other words, according to the present embodiment, it is possible to improve the workability of the restoration work compared to when the tray 80 remains at an abnormal position.

According to the present embodiment, when an abnormality occurs in the tray insertion operation, the tray 80 returns to the eject position through the tray automatic ejection function. In other words, the control unit causes the drive source to start outputting a driving force in the first direction when the cartridge does not reach the mounting position after a lapse of the predetermined time, and then stops the drive source when the cartridge reaches the retreat position. As a result, the user can easily understand that the user performs restoration work and then performs the tray insertion operation again, so the user is less likely to hesitate in determining the next operation.

In the present embodiment, when the toner cartridge 70 is moved from the retreat position to the mounting position, part of the toner cartridge 70 moves from the outside to the inside of the frame 16 (main body frame) through the opening 16a of the apparatus body 1A. In this configuration, even when the toner cartridge 70 cannot pass through the opening 16a for some reasons, the toner cartridge 70 can be automatically ejected to the outside of the apparatus body 1A.

### Automatic Tray Insertion Function in Case of Tray Ejection Abnormality

If an abnormality occurs in the tray ejection operation, the tray 80 can possibly stop at a position (abnormal position) that is neither the storage position nor the eject position.

For example, there may be a case where an obstacle is present at a position overlapping the movement trajectory of the tray 80 (for example, near the opening 16a of the apparatus body 1A) in the tray ejection operation, and the movement of the tray 80 is restricted when the tray 80 (or the door 14) in move contacts with the obstacle. In this case, the tray 80 stops at the abnormal position. Because the tray 80 is stopped at the abnormal position (that is, not ejected to the eject position), the user cannot remove the toner cartridge 70 from the tray 80 or may be difficult to perform work. In a state where the tray 80 has stopped at an abnormal position, it is difficult for the user to determine what operation to perform next, which is not favorable for the operability of the user.

Therefore, in the present embodiment, the image forming apparatus 1 has a function (tray automatic insertion function) to automatically move the tray 80 to the storage position if an abnormality occurs while the tray 80 is moving from the storage position to the eject position (during the tray ejection operation). Hereinafter, the tray automatic insertion function will be described.

Hereinafter, the contents of the process that is executed by the control unit (FIG. 2) when an abnormality is detected during the tray ejection operation will be described according to the flowchart of FIG. 48.

When the tray 80 is at the storage position, a user is able to instruct the image forming apparatus 1 to start the tray ejection operation with a method of operating the operating unit (for example, buttons on the operating panel) provided on the apparatus body 1A. When the control unit receives a tray ejection operation instruction (ejection instruction) (Y in S21), the control unit starts the rotation of the motor M2 in the forward rotation direction (S22). As a result, the tray ejection operation is started, and the tray 80 starts moving from the storage position toward the eject position under the driving force of the motor M2.

As described above, the tray eject sensor 135 detects that the tray 80 has moved to the predetermined position Q2 (Y in S24, the state of FIG. 46B). The motor M2 is temporarily stopped when a predetermined time T4 has elapsed after the detection of the tray 80 by the tray eject sensor 135 (S25), then the motor M2 is reversed for a predetermined time T5 (S26), and the motor M2 is stopped (S27). As a result, the tray 80 moves to the eject position as described above. When the tray 80 is pushed in by the user, the idle gear 63 enters a state where the output gear 632 is in a freely rotatable state relative to the input gear 631 in conjunction with the tray 80.

Here, assuming that an abnormality has occurred in the tray ejection operation and the movement of the tray 80 is hindered. In this case, the tray eject sensor 135 does not detect that the tray 80 has reached the predetermined position Q2 (N in S24). In other words, the control unit determines that the tray ejection operation is not complete.

In the present embodiment, when the tray eject sensor 135 does not detect that the tray 80 has reached the predetermined position Q2 even after a predetermined time T3 has elapsed since the start of the tray ejection operation (S22), the control unit determines that an abnormality has occurred in the tray ejection operation (Y in S23). The predetermined time T3 is, for example, a value obtained by adding a predetermined margin to a time needed from the start of forward rotation of the motor M2 to when the tray eject sensor 135 detects the reach of the tray 80 to the predetermined position Q2 in a case where the tray ejection operation normally proceeds. The predetermined time T3 is assumed to be stored in a storage section of the control unit in advance.

When the control unit determines that an abnormality has occurred in the tray ejection operation, the control unit temporarily stops the motor M2 and then rotates the motor M2 in the reverse rotation direction (S28). As a result, the tray 80 starts moving from the abnormal position toward the storage position under the driving force of the motor M2. The control unit determines that the tray 80 has reached the storage position, for example, after a predetermined time T6 has elapsed from the start of reverse rotation of the motor M2, stops the motor M2 (S29), and ends the automatic insertion operation. Instead of S29, the tray 80 may be configured to be moved to the storage position by using the tray insertion sensor 134 through control similar to the normal tray insertion operation (S14 to S15 in FIG. 47).

In other words, the control unit causes the drive device 98 to start the second operation in a state where the toner cartridge 70 (cartridge) is positioned at the mounting position and, when the toner cartridge 70 does not reach the retreat position after a lapse of the predetermined time, causes the drive device 98 to execute the first operation. The first operation is an operation in which the drive device 98 drives the moving device 85 such that the moving device 85 moves the toner cartridge 70 from the retreat position toward the mounting position. The second operation is an operation in which the drive device 98 drives the moving device 85 such that the moving device 85 moves the toner cartridge 70 from the mounting position toward the retreat position.

In this way, the control unit causes the motor M2 to start outputting a driving force in the forward direction (first direction) in a state where the tray 80 is positioned at the storage position Q1 corresponding to the mounting position of the toner cartridge 70, to start the tray insertion operation. The control unit causes the motor M2 to output a driving force in the reverse rotation direction (second direction) when the tray 80 does not reach the eject position Q3 corresponding to the retreat position of the toner cartridge 70 after a lapse of the predetermined time T3 from the start of the drive of the motor M2.

In other words, when the cartridge does not reach the retreat position after a lapse of a predetermined time from when the control unit causes the drive source to output a driving force in the first direction in a state where the cartridge is positioned at the mounting position, the control unit causes the drive source to output a driving force in the second direction.

According to the above control, when an abnormality occurs in the tray ejection operation, the tray 80 temporarily stops at the abnormal position and is then automatically inserted to the storage position. As a result, the user can easily understand that the user performs restoration work or the like and then performs the tray ejection operation again, so the user is less likely to hesitate in determining the next operation.

According to the present embodiment, when an abnormality occurs in the tray ejection operation, the tray 80 returns to the storage position Q1 through the tray automatic insertion function. In other words, the control unit causes the drive source to start outputting a driving force in the second direction when the cartridge does not reach the retreat position after a lapse of the predetermined time, and then stops the drive source when the cartridge reaches the retreat position. As a result, the user can easily understand that the user performs restoration work and then performs the tray ejection operation again, so the user is less likely to hesitate in determining the next operation.

In the present embodiment, when the toner cartridge 70 is moved from the mounting position to the retreat position, part of the toner cartridge 70 moves from the inside to the outside of the frame 16 (main body frame) through the opening 16a of the apparatus body 1A. In this configuration, even when the toner cartridge 70 cannot pass through the opening 16a for some reasons, the toner cartridge 70 can be automatically pulled back to the inside of the apparatus body 1A.

As described above, when the tray 80 moves from the first position toward the second position in a state where the tray 80 at the first position supports an incorrect toner cartridge 70, the toner cartridge 70 can possibly contact with the frame 16. At this time, the movement of the tray 80 to the second position is restricted, so the tray 80 cannot reach the second position even after a lapse of a predetermined time. At this time, when the toner cartridge 70 does not reach the retreat position after a lapse of a predetermined time from when the control unit causes the drive device 98 to start the second operation, the control unit causes the drive device 98 to execute the first operation. In other words, the drive device 98 executes the first operation, the tray 80 moves toward the first position, and reaches the first position.

In other words, in the image forming apparatus in FIGS. 32A and 32B, when the first tray moves from the first position to the second position in a state where the first tray at the first position supports the second cartridge, the second protrusion contacts with the first frame. The second protrusion contacts with the first frame, and the first tray is restricted from reaching the second position. Then, when the control unit detects that a predetermined time has elapsed since the second protrusion contacted with the first frame, the control unit executes the first operation. As a result, the first tray moves toward the first position and reaches the first position. Similarly, the above-described description also similarly applies to the image forming apparatus in FIG. 25. In other words, when the first tray moves from the first position toward the second position in a state where the first tray supports the second cartridge, the second cartridge contacts with the rotary or the housing such that the movement of the first tray to the second position is restricted. When the control unit detects that a predetermined time has elapsed since the second cartridge contacted with the rotary or the housing, the control unit executes the first operation. As a result, the first tray moves toward the first position and reaches the first position. The above-described description also similarly applies in a state where the second tray supports the first cartridge.

### Incorrect Mounting Suppression Using Colors

The image forming apparatus 1 in the present embodiment has an incorrect mounting suppression configuration using colors. Hereinafter, the description related to colors uses the Munsell color system (100 hues).

In other words, colors are classified by dividing hue into 100 sections and lightness into 10 sections. Measurement of colors can be performed by using a measuring instrument, such as a spectrophotometer and a colorimeter.

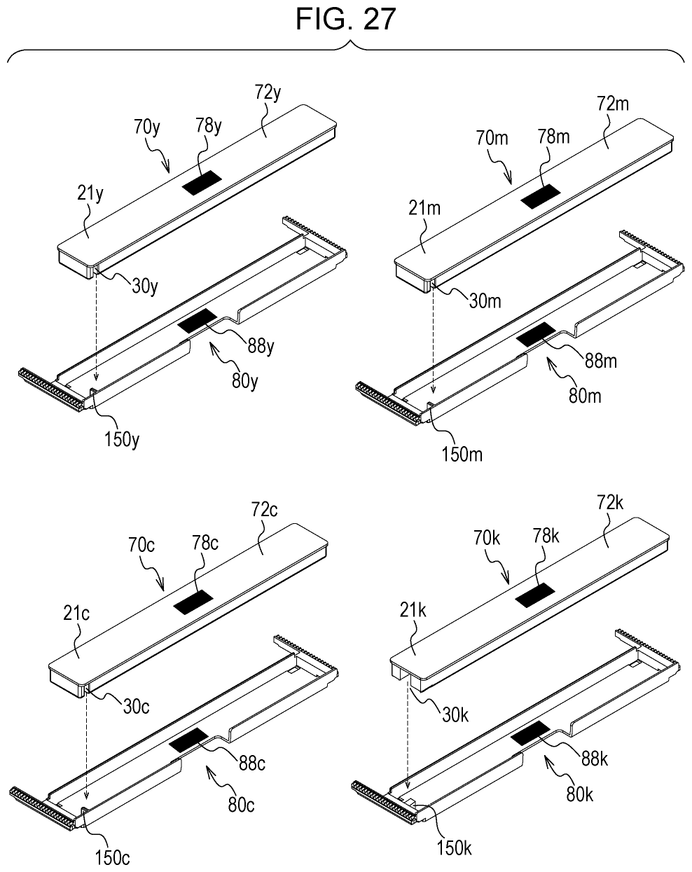

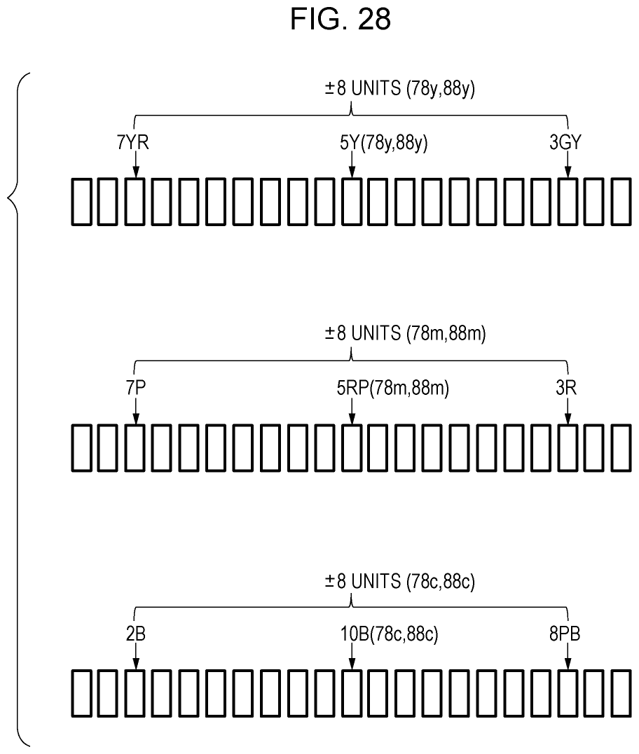

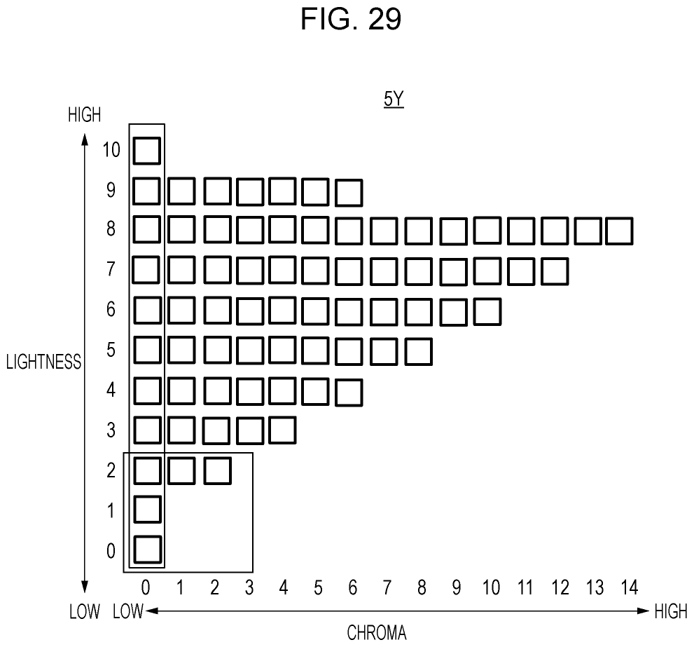

The incorrect mounting suppression configuration using colors in the present embodiment will be described with reference to FIGS. 27, 28, and 29. FIG. 27 shows perspective views of indicators of the toner cartridges 70 and indicators of the trays 80. FIG. 28 shows diagrams that show the closeness of hue between the toner cartridge 70 and the tray 80 in the present embodiment. FIG. 29 is a diagram that shows the color range of each of the toner cartridge 70k and the tray 80k.

In the present embodiment, as shown in FIG. 27, a label 78 is pasted to the frame 72 of the toner cartridge 70 as an indicator. More specifically, a label 78 is pasted to the top portion (top surface) 21 of the toner cartridge 70. A label 88 is pasted as an indicator of the tray 80. More specifically, a label 88 is pasted to the cartridge holding portion (bottom surface) 81 of the tray 80. One of the labels 78y, 78m, 78c, 78k can be referred to as a first cartridge indicator, one of the remaining three can be referred to as a second cartridge indicator, one of the remaining two can be referred to as a third cartridge indicator, and the last one can be referred to as a fourth cartridge indicator.

One of the labels 88y, 88m, 88c, 88k can be referred to as a first tray indicator, one of the remaining three can be referred to as a second tray indicator, one of the remaining two can be referred to as a third tray indicator, and the last one can be referred to as a fourth tray indicator.

In other words, the first cartridge indicator is on the first cartridge top surface. The second cartridge indicator is on the second cartridge top surface. The third cartridge indicator is on the third cartridge top surface. The fourth cartridge indicator is on the fourth cartridge top surface. The first tray indicator is on the first tray bottom surface. The second tray indicator is on the second tray bottom surface. The third tray indicator is on the third tray bottom surface. The fourth tray indicator is on the fourth tray bottom surface. Between the tray 80 and the toner cartridge 70 compatible with the tray 80, the color of toner, the color of the label 78, and the color of the label 88 are similar colors.

In the present embodiment, the Munsell values of the toner, label 78, and label 88 are as follows. The Munsell values are yellow toner (5Y 8/14), the label 78y (5Y 8/14), the label 88y (5Y 8/14), magenta toner (5RP 5/14), the label 78m (5RP 5/14), the label 88m (5RP 5/14), cyan toner (10B 6/10), the label 78c (10B 6/10), and the label 88c (10B 6/10). In addition, the Munsell values are black toner (N1.0), the label 78k (N1.0), and the label 88k (N1.0). For example, (5Y 8/14) means a hue of 5Y, a color value of 8, and a saturation of 14.

Next, the characteristics of the color settings of the toner, label 78, and label 88 in the present embodiment will be described. The hue of the label 78y is closer to the hue of the label 88y than to the hue of the label 88m or the hue of the label 88c. The hue of the label 78m is closer to the hue of the label 88m than to the hue of the label 88y or the hue of the label 88c. The hue of the label 78c is closer to the hue of the label 88c than to the hue of the label 88y or the hue of the label 88m. In other words, the hue of the first cartridge indicator is closer to the hue of the first tray indicator than to the hue of the second tray indicator, and the hue of the second cartridge indicator is closer to the hue of the second tray indicator than to the hue of the first tray indicator. Therefore, between the tray 80 and the toner cartridge 70 compatible with the tray 80, it is easy to recognize the correspondence between the label 78 and the label 88.

Furthermore, the hues of the labels 78y to 78c in the present embodiment respectively fall within ranges of the +8 units of the hues of the labels 88y to 88c as shown in FIG. 28. For example, the hue (5Y) of the label 78y in the present embodiment falls within the range (7YR to 3GY) of +8 units of the hue (5Y) of the label 88y. As a result, between the tray 80 and the toner cartridge 70 compatible with the tray 80, it is further easy to recognize the correspondence between the label 78 and the label 88.

The hue of the label 78y in the present embodiment is closer to the hue of yellow toner than to the hue of magenta toner or the hue of cyan toner. The hue of the label 78m is closer to the hue of magenta toner than to the hue of yellow toner or the hue of cyan toner. The hue of the label 78c is closer to the hue of cyan toner than to the hue of yellow toner or the hue of magenta toner. Therefore, it is easier to recognize the color of toner contained in the toner cartridge 70.

Furthermore, the hue of the label 78 falls within a range of +8 units of the hue of toner. For example, the hue (5Y) of the label 78y in the present embodiment falls within the range (7YR to 3GY) of +8 units of the hue (5Y) of yellow toner. As a result, it is further easier to recognize the color of toner contained in the toner cartridge 70.

The hue of the label 88y in the present embodiment is closer to the hue of yellow toner than to the hue of magenta toner or the hue of cyan toner. The hue of the label 88m is closer to the hue of magenta toner than to the hue of yellow toner or the hue of cyan toner. The hue of the label 88c is closer to the hue of cyan toner than to the hue of yellow toner or the hue of magenta toner. As a result, it is easier to recognize the correspondence between the tray 80 and the color of toner.

Furthermore, the hue of the label 88 falls within a range of +8 units of the hue of toner. For example, the hue (5Y) of the label 88y in the present embodiment falls within the range (7YR to 3GY) of +8 units of the hue (5Y) of yellow toner. As a result, it is further easier to recognize the correspondence between the tray 80 and the color of toner.

In the present embodiment, the color of black toner (N1.0), the color of the label 78k (N1.0), and the color of the label 88k (N1.0) are set as colors that have a chroma of N or a lightness of two or lower. For example, FIG. 29 shows the colors of the hue 5Y; however, 13 colors are classified as black. In other words, in all the hues (100), colors with a chroma of N or a lightness of two or lower are classified as black.

In the present embodiment, the color of yellow toner, the color of the label 78y, the color of the label 88y, the color of magenta toner, the color of the label 78m, the color of the label 88m, the color of cyan toner, the color of the label 78c, and the color of the label 88c all have a chroma higher than zero and a lightness higher than two.

In this way, when the colors of the black toner, label 78k, and label 88k have a chroma of N or a lightness of two or lower, it is easier to recognize the correspondence among black toner, the label 78k, and the label 88k.

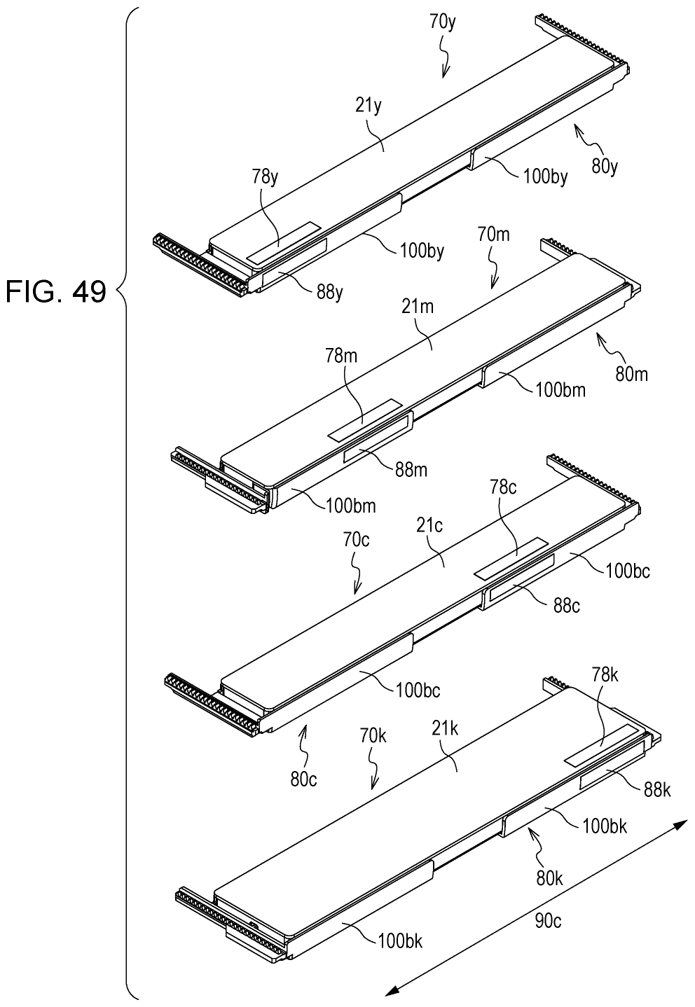

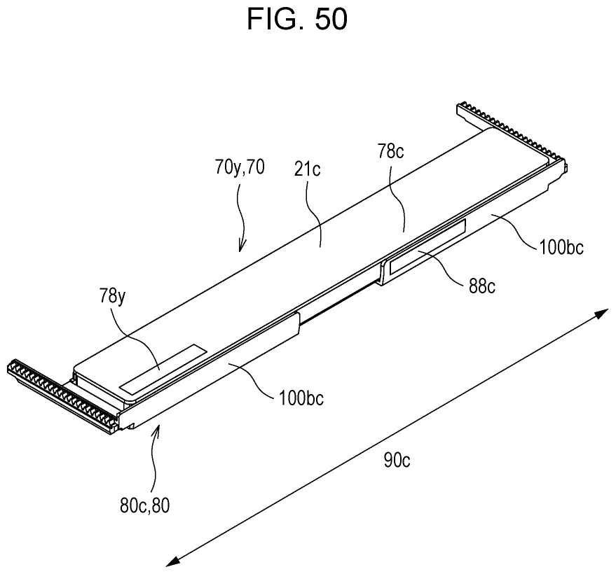

The first tray indicator may be at a position different from that of the present embodiment. A modification in which the tray indicators are at positions different from those of the present embodiment will be described with reference to FIGS. 49 and 50. FIG. 49 shows a state where the toner cartridges 70 are supported by the trays 80. FIG. 50 shows a state where the toner cartridge 78y is incorrectly mounted on the tray 80c.

As shown in FIG. 49, each tray indicator is on the side wall 100b, and each cartridge indicator is on the top surface 21. In other words, the first cartridge indicator is on the first cartridge top surface, and the first tray indicator is on the first tray side surface. The second cartridge indicator is on the second cartridge top surface, and the second tray indicator is on the second tray side surface.

In the state of FIG. 49, at least part of the cartridge indicator is at the same position as the tray indicator in the direction of the rotation axis 90C of the rotary body 90. In other words, when the first cartridge is supported by the first tray, at least part of the first cartridge indicator is at the same position as the first tray indicator in the rotation axis direction of the rotary body 90.

On the other hand, as shown in FIG. 50, when the toner cartridge 70y is supported by the tray 80c, the label 78y is at a different position from the label 88c in the rotation axis direction of the rotary body 90. In other words, when the first cartridge is supported by the second tray, the first cartridge indicator is at a different position from the second tray indicator in the rotation axis direction of the rotary. In this way, when the position of the label 78y and the position of the label 88c are different in the rotation axis direction, the user is more likely to become aware of incorrect mounting.

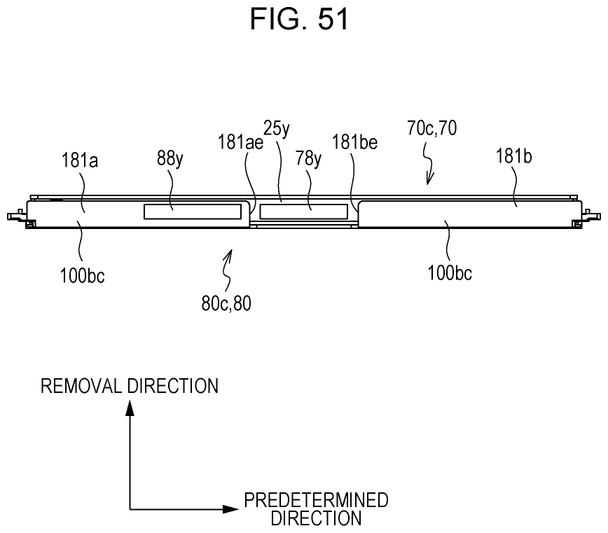

Next, a modification shown in FIG. 51 will be described. FIG. 51 is a plan view that shows a state when the toner cartridge 70 of a correct color is correctly mounted on the tray 80. FIG. 51 shows the toner cartridge 70y and the tray 80y in an example.

The direction in which the toner cartridge 70 supported by the tray 80 in a first posture is removed is referred to as a removal direction. The removal direction is preferably the vertical direction. The predetermined direction in which the first opposing portion 181a extends is a direction orthogonal to the removal direction. Preferably, the predetermined direction is the horizontal direction. The first opposing portion 181a has an end 181ae. The first end 181ae is a downstream-side end of the first opposing portion 181a in the predetermined direction. In the predetermined direction, part of the cartridge (exposed part 25y) is positioned downstream of the first end 181ae that is the downstream-side end in the predetermined direction in which the first opposing portion 181a extends. A second opposing portion 181b has an end 181be. The end 181be is an upstream-side end of the second opposing portion 181b in the predetermined direction. In the predetermined direction, part of the cartridge (exposed part 25y) is positioned upstream of the upstream-side end of the second opposing portion 181b. In other words, in the predetermined direction, the exposed part 26y that is part of the cartridge and exposed is present between the first opposing portion 181a and the second opposing portion 181b.

The label 78y is referred to as a first cartridge indicator, and the label 88y is referred to as a first tray indicator. The first cartridge indicator is at the exposed part 25y. The first tray indicator is at the first opposing portion 181a. At least part of the first cartridge indicator is at the same position as the first tray indicator in the removal direction.

In the present embodiment, the label 78 and the label 88 are respectively pasted to the toner cartridge 70 and the tray 80. Alternatively, part or all of the toner cartridge 70 and part or all of the tray 80 may be used as indicators without using the label 78 and the label 88. The label 78 may be pasted to any location on the toner cartridge 70. The label 88 may be pasted to any location on the tray 80. For example, the label 88 can be pasted to the side wall 100b.

Instead of pasting the label 78 and the label 88, resin sheets may be attached to the tray 80 and the toner cartridge 70 as indicators.

With the above-described configuration, it is possible to reduce the likelihood that an incompatible toner cartridge 70 is incorrectly mounted to the tray 80.

### Tray Shape

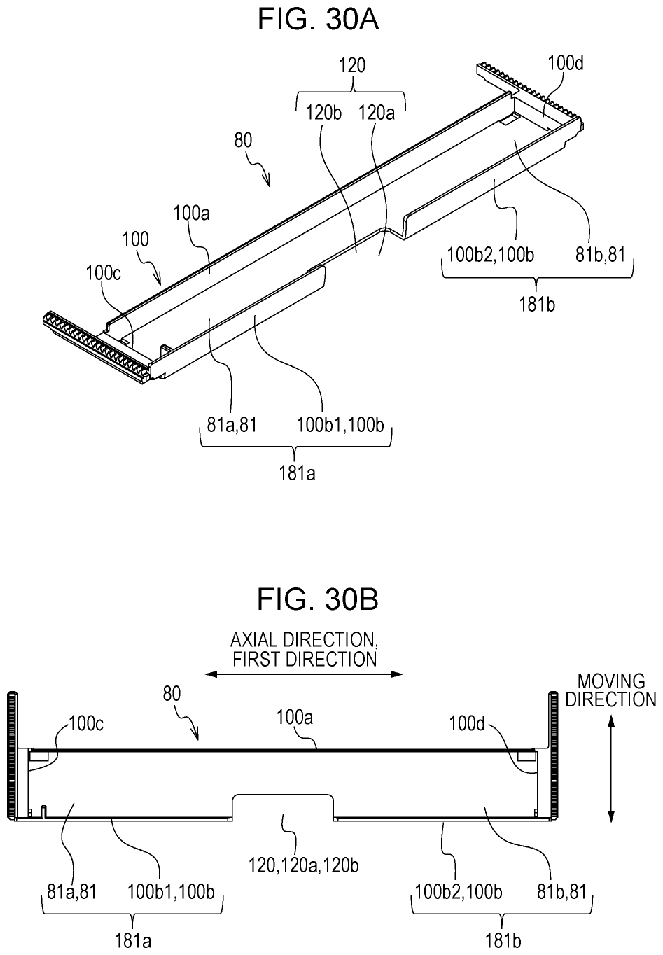

The shape of the tray 80 for making it easy for the toner cartridge 70 to be removed from the tray 80 will be described with reference to FIGS. 30A and 30B. FIG. 30A is a perspective view showing the shape of the tray 80. FIG. 30B is a plan view showing the shape of the tray 80.

In a state where the toner cartridge 70 is mounted on the tray 80, the surface of the toner cartridge 70 is covered by the cartridge holding portion 81 and the side wall 100. Therefore, by forming an opening (exposed part), such as a hole and a groove, in the cartridge holding portion 81 and the side wall 100, the surface of the toner cartridge 70 is exposed. As a result, the user can easily touch the toner cartridge 70 and is able to further easily remove the toner cartridge 70 from the tray 80.

The tray 80 has the side wall 100 and the cartridge holding portion 81 as an opposing portion 181 facing the toner cartridge 70 supported in the first posture and extending in a predetermined direction. More specifically, the tray 80 has a bottom wall 81a and a side wall 100b1 as the first opposing portion 181a facing the toner cartridge 70 supported in the first posture and extending in a predetermined direction. The bottom wall 81a is part of the cartridge support portion 81, and the side wall 100b1 is part of the side wall 100b.

The bottom wall 81a and the side wall 100b1 extend in the first direction of the toner cartridge 70 taking a normal posture for the tray 80. In a state where the toner cartridge 70 is taking a normal posture for the tray 80, the axial direction of the rotation axis 90C is parallel to the first direction of the toner cartridge 70.

As understood from FIG. 19A, in a state where the toner cartridge 70 is supported in the normal posture by the tray 80, the length of the first opposing portion 181a is shorter than the length of the toner cartridge 70 in the first direction. In the first direction, the first opposing portion 181a is adjacent to a space 120.

More specifically, the space 120 includes a space 120b adjacent to the bottom wall 81a and a space 120a adjacent to the side wall 100b1, in the first direction. In a state where the tray 80 supporting the toner cartridge 70 is positioned at the eject position, the toner cartridge 70 is exposed through the space 120 (the space 120a and the space 120b) (see FIG. 19A). The user is able to touch the toner cartridge 70 exposed through the space 120. In the present embodiment, the space 120a and the space 120b are continuous with each other. Alternatively, the space 120a and the space 120b may be discontinuous from each other.

Furthermore, the tray 80 has a bottom wall 81b and a side wall 100b2 as a second opposing portion 181b facing the toner cartridge 70 supported in the first posture and extending in a predetermined direction. The bottom wall 81b is part of the cartridge support portion 81, and the side wall 100b2 is part of the side wall 100b. The bottom wall 81b and the side wall 100b2 extend in the first direction of the toner cartridge 70 taking a normal posture for the tray 80.

As understood from FIG. 19A, in a state where the toner cartridge 70 is supported in the normal posture by the tray 80, the length of the second opposing portion 181b is shorter than the length of the toner cartridge 70 in the first direction. In the first direction, the second opposing portion 181b is adjacent to the space 120. In the first direction, the bottom wall 81b is adjacent to the space 120b, and the side wall 100b2 is adjacent to the space 120a.

The bottom wall 81a and the bottom wall 81b face the bottom portion (bottom surface) 20 of the toner cartridge 70 that is supported in the normal posture by the tray 80. The side wall 100b1 and the side wall 100b2 face the side portion (side surface) 25 of the toner cartridge 70 supported in the normal posture by the tray 80. The side portion 25 of the toner cartridge 70 can be regarded as extending in a direction that crosses the bottom portion 20.

The side wall 100b1 and the side wall 100b2 are positioned downstream of the cartridge holding portion 81 in the moving direction of the tray 80 from the storage position to the eject position. The side wall 100b1 and the side wall 100b2 are positioned downstream of the toner cartridge 70 that is supported in the normal posture by the tray 80 in the moving direction of the tray 80 from the storage position to the eject position.

In the axial direction of the rotation axis 90c, the space 120 is positioned between the first opposing portion 181a and the second opposing portion 181b. More specifically, the space 120a is positioned between the side wall 100b1 and the side wall 100b2, and the space 120b is positioned between the bottom wall 81a and the bottom wall 81b.

With the above-described configuration, the toner cartridge 70 is easily removed by using the portion exposed through the space 120 of the toner cartridge 70.

In the present embodiment, as shown in FIG. 7A, in a state where the toner cartridge 70 is taking the first posture, the upper end of the toner cartridge 70 in the vertical direction is positioned above the upper end of the side wall 100b1 and the upper end of the side wall 100b2. As a result, the upper end of the toner cartridge 70 is exposed, so it is easy to remove the toner cartridge 70.

In the present embodiment, the space 120 includes the space 120a and the space 120b. Alternatively, one of the space 120a and the space 120b may be omitted. In other words, the space where the toner cartridge 70 is exposed just needs to be disposed between the bottom wall 81a and the bottom wall 81b or between the side wall 100bl and the side wall 100b2. When the space 120 includes the space 120a and the space 120b, the user can further easily touch the toner cartridge 70 compared to when the space 120 includes only one of the space 120a and the space 120b.

The tray 80 includes the first opposing portion 181a and the second opposing portion 181b. Alternatively, one of the first opposing portion 181a and the second opposing portion 181b may be omitted. In this case as well, one of the space 120a and the space 120b may be omitted. In other words, the space 120b may be adjacent to the other one of the bottom wall 81a and the bottom wall 81b. Alternatively, one of the side wall 100b1 and the side wall 100b2 may be omitted, and the space 120b may be adjacent to the other one of the side wall 100b1 and the side wall 100b2.

Furthermore, in this present embodiment, the first opposing portion 181a and the second opposing portion 181b extend in the first direction of the toner cartridge 70 supported in the normal posture by the tray 80 as a predetermined direction. However, the tray 80 may have a first opposing portion and a second opposing portion that extend in the second direction of the toner cartridge 70 supported in the normal posture by the tray 80 as a predetermined direction. The tray 80 may have a first opposing portion and a second opposing portion that extend in the first direction of the toner cartridge 70 supported in the normal posture by the tray 80 as a predetermined direction, and may further have a first opposing portion and a second opposing portion that extend in the second direction.

### OTHER EMBODIMENTS

In the above-described embodiments, the configuration in which the tray 80 moves from the storage position to the eject position using the drive device, urging member, or the like, of the apparatus body 1A without operation of the user to the tray 80 has been described. Instead, the configuration that the user holds the tray 80 to eject the tray 80 from the storage position to the eject position (that is, the configuration to manually move the support member) in a state where the rotary body 90 is in the replacement posture may be provided. Even in this case, the user just needs to attach and detach the toner cartridge 70 to or from the tray 80 ejected from the apparatus body compared to the case where the toner cartridge is directly inserted into and removed from the apparatus body, so the operability improves.

In the above-described embodiments, the configuration that the rotary body 90 includes four developing units 50y to 50k and allow the formation of color images by using four colors of toner has been described. Alternatively, the rotary body 90 may include three or fewer developing units, or may include five or more developing units. In these cases, the number and arrangement of trays and toner cartridges can be changed as needed according to the number of developing units. For example, in each of the above-described embodiments, the configuration in which four toner cartridges 70y to 70k are detachably attachable to the rotary body 90 has been illustrated. Alternatively, only one toner cartridge 70k may be configured to be mounted to the rotary body 90.

### SUMMARY OF PRESENT DISCLOSURE

The present disclosure includes at least the following configurations.

### Configuration 1

An image forming apparatus to which a first cartridge that contains a first developer and a second cartridge that contains a second developer different in color from the first developer are detachably attached includes:
a rotary rotatable around a rotation axis extending in an axial direction, the rotary including a first developing chamber configured to contain the first developer supplied from the first cartridge and a second developing chamber configured to contain the second developer supplied from the second cartridge;
a first tray having a first restricting portion and capable of removably supporting the first cartridge such that the first cartridge takes a first posture, the first tray being configured to be displaced relative to the rotary between a first position where the first cartridge supported in the first posture is positioned outside the rotary and a second position where the first cartridge supported in the first posture is positioned inside the rotary; and
a second tray having a second restricting portion and capable of removably supporting the second cartridge such that the second cartridge takes a second posture, the second tray being configured to be displaced relative to the rotary between a third position where the second cartridge supported in the second posture is positioned outside the rotary and a fourth position where the second cartridge supported in the second posture is positioned inside the rotary, wherein
when the first tray supports the second cartridge, the first restricting portion of the first tray contacts with the second cartridge to restrict the second cartridge from taking the same posture as the first posture relative to the first tray, and
when the second tray supports the first cartridge, the second restricting portion of the second tray contacts with the first cartridge to restrict the first cartridge from taking the same posture as the second posture relative to the second tray.

### Configuration 2

The image forming apparatus according to Configuration 1, wherein
one of the first cartridge and the first tray has a first recess, the other one of the first cartridge and the first tray has a first protrusion, and the first protrusion is inserted into the first recess in a state where the first cartridge is supported by the first tray in the first posture, and
one of the second cartridge and the second tray has a second recess, the other one of the second cartridge and the second tray has a second protrusion, and the second protrusion is inserted into the second recess in a state where the second cartridge is supported by the second tray in the second posture.

### Configuration 3

The image forming apparatus according to Configuration 2, wherein
the first cartridge has the first recess, and the first restricting portion is the first protrusion, and
the second cartridge has the second recess, and the second restricting portion is the second protrusion.

### Configuration 4

The image forming apparatus according to Configuration 2, wherein
the first cartridge has the first protrusion, and the first tray has the first recess, the second cartridge has the second protrusion, and the second tray has the second recess, and
when the first tray supports the second cartridge, the first restricting portion contacts with the second protrusion, and, when the second tray supports the first cartridge, the second restricting portion contacts with the first protrusion.

### Configuration 5

The image forming apparatus according to any one of Configurations 1 to 4,
the first tray includes a first side wall that extends in a first direction in which the first tray is displaced from the first position to the second position,
the second tray includes a second side wall that extends in a second direction in which the second tray is displaced from the third position to the fourth position, and
a shortest distance between the first restricting portion and the first side wall in the axial direction is different from a shortest distance between the second restricting portion and the second side wall in the axial direction.

### Configuration 6

The image forming apparatus according to Configuration 5, wherein
the first tray includes a third side wall that extends in the axial direction,
the second tray includes a fourth side wall that extends in the axial direction, and
a shortest distance between the first restricting portion and the third side wall in the first direction is different from a shortest distance between the second restricting portion and the fourth side wall in the second direction.

### Configuration 7

The image forming apparatus according to Configuration 6, wherein
the first tray extends in the axial direction and includes a fifth side wall that faces the third side wall,
the second tray extends in the axial direction and includes a sixth side wall that faces the fourth side wall, and
a shortest distance between the third side wall and the fifth side wall in the first direction is longer than a shortest distance between the fourth side wall and the sixth side wall in the second direction.

### Configuration 8

The image forming apparatus according to Configuration 7, wherein a shortest distance between the third side wall and the first restricting portion in the first direction and a shortest distance between the fifth side wall and the first restricting portion in the first direction both are shorter than a length, in the second direction, of the second cartridge in the second posture.

### Configuration 9

The image forming apparatus according to Configuration 7, wherein a shortest distance between the fourth side wall and the sixth side wall in the second direction is shorter than a length, in the first direction, of the first cartridge in the first posture.

### Configuration 10

The image forming apparatus according to any one of Configuration 5 to 9, wherein
the first tray includes a seventh side wall that extends in the first direction and that faces the first side wall,
the second tray includes an eighth side wall that extends in the second direction and that faces the second side wall, and
in the axial direction, a shortest distance between a center between the first side wall and the seventh side wall and the first restricting portion is longer than a shortest distance between the first restricting portion and the first side wall, and a shortest distance between a center between the second side wall and the eighth side wall and the second restricting portion is longer than a shortest distance between the second restricting portion and the second side wall.

### Configuration 11

The image forming apparatus according to Configuration 1, wherein a shape of the first restricting portion when viewed in a direction orthogonal to a first direction in which the first tray is displaced from the first position to the second position and a rotation axis direction of the rotary is different from a shape of the second restricting portion when viewed in a direction orthogonal to a second direction in which the second tray is displaced from the third position to the fourth position and the rotation axis direction of the rotary.

### Configuration 12

The image forming apparatus according to Configuration 2, wherein
the first tray includes a first side wall, the first side wall extends in a direction crossing both a first direction in which the first tray is displaced from the first position to the second position and the axial direction of the rotary, and the first side wall has the first recess,
the second tray includes a second side wall, the second side wall extends in a direction crossing both a second direction in which the second tray is displaced from the third position to the fourth position and the axial direction of the rotary, and the second side wall has the second recess,
the first cartridge has the first protrusion, and
the second cartridge has the second protrusion.

### Configuration 13

The image forming apparatus according to Configuration 4, wherein
the first cartridge has a first cartridge bottom surface that is supported by the first tray in a state where the first cartridge is supported by the first tray in the first posture, and a first cartridge top surface that is a surface opposite to the first cartridge bottom surface, and
the first recess is continuous from the first cartridge bottom surface to the first cartridge top surface.

### Configuration 14

The image forming apparatus according to any one of Configurations 1 to 13, wherein
when the first tray supports the second cartridge, the first restricting portion of the first tray contacts with the second cartridge, and a distance in a vertical direction between a topmost part of the second cartridge and the first restricting portion is longer than a distance in the vertical direction between a topmost part of the first cartridge and the first restricting portion when the first tray supports the first cartridge, and
when the second tray supports the first cartridge, the second restricting portion of the second tray contacts with the first cartridge, and a distance in the vertical direction between a topmost part of the first cartridge and the second restricting portion is longer than a distance in the vertical direction between a topmost part of the second cartridge and the second restricting portion when the second tray supports the second cartridge.

### Configuration 15

The image forming apparatus according to any one of Configurations 1 to 13, wherein
the first tray has a first support surface configured to support a bottom surface of the first cartridge,
the second tray has a second support surface configured to support a bottom surface of the second cartridge,
in a state where the first tray supports the second cartridge, the bottom surface of the second cartridge is inclined relative to the first support surface, and
in a state where the second tray supports the first cartridge, the bottom surface of the first cartridge is inclined relative to the second support surface.

### Configuration 16

An image forming apparatus to which a first cartridge that contains a first developer and a second cartridge that contains a second developer different in color from the first developer are detachably attached includes:
a rotary rotatable around a rotation axis extending in an axial direction, the rotary including a first developing chamber configured to contain the first developer supplied from the first cartridge and a second developing chamber configured to contain the second developer supplied from the second cartridge;
a first tray capable of removably supporting the first cartridge such that the first cartridge takes a first posture, the first tray being configured to be displaced relative to the rotary between a first position where the first cartridge is positioned outside the rotary and a second position where the first cartridge is positioned inside the rotary; and
a second tray capable of removably supporting the second cartridge such that the second cartridge takes a second posture, the second tray being configured to be displaced relative to the rotary between a third position where the second cartridge is positioned outside the rotary and a fourth position where the second cartridge is positioned inside the rotary, wherein
in a state where the first tray supports the second cartridge, the first tray is restricted from moving to the second position, and, in a state where the second tray supports the first cartridge, the second tray is restricted from moving to the fourth position.

### Configuration 17

The image forming apparatus according to Configuration 16 further includes
a housing that accommodates the rotary, wherein
when the first tray moves from the first position toward the second position in a state where the first tray supports the second cartridge, the second cartridge contacts with the rotary or the housing such that the first tray is restricted from moving to the second position, and
when the second tray moves from the third position toward the fourth position in a state where the second tray supports the first cartridge, the first cartridge contacts with the rotary or the housing such that the second tray is restricted from moving to the fourth position.

### Configuration 18

The image forming apparatus according to Configuration 17 further includes a moving device configured to move the first tray from the first position toward the second position and to move the second tray from the third position toward the fourth position.

### Configuration 19

The image forming apparatus according to Configuration 18, wherein
when the first tray moves from the first position toward the second position in a state where the first tray supports the second cartridge and the second cartridge contacts with the rotary or the housing, the moving device stops, and
when the second tray moves from the third position toward the fourth position in a state where the second tray supports the first cartridge and the first cartridge contacts with the rotary or the housing, the moving device stops.

### Configuration 20

The image forming apparatus according to Configuration 16, wherein
the first tray has a first side wall, and the second tray has a second side wall,
in a state where the first tray supports the second cartridge, the first side wall is positioned upstream of the second cartridge in a direction in which the first tray moves from the first position toward the second position, and
in a state where the second tray supports the first cartridge, the second side wall is positioned upstream of the first cartridge in a direction in which the second tray moves from the third position toward the fourth position.

### Configuration 21

The image forming apparatus according to Configuration 17, wherein
the rotary includes a first frame that includes the first developing chamber and a second frame that includes the second developing chamber,
the first tray has a first cartridge holding portion that supports a bottom surface of the first cartridge in the first posture,
the second tray has a second cartridge holding portion that supports a bottom surface of the second cartridge in the second posture,
when the first tray supports the second cartridge, a shortest distance from the second cartridge holding portion to an upper end of the second cartridge is longer in a vertical direction than a shortest distance from the second cartridge holding portion to the first frame, and
when the second tray supports the first cartridge, a shortest distance from the first cartridge holding portion to an upper end of the first cartridge is longer in the vertical direction than a shortest distance from the first cartridge holding portion to the second frame.

### Configuration 22

The image forming apparatus according to Configuration 17, wherein
the first tray has a first cartridge holding portion that supports a bottom surface of the first cartridge in the first posture,
the second tray has a second cartridge holding portion that supports a bottom surface of the second cartridge in the second posture,
when the first tray supports the second cartridge, a shortest distance from the first cartridge holding portion to an upper end of the first cartridge is longer in a vertical direction than a shortest distance from the second cartridge holding portion to the housing, and
when the second tray supports the first cartridge, a shortest distance from the second cartridge holding portion to an upper end of the first cartridge is longer in a vertical direction than a shortest distance from the second cartridge holding portion to the housing.

### Configuration 23

The image forming apparatus according to Configuration 17, wherein
the rotary includes a first frame that includes the first developing chamber,
the first frame has a first recess,
the first cartridge has a first protrusion,
the second cartridge has a second protrusion,
when, in a state where the first tray at the first position supports the first cartridge, the first protrusion is positioned within a width of the first recess in the axial direction of the rotary and additionally the first tray moves from the first position to the second position, the first protrusion passes through the first recess, and the first tray moves to the second position, and
when, in a state where the first tray at the first position supports the second cartridge, the second protrusion is positioned outside the width of the first recess in the axial direction of the rotary and additionally the first tray moves from the first position toward the second position, the second protrusion contacts with the first frame, and the first tray is restricted from reaching the second position.

### Configuration 24

The image forming apparatus according to Configuration 23, wherein
when, in a state where the first tray at the first position supports the second cartridge, the first tray moves from the first position toward the second position, the second protrusion contacts with the first frame, and
after the second protrusion contacts with the first frame, the first tray moves to the first position.

### Configuration 25

The image forming apparatus according to Configuration 18 further includes:
a drive device configured to drive the moving device, the drive device being configured to perform a first operation to drive the moving device such that the moving device moves the first tray from the first position toward the second position, and a second operation to drive the moving device such that the moving device moves the first tray from the second position toward the first position; and
a control unit configured to control the drive device, wherein
the control unit is configured to cause the drive device to execute the second operation when the first tray does not reach the second position even when a predetermined time elapses from when the control unit causes the drive device to start the first operation in a state where the first tray is positioned at the first position.

### Configuration 26

An image forming apparatus includes:
a rotary including a first developing chamber and a second developing chamber;
a first cartridge having a first cartridge indicator and configured to supply a first developer to the first developing chamber;
a second cartridge having a second cartridge indicator and configured to supply a second developer different in color from the first developer to the second developing chamber;
a first tray having a first tray indicator, the first tray supporting the first cartridge such that the first cartridge is detachably attached, the first tray being configured to be displaced relative to the rotary between a first position where the first cartridge is positioned outside the rotary and a second position where the first cartridge is positioned inside the rotary; and
a second tray having a second tray indicator, the second tray supporting the second cartridge such that the second cartridge is detachably attached, the second tray being configured to be displaced relative to the rotary between a third position where the second cartridge is positioned outside the rotary and a fourth position where the second cartridge is positioned inside the rotary, wherein
a hue of the first cartridge indicator is closer to a hue of the first tray indicator than to a hue of the second tray indicator, and
a hue of the second cartridge indicator is closer to the hue of the second tray indicator than to the hue of the first tray indicator.

### Configuration 27

The image forming apparatus according to Configuration 26, wherein
the hue of the first cartridge indicator is closer to a hue of the first developer than to a hue of the second developer, and
the hue of the second cartridge indicator is closer to the hue of the second developer than to the hue of the first developer.

Configuration 28 The image forming apparatus according to Configuration 26 or 27, wherein
the hue of the first tray indicator is closer to a hue of the first developer than to a hue of the second developer, and
the hue of the second tray indicator is closer to the hue of the second developer than to the hue of the first developer.

### Configuration 29

The image forming apparatus according to any one of Configurations 26 to 28, wherein
in the Munsell color system,
the hue of the first cartridge indicator falls within a range of +8 units of the hue of the first tray indicator, and
the hue of the second cartridge indicator falls within a range of +8 units of the hue of the second tray indicator.

### Configuration 30

The image forming apparatus according to any one of Configurations 26 to 29, wherein
in the Munsell color system,
the hue of the first cartridge indicator falls within a range of +8 units of the hue of the first developer, and
the hue of the second cartridge indicator falls within a range of +8 units of the hue of the second developer.

### Configuration 31

The image forming apparatus according to any one of Configurations 26 to 30, in the Munsell color system,
the hue of the first tray indicator falls within a range of +8 units of the hue of the first developer, and
the hue of the second tray indicator falls within a range of +8 units of the hue of the second developer.

### Configuration 32

The image forming apparatus according to any one of Configurations 26 to 31, wherein
the first cartridge includes a first frame that contains the first developer, and the first cartridge indicator is attached to the first frame, and
the second cartridge includes a second frame that contains the second developer, and the second cartridge indicator is attached to the second frame.

### Configuration 33

The image forming apparatus according to any one of Configurations 26 to 32, wherein the first tray indicator is attached to the first tray, and the second tray indicator is attached to the second tray.

### Configuration 34

The image forming apparatus according to Configuration 26 includes:
the rotary having a third developing chamber;
a third cartridge having a third cartridge indicator, the third cartridge being configured to supply a third developer different in color from both the first developer and the second developer to the third developing chamber; and
a third tray having a third tray indicator, the third tray supporting the third cartridge such that the third cartridge is detachably attached, the third tray being configured to be displaced relative to the rotary between a fifth position where the third cartridge is positioned outside the rotary and a sixth position where the third cartridge is positioned inside the rotary, wherein
in the Munsell color system,
colors of the first cartridge indicator and the first tray indicator are greater in chroma than zero and greater in lightness than two,
colors of the second cartridge indicator and the second tray indicator are greater in chroma than zero and greater in lightness than two, and
colors of the third cartridge indicator and the third tray indicator are zero in chroma or less than or equal to two in lightness.

The present disclosure is not limited to the above-described embodiments. Various changes and modifications are applicable without departing from the spirit and scope of the present disclosure. Therefore, the following claims are attached to show the scope of the present disclosure.

According to the present disclosure, it is possible to provide a new image forming apparatus that has advanced the existing technology.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An image forming apparatus to which a first cartridge that contains a first developer and a second cartridge that contains a second developer different in color from the first developer are detachably attached, the image forming apparatus comprising:
a rotary rotatable around a rotation axis extending in an axial direction, the rotary including a first developing chamber configured to contain the first developer supplied from the first cartridge and a second developing chamber configured to contain a second developer supplied from the second cartridge;
a first tray having a first restricting portion and capable of removably supporting the first cartridge such that the first cartridge takes a first posture, the first tray being configured to be displaced relative to the rotary between a first position where the first cartridge supported in the first posture is positioned outside the rotary and a second position where the first cartridge supported in the first posture is positioned inside the rotary; and
a second tray having a second restricting portion and capable of removably supporting the second cartridge such that the second cartridge takes a second posture, the second tray being configured to be displaced relative to the rotary between a third position where the second cartridge supported in the second posture is positioned outside the rotary and a fourth position where the second cartridge supported in the second posture is positioned inside the rotary, wherein
when the first tray supports the second cartridge, the first restricting portion of the first tray contacts with the second cartridge to restrict the second cartridge from taking the same posture as the first posture relative to the first tray, and
when the second tray supports the first cartridge, the second restricting portion of the second tray contacts with the first cartridge to restrict the first cartridge from taking the same posture as the second posture relative to the second tray.

2. The image forming apparatus according to claim 1, wherein
one of the first cartridge and the first tray has a first recess, the other one of the first cartridge and the first tray has a first protrusion, and the first protrusion is inserted into the first recess in a state where the first cartridge is supported by the first tray in the first posture, and
one of the second cartridge and the second tray has a second recess, the other one of the second cartridge and the second tray has a second protrusion, and the second protrusion is inserted into the second recess in a state where the second cartridge is supported by the second tray in the second posture.

3. The image forming apparatus according to claim 2, wherein
the first cartridge has the first recess, and the first restricting portion is the first protrusion, and
the second cartridge has the second recess, and the second restricting portion is the second protrusion.

4. The image forming apparatus according to claim 2, wherein
the first cartridge has the first protrusion, and the first tray has the first recess,
the second cartridge has the second protrusion, and the second tray has the second recess, and
when the first tray supports the second cartridge, the first restricting portion contacts with the second protrusion, and, when the second tray supports the first cartridge, the second restricting portion contacts with the first protrusion.

5. The image forming apparatus according to claim 1, wherein
the first tray includes a first side wall that extends in a first direction in which the first tray is displaced from the first position to the second position,
the second tray includes a second side wall that extends in a second direction in which the second tray is displaced from the third position to the fourth position, and
a shortest distance between the first restricting portion and the first side wall in the axial direction is different from a shortest distance between the second restricting portion and the second side wall in the axial direction.

6. The image forming apparatus according to claim 5, wherein
the first tray includes a third side wall that extends in the axial direction,
the second tray includes a fourth side wall that extends in the axial direction, and
a shortest distance between the first restricting portion and the third side wall in the first direction is different from a shortest distance between the second restricting portion and the fourth side wall in the second direction.

7. The image forming apparatus according to claim 6, wherein
the first tray extends in the axial direction and includes a fifth side wall that faces the third side wall,
the second tray extends in the axial direction and includes a sixth side wall that faces the fourth side wall, and
a shortest distance between the third side wall and the fifth side wall in the first direction is longer than a shortest distance between the fourth side wall and the sixth side wall in the second direction.

8. The image forming apparatus according to claim 7, wherein a shortest distance between the third side wall and the first restricting portion in the first direction and a shortest distance between the fifth side wall and the first restricting portion in the first direction both are shorter than a length, in the second direction, of the second cartridge in the second posture.

9. The image forming apparatus according to claim 7, wherein a shortest distance between the fourth side wall and the sixth side wall in the second direction is shorter than a length, in the first direction, of the first cartridge in the first posture.

10. The image forming apparatus according to claim 5, wherein
the first tray includes a seventh side wall that extends in the first direction and that faces the first side wall,
the second tray includes an eighth side wall that extends in the second direction and that faces the second side wall, and
in the axial direction, a shortest distance between a center between the first side wall and the seventh side wall and the first restricting portion is longer than a shortest distance between the first restricting portion and the first side wall, and a shortest distance between a center between the second side wall and the eighth side wall and the second restricting portion is longer than a shortest distance between the second restricting portion and the second side wall.

11. The image forming apparatus according to claim 1, wherein a shape of the first restricting portion when viewed in a direction orthogonal to a first direction in which the first tray is displaced from the first position to the second position and a rotation axis direction of the rotary is different from a shape of the second restricting portion when viewed in a direction orthogonal to a second direction in which the second tray is displaced from the third position to the fourth position and the rotation axis direction of the rotary.

12. The image forming apparatus according to claim 2, wherein
the first tray includes a first side wall, the first side wall extends in a direction crossing both a first direction in which the first tray is displaced from the first position to the second position and the axial direction of the rotary, and the first side wall has the first recess,
the second tray includes a second side wall, the second side wall extends in a direction crossing both a second direction in which the second tray is displaced from the third position to the fourth position and the axial direction of the rotary, and the second side wall has the second recess,
the first cartridge has the first protrusion, and
the second cartridge has the second protrusion.

13. The image forming apparatus according to claim 4, wherein
the first cartridge has a first cartridge bottom surface that is supported by the first tray in a state where the first cartridge is supported by the first tray in the first posture, and a first cartridge top surface that is a surface opposite to the first cartridge bottom surface, and
the first recess is continuous from the first cartridge bottom surface to the first cartridge top surface.

14. The image forming apparatus according to claim 1, wherein
when the first tray supports the second cartridge, the first restricting portion of the first tray contacts with the second cartridge, and a distance in a vertical direction between a topmost part of the second cartridge and the first restricting portion is longer than a distance in the vertical direction between a topmost part of the first cartridge and the first restricting portion when the first tray supports the first cartridge, and
when the second tray supports the first cartridge, the second restricting portion of the second tray contacts with the first cartridge, and a distance in the vertical direction between a topmost part of the first cartridge and the second restricting portion is longer than a distance in the vertical direction between a topmost part of the second cartridge and the second restricting portion when the second tray supports the second cartridge.

15. The image forming apparatus according to claim 1, wherein
the first tray has a first support surface configured to support a bottom surface of the first cartridge,
the second tray has a second support surface configured to support a bottom surface of the second cartridge,
in a state where the first tray supports the second cartridge, the bottom surface of the second cartridge is inclined relative to the first support surface, and
in a state where the second tray supports the first cartridge, the bottom surface of the first cartridge is inclined relative to the second support surface.
